(19) United States
(12) Patent Application Publication
(10) Pub. No.: US 2026/0089734 A1
(43) Pub. Date: Mar. 26, 2026

(54) FLEXIBLE SCHEDULING IN TIME AND FREQUENCY DOMAINS

(71) Applicant: QUALCOMM Incorporated, San Diego, CA (US)

(72) Inventors: Kianoush HOSSEINI, San Diego, CA (US); Mostafa KHOSHNEVISAN, San Diego, CA (US); Gokul SRIDHARAN, Sunnyvale, CA (US); Jing SUN, San Diego, CA (US)

(21) Appl. No.: 18/893,834

(22) Filed: Sep. 23, 2024

(51) Int. Cl. H04W 72/232; H04L 5/00; H04W 72/1273

(52) U.S. Cl. CPC H04W 72/232; H04L 5/001; H04W 72/1273

(57) ABSTRACT

The apparatus may be a wireless device configured to receive an indication of a single TB scheduled across a plurality of slots and across one of a plurality of sub-bands within a virtual cell or a plurality of component carriers associated with a carrier aggregation, and receive or transmit the TB via the plurality of slots and one of the plurality of sub-bands or the plurality of component carriers. In certain aspects, the apparatus may be a network device configured to transmit an indication of a TB scheduled across a plurality of slots and across one of a plurality of sub-bands within a virtual cell or a plurality of component carriers associated with a carrier aggregation and to transmit or receive the TB via the plurality of slots and one of the plurality of sub-bands or the plurality of component carriers.

### TECHNICAL FIELD

The present disclosure relates generally to communication systems, and more particularly, to a method of wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device such as a user equipment (UE) configured to receive an indication of a single transport block (TB) scheduled across a plurality of slots and across one of a plurality of sub-bands within a virtual cell or a plurality of component carriers associated with a carrier aggregation, and receive or transmit the TB via the plurality of slots and one of the plurality of sub-bands within the virtual cell or the plurality of component carriers associated with the carrier aggregation.

In an aspect of the disclosure, a method, a computer-readable medium, and an apparatus are provided. The apparatus may be a network device such as a base station configured to transmit an indication of a TB scheduled across a plurality of slots and across one of a plurality of sub-bands within a virtual cell or a plurality of component carriers associated with a carrier aggregation and to transmit or receive the TB via the plurality of slots and one of the plurality of sub-bands within the virtual cell or the plurality of component carriers associated with the carrier aggregation.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating modular schedulers associated with carrier aggregation (CA) in accordance with some aspects of the disclosure.

FIG. 4B is a diagram illustrating a virtual carrier/cell associated with flexible spectrum integration (FSI) and/or enhanced CA (ECA) in accordance with some aspects of the disclosure.

FIG. 5A is a diagram illustrating TB scheduling associated with FSI and/or ECA in accordance with some aspects of the disclosure.

FIG. 5B is a diagram illustrating TB scheduling associated with FSI and/or ECA in accordance with some aspects of the disclosure.

FIG. 6 is a diagram illustrating a single-TB mapping and/or scheduling across multiple CCs/SBs within a virtual cell/carrier in accordance with some aspects of the disclosure.

FIG. 7 is a diagram illustrating aspects of single-TB mapping and/or scheduling in accordance with some aspects of the disclosure.

FIG. 8 is a diagram illustrating aspects of single-TB mapping and/or scheduling in accordance with some aspects of the disclosure.

FIG. 9 is a diagram illustrating a semi-static indication of a set of resources in accordance with some aspects of the disclosure.

FIG. 10 is a diagram illustrating a semi-static indication of a set of resources in accordance with some aspects of the disclosure.

FIG. 11 is a diagram illustrating a semi-static indication of a set of resources in accordance with some aspects of the disclosure.

FIG. 12 is a diagram illustrating a semi-static indication of a set of resources in accordance with some aspects of the disclosure.

FIG. 13 is a diagram illustrating additional aspects of FSI/ECA scheduling including TB-repetition scheduling in accordance with some aspects of the disclosure.

FIG. 14 is a call flow diagram illustrating a method of wireless communication in accordance with some aspects of the disclosure.

FIG. 15 is a flowchart of a method of wireless communication.

FIG. 16 is a flowchart of a method of wireless communication.

FIG. 17 is a flowchart of a method of wireless communication.

FIG. 18 is a flowchart of a method of wireless communication.

FIG. 19 is a diagram illustrating an example of a hardware implementation for an example apparatus and/or network entity.

FIG. 20 is a diagram illustrating an example of a hardware implementation for an example network entity.

FIG. 21 is a diagram illustrating an example of a hardware implementation for an example network entity.

### DETAILED DESCRIPTION

In some aspects of wireless communication, carrier aggregation (CA) may theoretically be used to improve throughput, reliability, and/or power saving based on using a single scheduler and/or coordinated/integrated schedulers. In practice, schedulers for CA may remain modular such that the theoretical benefits may not be realized. In some aspects, an enhanced CA (ECA) and/or a flexible spectrum integration (FSI) in place of CA may be employed to realize the benefits of using a single scheduler for CA. For example, a plurality of component carriers (CCs) or sub-bands (SBs) in a same band and/or different bands may be integrated to form a virtual cell and/or a virtual carrier. In some aspects, the virtual cell may use a single CC for PDCCH associated with scheduling transport blocks (TBs) across the CCs included in the virtual cell and may integrate multiple CCs into a single (larger) virtual carrier. Using a virtual cell, in some aspects, each TB may be mapped onto a non-contiguous bandwidth part (BWP) or a group of BWPs where each BWP in the group of BWPs is activated on one SB or CC associated with the virtual cell.

Various aspects relate generally to scheduling schemes for FSI and/or ECA. Some aspects more specifically relate to a scheduling associated with a repetition of a TB across multiple CCs and/or SBs associated with the FSI and/or ECA (e.g., without a prior indication of a failure from a receiving device) and/or a scheduling associated with a transmission/reception of a (single) TB over multiple CCs and/or over multiple SBs associated with the FSI and/or ECA (e.g., CCs associated with ECA and/or SBs associated with a virtual cell/carrier), where the multiple CCs and/or SBs may be associated with different link directions (e.g., DL/UL or D/U) in any particular slot and/or symbol. For example, some aspects relate to indicating a time domain resource allocation (TDRA) and/or a frequency domain resource allocation (FDRA) for transmitting/receiving the TB repeated across multiple CCs and/or SBs and/or for transmitting/receiving the (single) TB over the multiple CCs and/or the multiple SBs. In some examples, a wireless device may be configured to receive an indication of a single TB scheduled across a plurality of slots and across one of a plurality of sub-bands within a virtual cell or a plurality of component carriers associated with a carrier aggregation and to transmit or receive the TB via the plurality of slots and one of the plurality of sub-bands within the virtual cell or the plurality of component carriers associated with the carrier aggregation. In some examples, a network device may be configured to transmit an indication of a TB scheduled across a plurality of slots and across one of a plurality of sub-bands within a virtual cell or a plurality of component carriers associated with a carrier aggregation and to transmit or receive the TB via the plurality of slots and one of the plurality of sub-bands within the virtual cell or the plurality of component carriers associated with the carrier aggregation.

Particular aspects of the subject matter described in this disclosure can be implemented to realize one or more of the following potential advantages. In some examples, by using FSI and/or ECA to schedule repetitions of a TB, or a single TB transmission/reception, across multiple SBs or CCs, the described techniques can be used to realize the potential improvements to throughput, reliability, and/or power consumption/saving associated with using a single scheduler and/or coordinated/integrated schedulers for multiple SBs and/or CCs.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

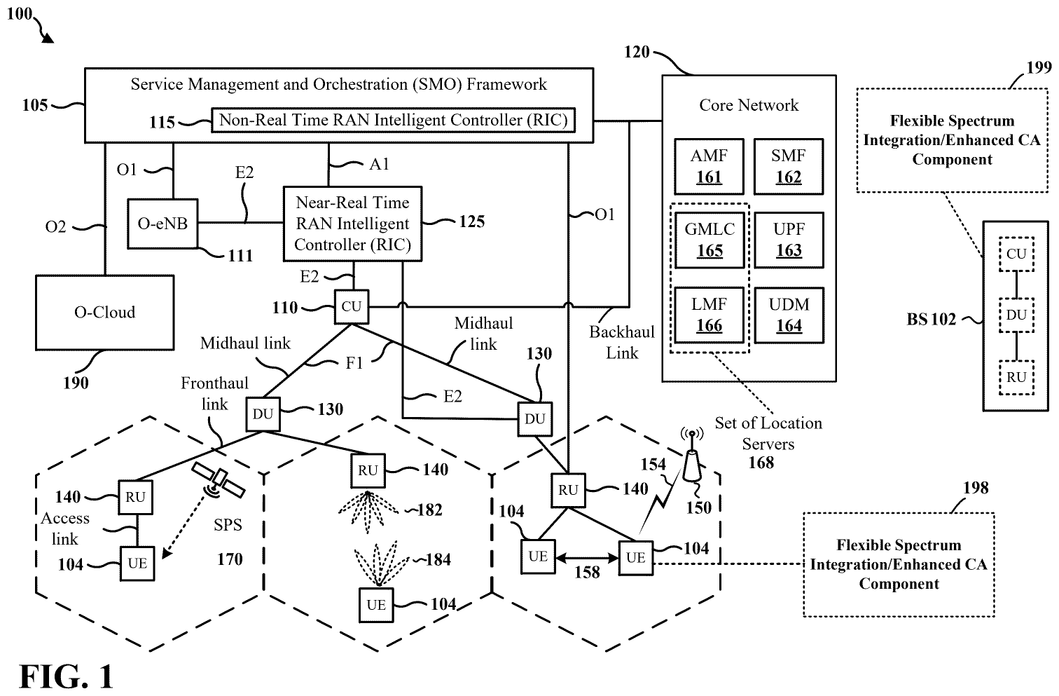

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHZ-7.125 GHZ) and FR2 (24.25 GHz-52.6 GHZ). Although a portion of FR1 is greater than 6 GHz, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a FSI/ECA component 198 that may be configured to receive an indication of a single TB scheduled across a plurality of slots and across one of a plurality of sub-bands within a virtual cell or a plurality of component carriers associated with a carrier aggregation, and receive or transmit the TB via the plurality of slots and one of the plurality of sub-bands within the virtual cell or the plurality of component carriers associated with the carrier aggregation. In certain aspects, the base station 102 may have a FSI/ECA component 199 that may be configured to transmit an indication of a TB scheduled across a plurality of slots and across one of a plurality of sub-bands within a virtual cell or a plurality of component carriers associated with a carrier aggregation and to transmit or receive the TB via the plurality of slots and one of the plurality of sub-bands within the virtual cell or the plurality of component carriers associated with the carrier aggregation. Although the following description may be focused on 5G NR, the concepts described herein may be applicable to other similar areas, such as LTE, LTE-A, CDMA, GSM, and other wireless technologies.

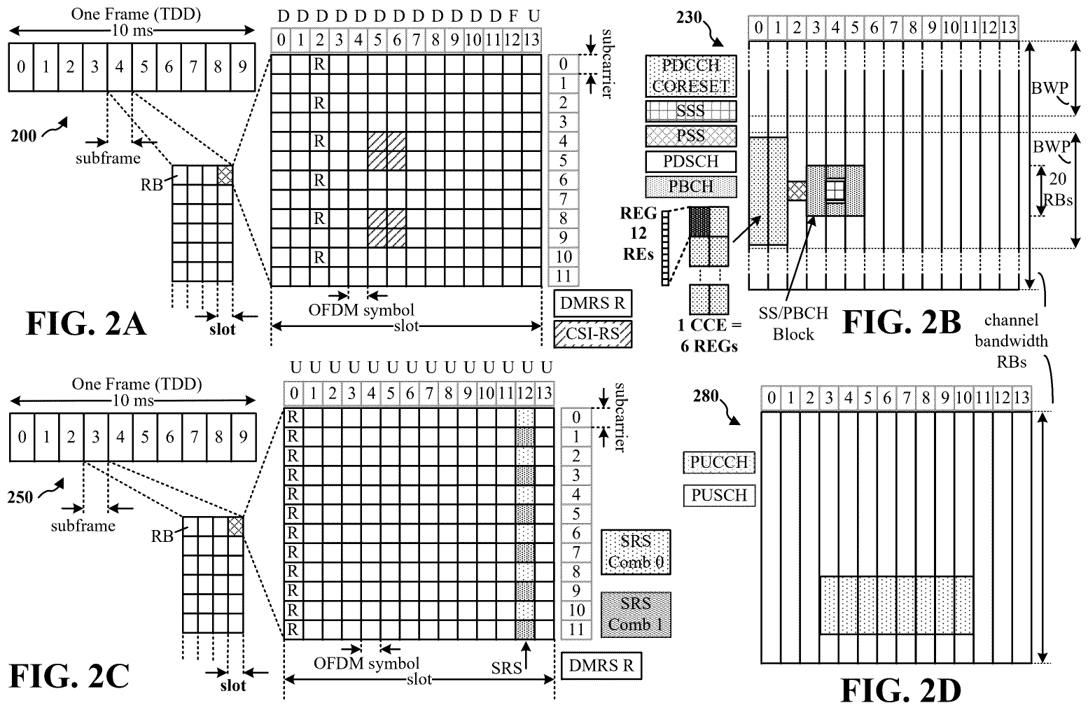

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD. TDD, in some aspects, is associated with a configuration in which, for a particular set of subcarriers (carrier system bandwidth), subframes within the set of subcarriers are dedicated for either DL or UL, while FDD is associated with a configuration in which, for a particular set of subcarriers (carrier system bandwidth), subframes within the set of subcarriers are dedicated for both DL and UL.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ*15} kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different BWPs (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

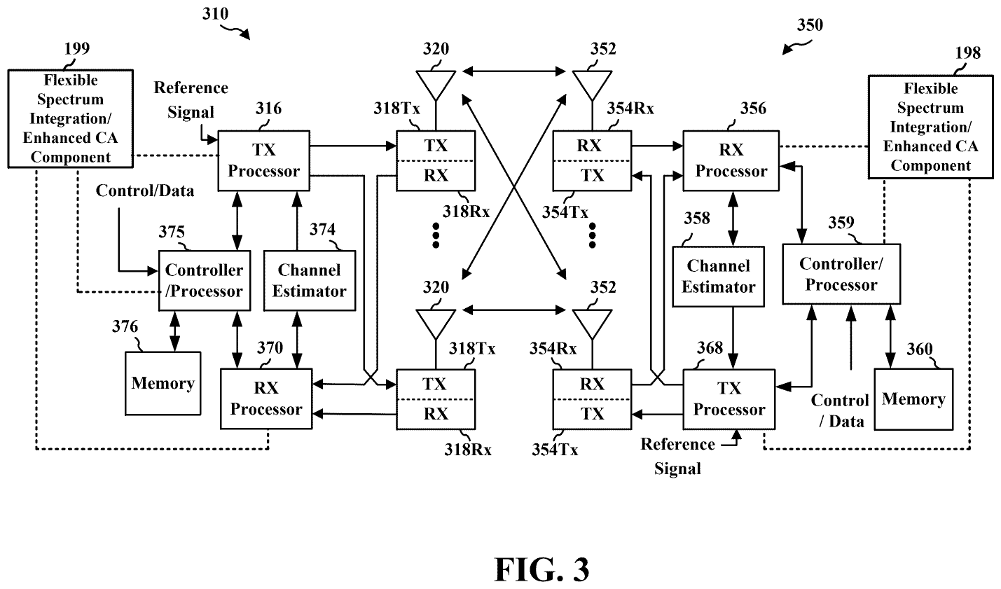

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the FSI/ECA component 198 of FIG. 1.

At least one of the TX processor 316, the RX processor 370, and the controller/processor 375 may be configured to perform aspects in connection with the FSI/ECA component 199 of FIG. 1.

In some aspects of wireless communication, carrier aggregation (CA) may theoretically be used to improve throughput, reliability, and/or power saving based on using a single scheduler and/or coordinated/integrated schedulers. For example, CA may leverage the best CCs to carry DL/UL data, may extend DL coverage by carrying UL control on the most robust cell (e.g., a PCell), may allow cross-CC scheduling, may improve PDCCH reliability, and/or may improve a UE's power saving. However, in practice, CA may be associated with inefficiency when aggregating small, scattered, low-band CCs and/or a lack of diversity associated with one or more of independent per-CC independent scheduling or the use of separate HARQ entities with transmission and retransmission on the same CC. In some aspects, the PCell/SCell abstraction (e.g., identifying CC's as PCell CC's or SCell CC's and inheriting characteristics of the PCell or SCell) may reduce flexibility. For example, based on the PCell/SCell abstraction, the UE and/or network may trigger a handover (HO) when a PCell is not robust (e.g., in the absence of layer 1 [L1] triggered mobility [LTM]), or the UE may perform initial access (IA) on, e.g., a TDD carrier, in the absence of most of the UL massive MIMO (mMIMO) gains.

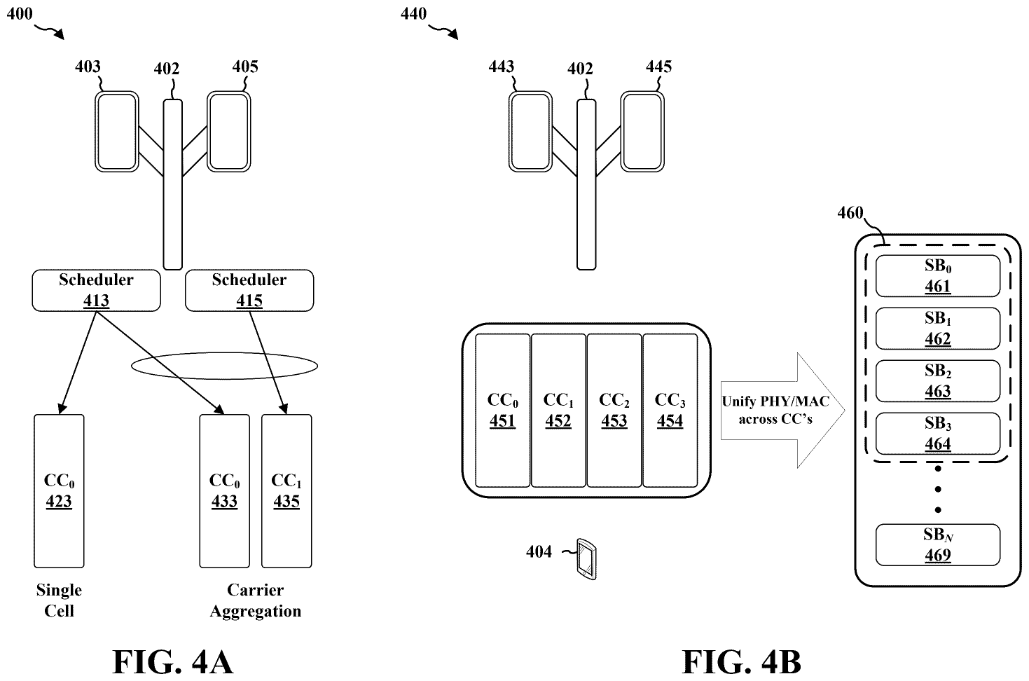

In some aspects, the failure to realize the potential benefits of CA may be associated with the schedulers for CA, in practice, remaining modular. FIG. 4A is a diagram 400 illustrating modular schedulers associated with CA in accordance with some aspects of the disclosure. Diagram 400 illustrates that a base station 402 may be associated with multiple antennas/cells (e.g., at least cell 403 and cell 405). Each antenna/cell may be associated with a CC (e.g., cell 403 may be associated with a first CC, e.g., CC₀ 423 for the single cell implementation and/or CC₀ 433 associated with CA, and cell 405 may be associated with a second CC, e.g., CC₁ 435 associated with CA). Each antenna/cell, in some aspects, may be associated with a different scheduler (e.g., cell 403 may be associated with scheduler 413 and cell 405 may be associated with scheduler 415). The different schedulers (e.g., scheduler 413 and scheduler 415), in some aspects, may be “stitched” together but may not coordinate most aspects of wireless communication and/or scheduling across CCs (e.g., may coordinate HARQ operation across CCs, but not coordinate other aspects of wireless communication and/or scheduling). Accordingly, the theoretical benefits may not be realized in practice. For example, the modular/separate schedulers may not use the best CC for DL/UL data and/or control and may not perform and/or utilize cross-CC scheduling such that the potential power savings at the UE may not be realized.

FIG. 4B is a diagram 440 illustrating a virtual carrier/cell associated with FSI and/or ECA in accordance with some aspects of the disclosure. In some aspects, an enhanced CA (ECA) and/or a flexible spectrum integration (FSI) in place of CA may be employed to realize the benefits of using a single scheduler for CA. Diagram 440 illustrates that a base station 402 may be associated with multiple antennas/cells (e.g., at least cell 443 and cell 445). Each antenna/cell may be associated with one or more CCs or SBs (e.g., any of CC₀ 451, CC₁ 452, CC₂ 453, and CC₃ 454 or SB₀ 461, SB₁ 462, SB₂ 463, and SB₃ 464). In some aspects of FSI/ECA, a plurality of CCs or sub-bands (e.g., CC₀ 451, CC₁ 452, CC₂ 453, and CC₃ 454 or SB₀ 461, SB₁ 462, SB₂ 463, and SB₃ 464), in a same band and/or different bands may be integrated to form a virtual cell and/or a virtual carrier 460, where additional CCs and/or SBs, such as SB_{N} 469, may not be associated with FSI/ECA for a particular UE 404.

In some aspects, the virtual cell/carrier may be treated as a single cell with regards to scheduling and/or HARQ. The virtual cell/carrier, in some aspects may use one CC and/or SB for PDCCH (e.g., for control transmissions for scheduling such as DCI). Using a single CC and/or SB for transmitting PDCCH, in some aspects, may result in fewer decoding attempts (e.g., for one CC/SB instead of multiple CCs/SBs) over a narrow RF range for PDCCH associated with a reduced power consumption. In some aspects, treating the virtual cell/carrier as a single carrier may allow the UE/network to unify re-transmissions across CCs/SBs for better diversity. In association with a virtual cell/carrier and/or FSI/ECA, different types of TB scheduling across aggregated CCs/SBs may be possible. In some aspects, small and scattered FDD channels (e.g., FDD CCs/SBs) may be integrated as one (larger) virtual carrier for a single-TB scheduling or multi-TB scheduling with a single-CC (or single SB) PDCCH may be used for the (larger) aggregated bandwidth (BW). BW adaptation using a BWP mechanism, in some aspects, may be associated with a low latency adaptation when triggered/initiated depending on a UE's RF BW and configured measurements.

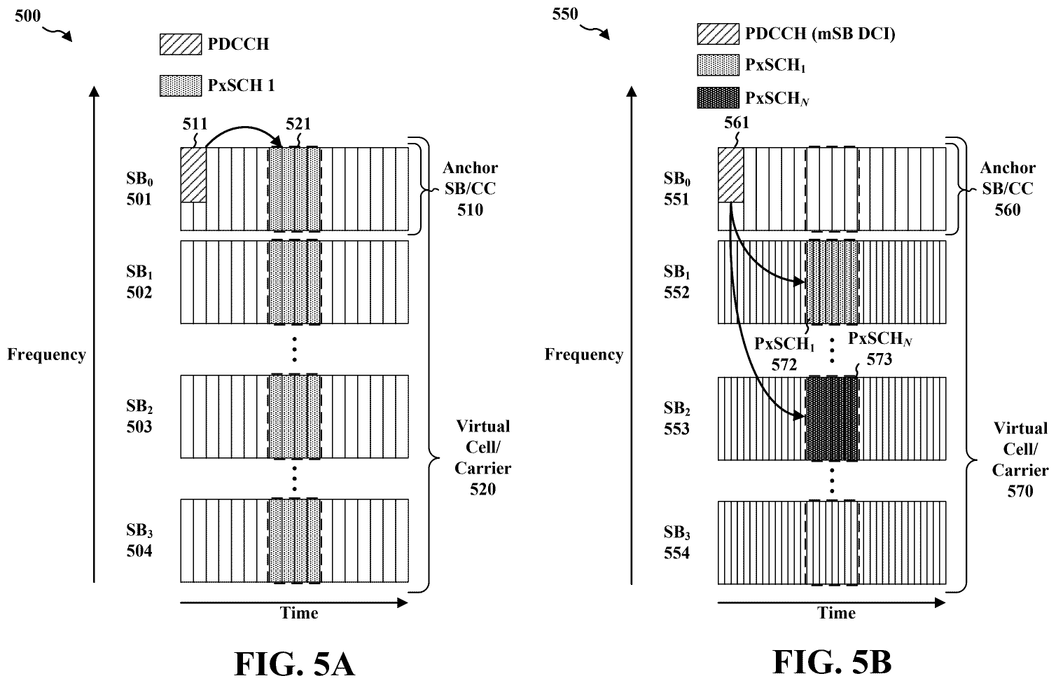

FIG. 5A is a diagram 500 illustrating TB scheduling associated with FSI and/or ECA in accordance with some aspects of the disclosure. In some aspects of FSI/ECA, TB scheduling may be associated with a single PxSCH 521 (e.g., where x may be D or U scheduled by PDCCH) for a TB scheduled across multiple CCs/SBs (e.g., SB₀ 501, SB₁ 502, SB₂ 503, and SB₃ 504). While illustrated for a PxSCH 521, the TB scheduling may, in some aspects, be associated with a scheduled PUCCH. Aspects associated with scheduling a single TB across multiple CCs/SBs may be referred to as “jointly mapping,” “single-TB scheduling,” a “joint mapping,” or a “single-TB mapping” implementation and/or method. For example, a TB (e.g., associated with PxSCH 521) scheduled via PDCCH 511 may be mapped onto a non-contiguous BWP (e.g., a BWP spanning and/or including SB₀ 501, SB₁ 502, SB₂ 503, and SB₃ 504) activated within, or associated with, a virtual cell 520 (e.g., a virtual cell/carrier). In some aspects of FSI/ECA, a UE may monitor for PDCCH and/or perform a PDCCH blind detection on an anchor SB/CC 510 (e.g., an SB/CC including a set of PDCCH candidates). The UE may, in some aspects of FSI/ECA, refrain from, or omit, monitoring for a PDCCH and/or performing a PDCCH blind decoding on other CCs/SBs of the virtual cell 520. In some aspects, a TB mapping across CCs/SBs may be associated with a code block (CB) level interleaving which may be used in a low-band spectrum with small channels. A TB spanning different CCs/SBs, in some aspects, may be scheduled with different link parameters such as modulation order, SCS, and rank (for different CCs/SBs).

FIG. 5B is a diagram 550 illustrating TB scheduling associated with FSI and/or ECA in accordance with some aspects of the disclosure. In some aspects of FSI/ECA, TB scheduling may be associated with multiple PxSCH transmissions (e.g., PxSCH₁ 572 and PxSCH_{N} 573, where PxSCH may refer to either PDSCH or PUSCH for DL or UL, respectively and where the scheduling may be for PUCCH in some aspects) for multiple TBs scheduled across multiple CCs/SBs (e.g., SB₀ 551, SB₁ 552, SB₂ 553, and SB₃ 554). For example, multiple TBs (e.g., a TB associated with each of PxSCH₁ 572 and PxSCH_{N} 573 or a PUCCH [not shown]) may be scheduled via PDCCH 561 and may be mapped onto one CC/SB (e.g., one of SB₀ 551, SB₁ 552, SB₂ 553, or SB₃ 554) within, or of, a virtual cell 570 (e.g., a virtual cell/carrier). For example, a first TB (e.g., associated with PxSCH₁ 572) may be mapped to SB₁ 552 and a second TB (e.g., associated with PxSCH_{N} 573) may be mapped to SB₂ 553. In some aspects of FSI/ECA, a UE may monitor for PDCCH and/or perform a PDCCH blind detection on an anchor SB/CC 560 (e.g., an SB/CC including a set of PDCCH candidates). The UE may, in some aspects of FSI/ECA, refrain from, or omit, monitoring for a PDCCH and/or performing a PDCCH blind decoding on other CCs/SBs of the virtual cell 570. In some aspects, scheduling transmissions (e.g., TBs) for all the CCs/SBs may be via a PDCCH associated with the anchor CC/SB such that the UE may not support self-CC scheduling. In some aspects, multiple TB scheduling using different CCs/SBs may be used when the individual CCs/SBs are associated with sufficiently large channel BWs such that cross-CC/cross-SB diversity may not provide a benefit outweighing the additional complexity of cross-CC/cross-SB scheduling. Both intra-band and inter-band multiple TB scheduling scenarios may be supported. In some aspects, aggregation and/or integration of CCs/SBs with different numerologies (e.g., SCS) may be supported despite introducing additional complexity. Because the virtual cell/carrier (e.g., virtual cell 570) is a single HARQ entity, frequency diversity across HARQ transmissions may be achieved.

When using FSI/ECA, in some aspects, a single HARQ entity may be assumed across all SBs. As indicated in diagram 500 of FIG. 5A, a TB, in some aspects of FSI/ECA, may be scheduled across multiple CCs/SBs. In some aspects of FSI/ECA, a TB may be re-transmitted via different CCs/SBs (or sets of CCs/SBs) in case of a decoding failure. The FSI/ECA, in some aspects, may be applied to CCs/SBs with different duplexing modes, different slot formats, and/or different SCS. For example, the different duplexing modes may include TDD, FDD, or SBFD (e.g., in which slots may be associated with one of UL, DL, or non-overlapping sets of UL resources/subcarriers, DL resources/subcarriers, and guard band resources/subcarriers), and a mismatch in transmission direction associated with a particular slot may result from a first CC/SB of a virtual cell/carrier being associated with a first duplexing method, e.g., FDD/TDD/SBFD and a second CC/SB of the virtual cell/carrier being associated with a same or different duplexing method associated with a different transmission direction (FDD vs. TDD, TDD in one direction vs. TDD in an opposite direction [for TDD CCs/SBs in different frequency bands], or TDD vs. SBFD). In some aspects experiencing a mismatch in transmission direction, a simple mapping of a TB across CCs/SBs may not be possible (e.g., a DL transmission may not be able to be mapped to an UL, or U, slot/symbol). For example, for a TDD CC/SB and FDD CC/SB integrated and/or aggregated into a virtual cell/carrier using FSI/ECA, if the slot directions are D and U, a DL TB, or UL TB, can be mapped to the CC/SB associated with the D slot, or the U slot, respectively, and diversity gains may be achieved when transmission directions align across CCs/SBs, but not when transmission directions are not aligned across CCs/SBs. In some aspects, a method of mapping a single TB across CCs/SBs is provided that may achieve diversity gains based on improved time and/or frequency resource allocation and signaling.

As discussed above, in some aspects, we may assume that a single TB may be jointly mapped to resources across CCs/SBs (e.g., that coded bits may be read from the HARQ buffer once, where the number of selected bits depends on the “total number of resources” available across CCs/SBs based on a number of MIMO layers per CC/SB and MCS per CC/SB), and that retransmission of a TB may occur on different CCs/SBs than the CCs/SBs used for the previous transmissions of the same TB. In some aspects, instead of mapping a TB across resources in available to different CCs/SBs (e.g., across multiple CCs/SBs), a HARQ-less repetition of a TB across CCs/SBs can be employed (e.g., which may be referred to as a “TB repetition” implementation and/or method or “TB repetition scheduling” and may be associated with a repeated transmission of a same TB via multiple CCs/SBs without an indication that a first transmission of the TB has failed). Transmitting the same TB via multiple CCs/SBs effectively brings the diversity gain expected from single-TB scheduling of FSI/ECA (e.g., the transmission of a single TB across resources of different CCs/SBs), but instead of jointly mapping a single TB to resources across different CCs/SBs for transmission/reception, a TB may be repeated across CCs/SBs (and, in some aspects, also across time) in a HARQ-less manner. In some aspects, the TB repetition scheduling may be easier to specify and/or indicate, but may perform slightly worse than single-TB scheduling (e.g., due to coding loss). Some aspects address the signaling associated with single-TB scheduling and/or mapping and TB repetition scheduling.

Various aspects relate generally to scheduling schemes for FSI and/or ECA. Some aspects more specifically relate to a scheduling associated with a repetition of a TB across multiple CCs and/or SBs associated with the FSI and/or ECA (e.g., without a prior indication of a failure from a receiving device) and/or a scheduling associated with a transmission/reception of a (single) TB over multiple CCs and/or over multiple SBs associated with the FSI and/or ECA (e.g., CCs associated with ECA and/or SBs associated with a virtual cell/carrier), where the multiple CCs and/or SBs may be associated with different link directions (e.g., DL/UL or D/U) in any particular slot and/or symbol. For example, some aspects relate to indicating a TDRA and/or an FDRA for transmitting/receiving the TB repeated across multiple CCs and/or SBs and/or for transmitting/receiving the (single) TB over the multiple CCs and/or the multiple SBs. In some examples, a wireless device may be configured to receive an indication of a single TB scheduled across a plurality of slots and across one of a plurality of sub-bands within a virtual cell or a plurality of component carriers associated with a carrier aggregation and to transmit or receive the TB via the plurality of slots one of the plurality of sub-bands within the virtual cell or the plurality of component carriers associated with the carrier aggregation. In some examples, a network device may be configured to transmit an indication of a TB scheduled across a plurality of slots and across one of a plurality of sub-bands within a virtual cell or a plurality of component carriers associated with a carrier aggregation and to transmit or receive the TB via the plurality of slots and one of the plurality of sub-bands within the virtual cell or the plurality of component carriers associated with the carrier aggregation.

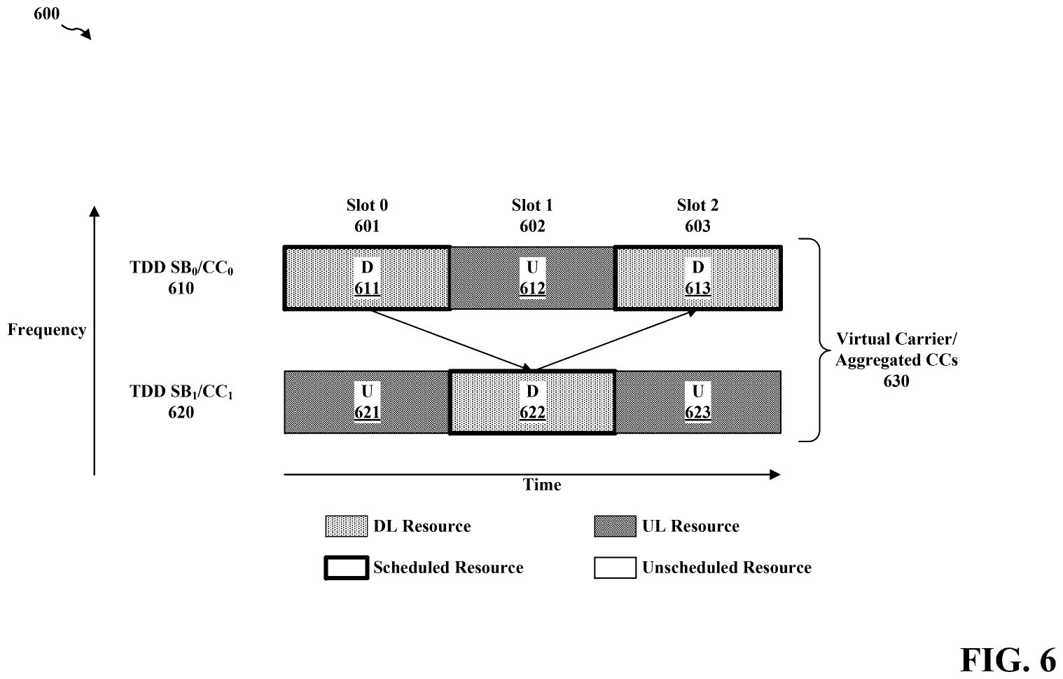

FIG. 6 is a diagram 600 illustrating a single-TB mapping and/or scheduling across multiple CCs/SBs within a virtual cell/carrier in accordance with some aspects of the disclosure. Diagram 600 illustrates that a virtual cell/carrier (e.g., virtual carrier/Aggregated CCs 630) may include a first TDD SB₀/CC₀ 610 and a second TDD SB₁/CC₁ 620. The first TDD SB₀/CC₀ 610 may be associated with a first pattern of slot formats {D 611, U 612, D 613} and the second TDD SB₁/CC₁ 620 may be associated with a second pattern of slot formats {U 621, D 622, U 623} in slots 0, 1, and 2 (e.g., slot 601, slot 602, and slot 603, respectively). Based on the slot format, a single TB may be scheduled and/or configured to be transmitted/received across the different SBs within the virtual cell (or CCs in case of CA) and in different time-domain resources (e.g., slots). For example, a single DL TB may be scheduled over both time and frequency across the SBs/CCs associated with the virtual carrier/Aggregated CCs 630, e.g., via the first TDD SB₀/CC₀ 610 during a first slot (e.g., slot 0 or D 611), via the second TDD SB₁/CC₁ 620 during a second slot (e.g., slot 1 or D 622), and via the first TDD SB₀/CC₀ 610 during a third slot (e.g., slot 2 or D 613). While this example is illustrated in relation to DL, it is equally applicable to UL transmissions/receptions.

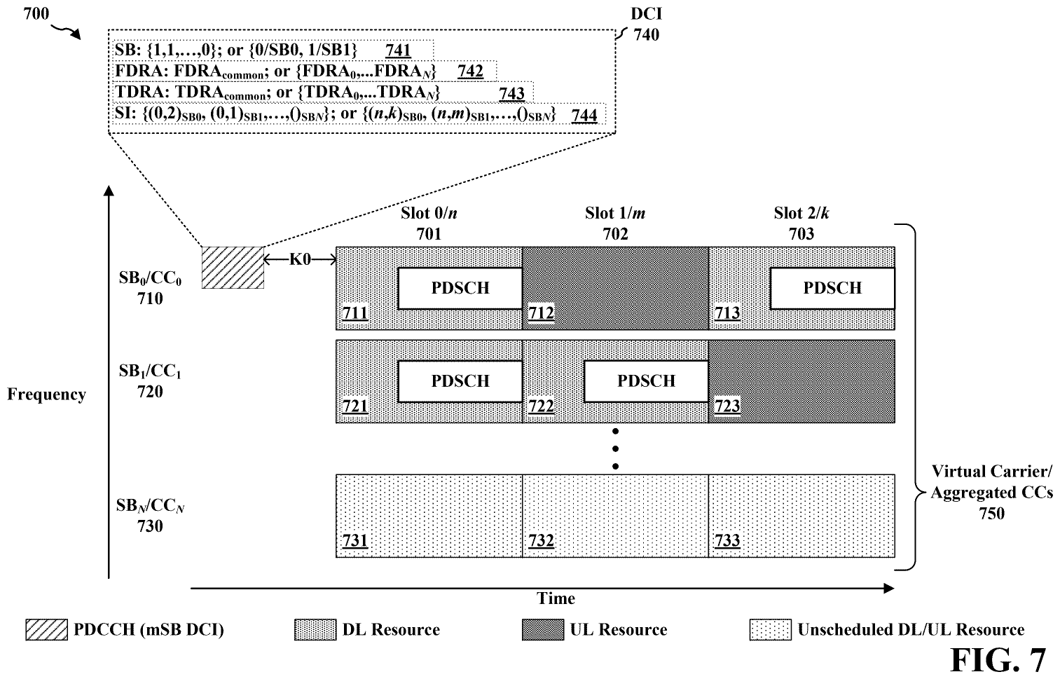

FIG. 7 is a diagram 700 illustrating aspects of single-TB mapping and/or scheduling in accordance with some aspects of the disclosure. Diagram 700 illustrates a virtual carrier/aggregated carrier 750 including N+1 SBs/CCs (e.g., including SB₀/CC₀ 710, SB₁/CC₁ 720, and SB_{N}/CC_{N} 730). Diagram 700 further illustrates that the different SBs/CCs may have different slot formats over a set of slots including slots 0/n, 1/m, and 2/k (e.g., slot 701, slot 702, and slot 703, respectively). Sets of candidate time-and-frequency resources for TB transmission/reception (e.g., resources 711, resources 712, resources 713, resources 721, resources 722, resources 723, resources 731, resources 732, and resources 733 each including a set of REs to which a TB may be mapped) may be identified by a slot and an SB/CC (e.g., resources 711 may be identified with SB₀/CC₀ 710 and slot 701, and the other resources 712 to 733 may similarly be identified by a corresponding combination of SB/CC and slot).

A PDCCH transmission, in some aspects, may include a DCI 740 indicating the single-TB scheduling information. For example, in some aspects, scheduling DCI for dynamically granted PxSCH (e.g., PDSCH/PUSCH), may provide time and frequency assignments (e.g., may indicate time and frequency resources in each SB/CC for transmission of [a part of] the TB). For a given TB, the scheduling DCI, in some aspects, may indicate frequency (domain) resources at different levels, e.g., SB/CC level frequency resources and intra-SB/CC (e.g., RB or RB group [RBG]) level frequency resources. The scheduling DCI, in some aspects, may include an SB/CC level frequency resource indication of SBs/CCs to which the TB is (or will be) mapped, e.g., the DCI 740 scheduling a transmission/reception of a PDSCH may include an indication of a set of SBs/CCs associated with the transmission/reception of the TB (e.g., an SB/CC field 741 indicating the set of SBs/CCs via a bitmap or a set of SB/CC indices). For example, the DCI 740 may indicate SB/CC level frequency resources associated with a transmission (from a network device) and reception (at a UE) (e.g., an indication of SB₀/CC₀ 710 and SB₁/CC₁ 720 as being SBs/CCs to which the TB is mapped) in a subset of (PDSCH) resources in resources 711, 713, 721, and 722 indicated as PDSCH in diagram 700. In some aspects, the DCI 740 may precede a first slot associated with the transmission/reception of the TB by a time, or number of slots, that is at least at threshold time or number of slots indicated by K0 for DL (e.g., PDSCH) or K2 for UL (e.g., PUSCH or PUCCH).

In some aspects, for a given TB, the scheduling DCI may further indicate intra-SB/CC (e.g., RB or RBG) level frequency resources via an FDRA (e.g., via an FDRA field 742). The indication of the frequency resources, in some aspects, may be a single FDRA applied to all SBs/CCs and slots (e.g., FDRA_{common} in FDRA field 742). In some aspects, a set of FDRAs may be indicated, in some aspects, corresponding to the set of slots such that each slot is associated with a corresponding FDRA in the set of FDRAs over the set of SBs/CCs, but the FDRAs in the set of FDRAs corresponding to each slot may indicate different frequency resources (e.g., a set of FDRAs, {FDRA_{0/n}, FDRA_{1/m}, FDRA_{2/k}}, may be provided in FDRA field 742). A set of FDRAs may be indicated, in some aspects, corresponding to the set of SBs/CCs such that each SB/CC is associated with a corresponding FDRA in the set of FDRAs over the set of slots, but the FDRAs in the set of FDRAs corresponding to each SB/CC may indicated different frequency resources (e.g., a set of FDRAs, {FDRA₀, . . . , FDRA_{N}}, may be provided in FDRA field 742). In some aspects, an FDRA may be provided for each SB/CC for each slot (e.g., a set of FDRAs, {FDRA_{0,0/n}, FDRA_{0,1/m}, FDRA_{0,2/k}, . . . , FDRA_{N,0/n}, FDRA_{N,1/m}, FDRA_{N,2/k}}, may be provided in FDRA field 742).

As described above for the indication of frequency resources, the scheduling DCI, in some aspects, may indicate time (domain) resources at different levels, e.g., slot level time resources and intra-slot (e.g., symbol) level time resources. In some aspects, for a given TB, the scheduling DCI may indicate time resources via an explicit slot index or slot offset indicating slot level time resources to which the TB is (or will be) mapped (e.g., in one or more SBs/CCs indicated for TB mapping during the slot). For example, the DCI 740 may indicate (slot level) time resources in a slot indication (SI) field 744 as one of {(0,2)_{SB0}, (0,1)_{SB1}, . . . , ( )_{SBN}} (e.g., indicating a set of offsets from a first slot associated with the TB for each SB/CC of a set of SBs/CCs indicated by a frequency resource allocation/indication in the DCI 740 or from a first slot associated with the TB for the set of SBs/CCs) or {(n,k)_{SB0}, (n,m)_{SB1}, . . . , ( )_{SBN}} (e.g., indicating a set of slot indices associated with the TB for each SB/CC of the set of SBs/CCs). In some aspects, the first slot may be determined based on a time and or number of slots K0 (or K2) from a last symbol of a DCI scheduling the DL (or UL) transmission associated with the TB. The slot indexes and/or offsets, in some aspects, may be based on a configured reference SCS, an SCS of an anchor SB/CC, an SCS of the first SB/CC used for Tx/Rx, a largest SCS (e.g., associated with a shortest slot), or for each SB/CC based on its own SCS.

In some aspects, intra-slot (symbol) level time resources may be indicated via a TDRA (e.g., via a TDRA field 743 used to indicate a starting symbol and a length/duration per slot). The indication of the time resources, in some aspects, may be a single TDRA (e.g., TDRA_{common} in TDRA field 743) applied to all indicated SBs/CCs, slots, or resources (e.g., resources indicated by a combination of frequency resource indication and slot level time resource allocation). In some aspects, “indicated SBs/CCs” may refer to SBs/CCs indicated to include a transmission/reception of the TB (e.g., to which the TB is mapped) based on the SB/CC level frequency resource indication (e.g., the indication of the set of SBs/CCs), “indicated slots” may refer to slots indicated to include a transmission/reception of the TB (e.g., to which the TB is mapped) based on the slot level time resource indication (e.g., the indication of the slot index or slot offset as described above), and “indicated resources” may refer to resources indicated by a combination of a (SB/CC and/or intra-SB/CC) frequency resource indication and a slot level time resource indication to include a transmission/reception of the TB (e.g., to which the TB is mapped) based on the intersection of the frequency resource indication and the time resource indication. In some aspects, a set of TDRAs may be indicated, in some aspects, corresponding to the set of slots such that each slot is associated with a corresponding TDRA in the set of TDRAs over the set of indicated SBs/CCs, but the TDRAs in the set of TDRAs corresponding to each slot may indicate different time resources (e.g., a set of TDRAs, {TDRA_{0/n}, TDRA_{1/m}, TDRA_{2/k}}, may be provided in TDRA field 743). A set of TDRAs may be indicated, in some aspects, corresponding to the set of SBs/CCs such that each SB/CC is associated with a corresponding TDRA in the set of TDRAs over the set of slots, but the TDRAs in the set of TDRAs corresponding to each SB/CC may indicated different time resources (e.g., a set of TDRAs, {TDRA₀, . . . , TDRA_{N}}, may be provided in TDRA field 743). In some aspects, an TDRA may be provided for each SB/CC for each slot (e.g., a set of TDRAs, {TDRA_{0,0/n}, TDRA_{0,1/m}, TDRA_{0,2/k}, . . . , TDRA_{N,0/n}, TDRA_{N,1/m}, TDRA_{N,2/k}}, may be provided in TDRA field 743).

In some aspects, the TDRA may be a TDRA associated with a single slot (e.g., a legacy TDRA). In some aspects, the TDRA may be a TDRA configured to indicate resources (e.g., symbols) spanning multiple slots which may be referred to as a “long TDRA.” When using a long TDRA spanning the set of slots over which the TB is scheduled, the long TDRA may be indicated across the set of SBs/CCs or may be indicated per SB/CC in the set of SBs/CCs. In some aspects, the long TDRA may cover slots associated with a transmission/reception direction of the TB (either D or U slots) and “opposing” slots associated with a transmission/reception direction that is opposite to the transmission/reception direction of the TB (either U or D slots, respectively). The opposing slots, in some aspects, may be counted as part of the duration and/or span indicated by the long TDRA but may not be associated with a transmission/reception of the TB.

In some aspects, the opposing slots may not be counted as part of the duration and/or span indicated by the long TDRA (and may, accordingly, not be associated with a transmission/reception of the TB). For example, if not counting the opposing slots, a long TDRA may indicate a starting symbol of 5 and a duration of 19 symbols such that for a first SB/CC having a slot format of {D, U, D} the TB would be scheduled for transmission/reception during the first slot and continue in the third slot, while for a second SB/CC having a slot format of {D, D, X}, the TB would be scheduled for transmission/reception during the first slot and continue in the second slot. If counting the opposing slots, a long TDRA may, for example, indicate a starting symbol of 5 and a duration of 33 symbols such that for a first SB/CC having a slot format of {D, U, D} the TB would be scheduled for transmission/reception during the first slot and continue in the third slot, while for a second SB/CC having a slot format of {D, D, U}, the TB would be scheduled for transmission/reception during the first slot and continue in the second slot, and for a third SB/CC having a slot format of {D, D, D}, the TB would be scheduled for transmission/reception during the first slot and continue in the second slot and the third slot. While discussed at the slot level, the considerations relating to the slot format (e.g., a transmission/reception direction associated with a slot) may be applied to symbol level format associated with a transmission/reception direction associated with a symbol. In some aspects, in addition to U and D symbols, a slot may include flexible, ‘F,’ symbols that may be treated as either U or D symbols and/or gap symbols to allow a UE to switch between UL transmission and DL reception. The F symbols, in some aspects, may be treated as being in one of a same transmission/reception direction as a transmission/reception direction for a scheduled TB in a neighboring symbol or an opposite transmission/reception direction from the transmission/reception direction for the scheduled TB in the neighboring symbol. In some aspects, the gap symbols may be treated as being in the opposite transmission/reception direction from a transmission/reception direction for a scheduled TB in a neighboring symbol.

In some aspects, the UE may interpret frequency-domain and time-domain assignments (e.g., an SB/CC indication, a slot indication, the FDRA, and/or the TDRA) together to determine which resources are associated with the transmission/reception of the scheduled TB (e.g., to determine the resources to which to map the TB). For example, a valid FDRA and/or TDRA may be indicated for each SB/CC (e.g., for each of the resources 711 to 733), but in some slots, that SB/CC (or the corresponding resources of the resources 711 to 733) may not be used, e.g., based on a slot level time resource indication (or signaling) and/or based on a SB/CC level frequency resource indication (or signaling). For example, in slot 1/m (e.g., slot 702), although the indicated FDRA and/or TDRA may be provided for, or apply to, SB₀/CC₀ 710 and SB_{N}/CC_{N} 730 (e.g., as FDRA_{common}, FDRA_{1/m}, FDRA₀/FDRA_{N}, TDRA_{common}, TDRA_{1/m}, TDRA₀/TDRA_{N}), SB₀/CC₀ 710 and SB_{N}/CC_{N} 730 may not be used to transmit/receive, or may not be associated with a transmission/reception of, the TB scheduled by the DCI if SB₀/CC₀ 710 and SB_{N}/CC_{N} 730 are not indicated for mapping the TB by the grant for TB scheduling during slot 1/m such as for SB_{N}/CC_{N} 730 which is not indicated in the SB/CC field 741 to be used for mapping the TB in any slot, or for SB₀/CC₀ 710 which is not indicated to be used for mapping the TB in the slot 1/m (e.g., by the value (n,k)_{SB0} or (0,2)_{SB0} in the SI field 744). Similarly, SB₀/CC₀ 710 and SB_{N}/CC_{N} 730 may not be used to transmit/receive, or may not be associated with a transmission/reception of, the TB scheduled by the DCI if the resources associated with the SB/CC for the slot are in an opposite direction from the transmission/reception of the TB such as for SB₀/CC₀ 710 during slot 1/m.

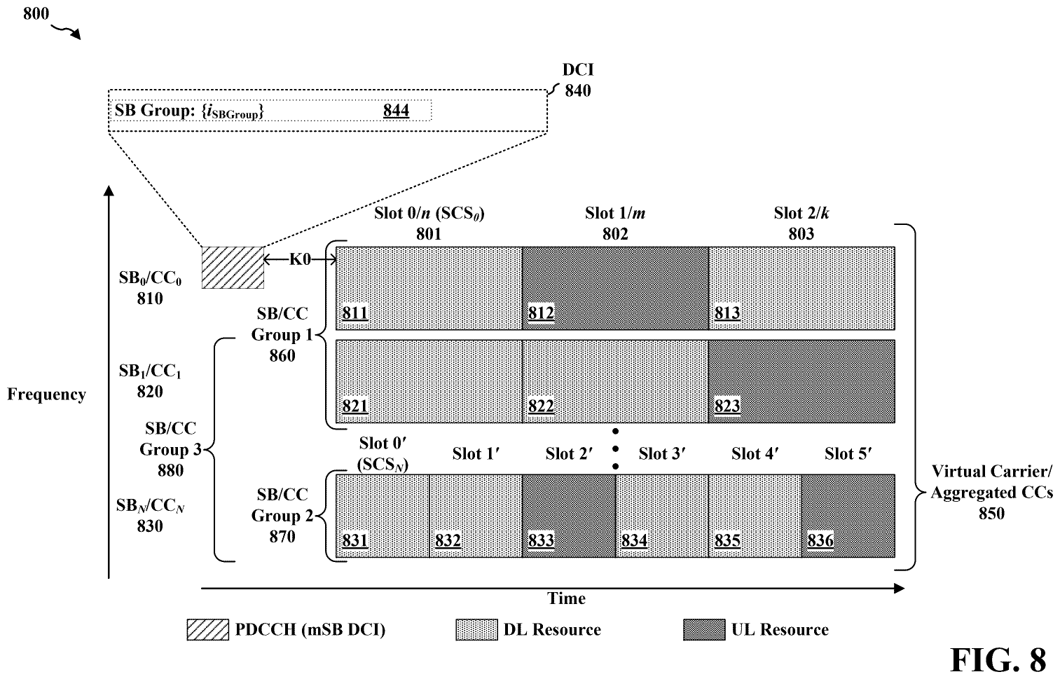

FIG. 8 is a diagram 800 illustrating aspects of single-TB mapping and/or scheduling in accordance with some aspects of the disclosure. Diagram 800 illustrates a virtual carrier/aggregated carrier 850 including N+1 SBs/CCs (e.g., including SB₀/CC₀ 810, SB₁/CC₁ 820, and SB_{N}/CC_{N} 830). Diagram 800 further illustrates that the different SBs/CCs may have different slot formats over a set of slots including slots 0/n, 1/m, and 2/k (e.g., slot 801, slot 802, and slot 803, respectively). Sets of candidate time-and-frequency resources for TB transmission/reception (e.g., resources 811, resources 812, resources 813, resources 821, resources 822, resources 823, resources 831, resources 832, resources 833, resources 834, resources 835, and resources 836 each including a set of REs to which a TB may be mapped) may be identified by a slot and an SB/CC (e.g., resources 811 may be identified with SB₀/CC₀ 810 and slot 801, and the other resources 812 to 833 may similarly be identified by a corresponding combination of SB/CC and slot).

In some aspects, the SBs/CCs in the virtual carrier/aggregated carrier 850 may be grouped into subsets of SBs/CCs used for single-TB (or TB repetition) scheduling. For example, diagram 800 illustrates that the virtual carrier/aggregated carrier 850 may be divided into multiple groups of SBs/CCs (e.g., two or more of a first SB/CC group 860, a second SB/CC group 870, and/or a third SB/CC group 880). In some aspects, a group may not include SBs/CCs with different SCSs (e.g., the first SB/CC group 860, and the second SB/CC group 870), while in other aspects, a group may include SBs/CCs with different SCSs (e.g., the third SB/CC group 880). The association of SBs/CCs to SB/CC groups for scheduling, in some aspects, may be indicated to a UE by one or more of (UE-specific) RRC signaling, a MAC-CE, or DCI. When using SB/CC groups, the DCI 840, in some aspects may include an SB/CC group index (e.g., via an SB/CC group index “i_{SBGroup}” in an SB/CC group field 844) that identifies the SBs/CCs associated with a scheduled TB (e.g., based on the RRC signaling). The SB/CC group index, in some aspects, may also indicate an order associated with the SBs/CCs (e.g., for providing an ordered list of values associated with SB/CC indication and/or resource allocation/assignment) or the order may be implied by frequencies associated with each SB/CC or inherited from an ordering associated with the full set of SBs/CCs associated with the virtual carrier/aggregated carrier 850.

In some aspects, the subsets of SBs/CCs may be selected to provide frequency diversity within and/or across the group and/or subset of SBs/CCs. In some aspects, the grouping (e.g., subdivision) may be performed if the number of SBs/CCs in the virtual carrier/aggregated carrier 850 is large (e.g., larger than a threshold number, such as if N+1>#_{threshold}) to reduce the signaling overhead associated with per-SB/CC signaling. For example, signaling overhead associated with per-SB/CC signaling may be reduced by indicating a group and/or subset including fewer than all the SBs/CCs in the virtual carrier/aggregated carrier. In some aspects, whether to perform the grouping (e.g., the subdivision) may depend on the BW of each SB/CC (e.g., a minimum BW across SBs/CCs), a total BW across SBs/CCs, a minimum BW across SBs/CCs in the possible groups that may be formed, and/or a total BW across SBs/CCs in the possible groups that may be formed. For a virtual carrier/aggregated carrier including six SBs/CCs (e.g., SB₀/CC₀ to SB₅/CC₅), for example, frequency diversity may be achieved by using one of two groups of three SBs/CCs (e.g., either SB₀/CC₀, SB₂/CC₂, and SB₄/CC₄ or SB₁/CC₁, SB₃/CC₃, and SB₅/CC₅ or other division of SBs/CCs) and, when using a bitmap in the grant or DCI to indicate SBs/CCs for a transmission/reception of the TB (e.g., to indicate SBs/CCs to which the TB are, or will be, mapped), the indication may use, e.g., four bits instead of six bits (e.g., may use one bit to indicate which group of SBs/CCs and one bit for each of the three associated SBs/CCs to indicate whether it is an SB/CC to which the TB is, or will be, mapped, instead of using one bit for each of the six SBs/CCs in the virtual carrier/aggregated carrier to indicate whether it is an SB/CC to which the TB is, or will be, mapped). Additional signaling overhead associated with per-SB/CC FDRA and/or TDRA could similarly be reduced by reducing the number of SBs/CCs for which the per-SB/CC FDRA and/or TDRA is signaled. Alternatively, or additionally, the virtual carrier/aggregated carrier including six SBs/CCs (e.g., SB₀/CC₀ to SB₅/CC₅) may be divided into three groups of two SBs/CCs (e.g., SB₀/CC₀ and SB₃/CC₃, SB₁/CC₁ and SB₄/CC₄, or SB₂/CC₂ and SB₅/CC₅) to further reduce the signaling overhead associated with per-SB/CC FDRA and/or TDRA.

While specific examples of division into two and three groups of a same number of SBs/CCs is presented above, other divisions may be used based on the frequency ranges associated with the different SBs/CCs. For example, in some aspects, a group of SBs/CCs may include SBs/CCs in a single frequency range (e.g., FR1 or FR2) such that no group of SBs/CCs spans multiple frequency ranges. In some aspects, a first SB/CC may be the only member of a first group based on spanning a large enough frequency range (or number of subcarriers) to provide frequency diversity within the SB/CC while different numbers of smaller SBs/CCs may be grouped to provide frequency diversity for different SB/CC groups.

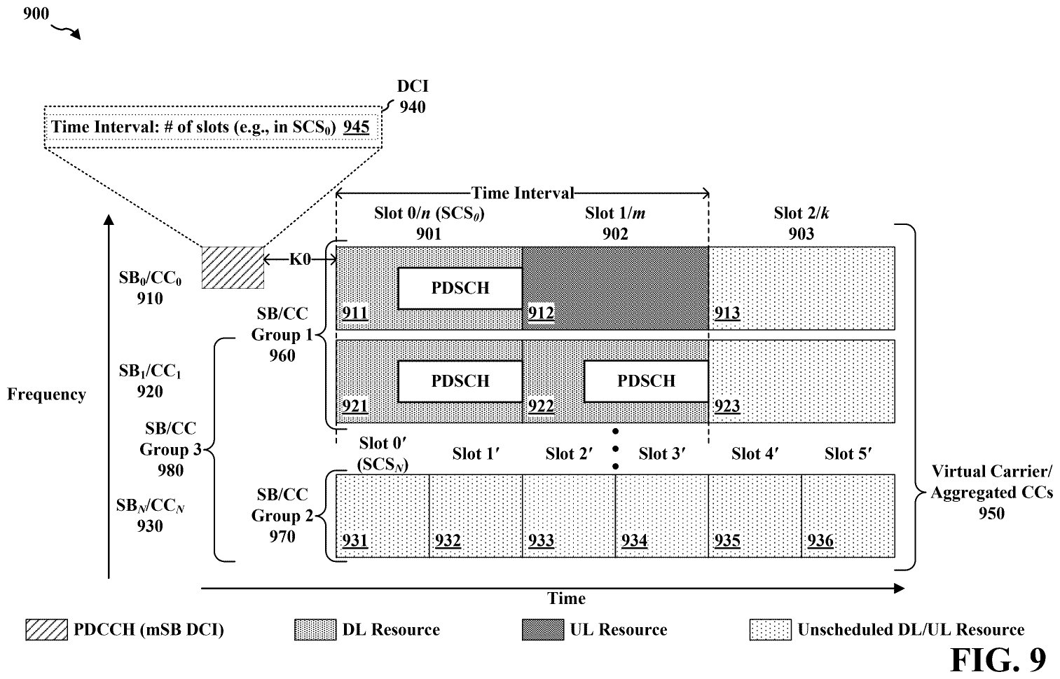

FIG. 9 is a diagram 900 illustrating a semi-static indication of a set of resources in accordance with some aspects of the disclosure. Diagram 900 illustrates a virtual carrier/aggregated carrier 950 including N+1 SBs/CCs (e.g., including SB₀/CC₀ 910, SB₁/CC₁ 920, and SB_{N}/CC_{N} 930). Diagram 900 further illustrates that the different SBs/CCs may have different slot formats over a set of slots including slots 0/n, 1/m, and 2/k (e.g., slot 901, slot 902, and slot 903, respectively). Different SBs/CCs may be associated with different SCSs (e.g., SB₀/CC₀ 910 and SB₁/CC₁ 920 may be associated with SCS₀, while SB_{N}/CC_{N} 930 may be associated with SCS_{N}) and corresponding different slot lengths/durations. Sets of candidate time-and-frequency resources for TB transmission/reception (e.g., resources 911, resources 912, resources 913, resources 921, resources 922, resources 923, resources 931, resources 932, resources 933, resources 934, resources 935, and resources 936 each including a set of REs to which a TB may be mapped) may be identified by a slot and an SB/CC (e.g., resources 911 may be identified with SB₀/CC₀ 910 and slot 901, and the other resources 912 to 936 may similarly be identified by a corresponding combination of SB/CC and slot).

In some aspects, the SBs/CCs in the virtual carrier/aggregated carrier 950 may be grouped into subsets of SBs/CCs used for single-TB (or TB repetition) scheduling. For example, diagram 900 illustrates that the virtual carrier/aggregated carrier 950 may be divided into multiple groups of SBs/CCs (e.g., two or more of a first SB/CC group 960, a second SB/CC group 970, and/or a third SB/CC group 980). In some aspects, a group may not include SBs/CCs with different SCSs (e.g., the first SB/CC group 960, and the second SB/CC group 970), while in other aspects, a group may include SBs/CCs with different SCSs (e.g., the third SB/CC group 980). The association of SBs/CCs to SB/CC groups for scheduling, in some aspects, may be indicated to a UE by one or more of (UE-specific) RRC signaling, a MAC-CE, or DCI. When using SB/CC groups, the DCI 940, in some aspects may include an SB/CC group index (e.g., via an SB/CC group index “i_{SBGroup}” in an SB/CC group field such as SB/CC group field 844 of FIG. 8) that identifies the SBs/CCs associated with a scheduled TB (e.g., based on the RRC signaling).

In some aspects, to indicate resources to which the TB is, or will be, mapped (e.g., from the set of resources including resource 911 to 936), the DCI 940 may use a previously indicated (e.g., semi-statically, via a MAC-CE, or dynamically, via DCI) slot format. The previously indicated slot format, in some aspects, may be combined with an indication of an indicated SB/CC group (e.g., from a configured set of SB/CC groups) or other indication of indicated SBs/CCs to identify resources to which the TB is, or will be, mapped. For example, in diagram 900, the UE may have previously been provided an indication of the transmission/reception directions of the slot 0/n and the slot 1/m and may further receive DCI 940 indicating a first SB/CC group 960 (or of the individual SBs/CCs, SB₀/CC₀ 910 and SB₁/CC₁ 920) and an indication of a time interval (e.g., a number of slots in a time interval field 945) associated with the scheduled TB. By combining the previously indicated slot format, the indicated SB(s)/CC(s), and the time interval (which may implicitly begin at a first slot after the time and/or number of slots K0/K2 has elapsed since the last symbol of the DCI 940 scheduling a DL/UL transmission/reception), the UE may identify that resources 911, 921, and 922 are associated with the transmission/reception of the scheduled TB (e.g., are resources to which the TB is, or will be, mapped). For example, for a DL reception scheduled at a UE, an SB/CC group index may indicate that the TB is scheduled over SB₀/CC₀ 910 and SB₁/CC₁ 920 (e.g., that resources 911 to 923 are candidate resources for reception of the scheduled TB), the time interval field 945 and the resources associated with the DCI 940 may indicate that the TB is scheduled over slot 0/n and slot 1/m, e.g., slot 901 and slot 902 (e.g., that resources 911, 912, 921, and 922 are candidate resources for reception of the scheduled TB), and the indicated slot formats (e.g., indicating that resource 912 is associated with a U format) may indicate that resource 912 may not be used for reception of the scheduled TB. Accordingly, the UE may determine to use resources 911, 921, and 922 for reception of the scheduled TB (e.g., the PDSCH included in the time-and-frequency resources indicated by, in some aspects, the FDRA and TDRA as discussed above). In some aspects, the number of slots indicated in the time interval field 945 may be based on a configured reference SCS, an SCS of an indicated SB/CC, an SCS of an anchor SB/CC, an SCS of the first SB/CC used for Tx/Rx, or a largest SCS (e.g., associated with a shortest slot) associated with the indicated SBs/CCs.

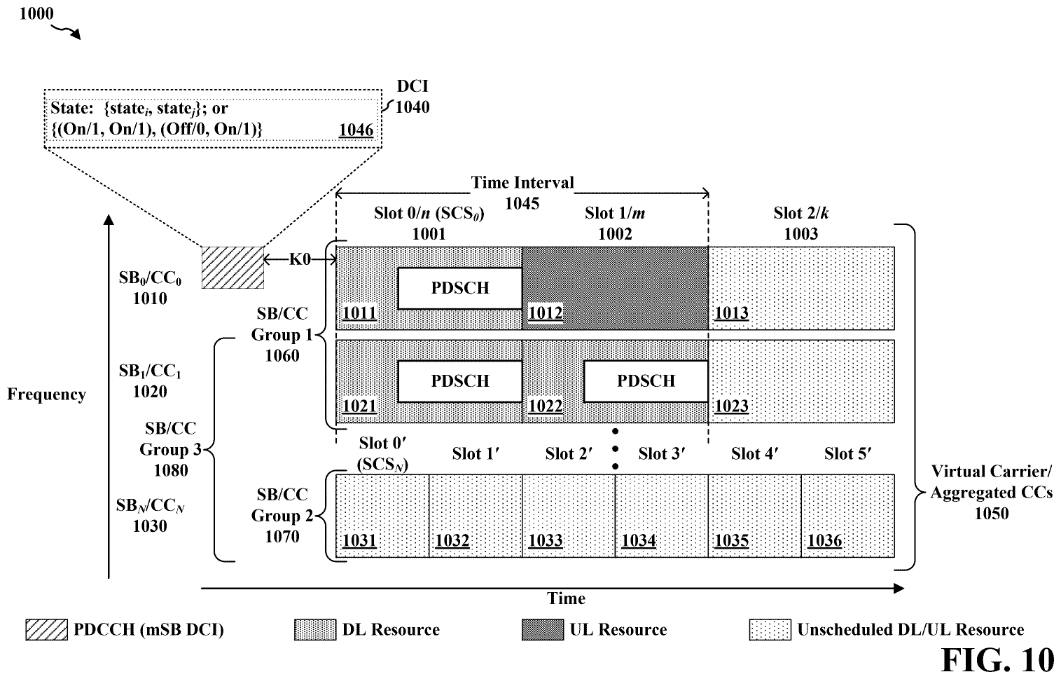

FIG. 10 is a diagram 1000 illustrating a semi-static indication of a set of resources in accordance with some aspects of the disclosure. Diagram 1000 illustrates a virtual carrier/aggregated carrier 1050 including N+1 SBs/CCs (e.g., including SB₀/CC₀ 1010, SB₁/CC₁ 1020, and SB_{N}/CC_{N} 1030). Diagram 1000 further illustrates that the different SBs/CCs may have different slot formats over a set of slots including slots 0/n, 1/m, and 2/k (e.g., slot 1001, slot 1002, and slot 1003, respectively). Different SBs/CCs may be associated with different SCSs (e.g., SB₀/CC₀ 1010 and SB₁/CC₁ 1020 may be associated with SCS₀, while SB_{N}/CC_{N} 1030 may be associated with SCS_{N}) and corresponding different slot lengths/durations. Sets of candidate time-and-frequency resources for TB transmission/reception (e.g., resources 1011, resources 1012, resources 1013, resources 1021, resources 1022, resources 1023, resources 1031, resources 1032, resources 1033, resources 1034, resources 1035, and resources 1036 each including a set of REs to which a TB may be mapped) may be identified by a slot and an SB/CC (e.g., resources 1011 may be identified with SB₀/CC₀ 1010 and slot 1001, and the other resources 1012 to 1036 may similarly be identified by a corresponding combination of SB/CC and slot).

In some aspects, the SBs/CCs in the virtual carrier/aggregated carrier 1050 may be grouped into subsets of SBs/CCs used for single-TB (or TB repetition) scheduling. For example, diagram 1000 illustrates that the virtual carrier/aggregated carrier 1050 may be divided into multiple groups of SBs/CCs (e.g., two or more of a first SB/CC group 1060, a second SB/CC group 1070, and/or a third SB/CC group 1080). In some aspects, a group may not include SBs/CCs with different SCSs (e.g., the first SB/CC group 1060 and the second SB/CC group 1070), while in other aspects, a group may include SBs/CCs with different SCSs (e.g., the third SB/CC group 1080). The association of SBs/CCs to SB/CC groups for scheduling, in some aspects, may be indicated to a UE by one or more of (UE-specific) RRC signaling, a MAC-CE, or DCI. When using SB/CC groups, the DCI 1040, in some aspects may include an SB/CC group index (e.g., via an SB/CC group index “i_{SBGroup}” in an SB/CC group field such as SB/CC group field 844 of FIG. 8) that identifies the SBs/CCs associated with a scheduled TB (e.g., based on the RRC signaling).

In some aspects, a UE may receive a configuration (e.g., via one or more of RRC signaling, a MAC-CE, or DCI) of a plurality of time-domain patterns (e.g., for TDD slots and/or SBs/CCs) and/or states. Each state, in some aspects, may indicate, for a particular slot and/or set of slots, which of the available, or indicated, SBs/CCs (e.g., individually indicated or indicated in association with an SB/CC group) is in an “ON” state (e.g., is indicated to be an SB/CC to which the TB is, or will be, mapped) and which of the available, or indicated, SBs/CCs is in an “OFF” state (e.g., is indicated to be an SB/CC to which the TB is not, or will not be, mapped). In some aspects, each state may be associated with (or identify states for SBs/CCs in) a single slot. For example, a state field 1046 in DCI 1040 may include an indication of a first state and a second state for a first and second slot (e.g., {stateᵢ, stateⱼ} for corresponding slots {slot 0/n, slot 1/m} in time interval 1045) where the first state may be associated with both a first SB/CC and a second SB/CC in an SB/CC group being indicated to be an SB/CC to which the TB is, or will be, mapped, or being associated with a reception of a TB (indicated as either (On, On) or (1, 1) where “1” is arbitrarily selected as being associated with an indicated SB/CC or an SB/CC in an “ON” state). Similarly, the second state (indicated as one of (Off, On) or (0, 1) in diagram 1000) may be associated with the first SB/CC in the SB/CC group not being an SB/CC to which the TB is, or will be, mapped (e.g., not associated with a reception of the TB), and a second SB/CC in the SB/CC group being an SB/CC to which the TB is, or will be, mapped (e.g., being associated with a reception of the TB). Based on the first and second states, the UE may receive a scheduled TB via resources 1011, 1021, and 1022 (e.g., via a PDSCH within the indicated resources). Each state, in some aspects, may be associated with (or identify states and/or slot formats for SBs/CCs across) multiple slots.

A configuration of state indices, in some aspects, may include one set of state indices used to indicate a set of different states (patterns of ON/OFF states and/or slot formats over a time interval) that may be used and/or configured for a plurality of SB/CC groups. The configuration of state indices, in some aspects, may include different states (e.g., different patterns of time-domain states over single or multiple slots) for different SB/CC groups (e.g., the first SB/CC group 1060, a second SB/CC group 1070, and/or a third SB/CC group 1080). In some aspects, the different states may be indicated by a same set of state indices (or state index values) where an indication of the SB/CC group allows the UE to determine a mapping between state index and states across the SBs/CCs in the SB/CC group over the time interval. For example, a first state index value (e.g., “01” or “010”) may indicate a first (Off, On) or (0, 1) state for a first SB/CC group (or first set of SB/CC groups) including two SBs/CCs and a second (Off, On, On) or (0, 1, 1) state for a second SB/CC group (or a second set of SB/CC groups) including three SBs/CCs. Alternatively, or additionally, a first state index (e.g., “00” or “000”) for each SB/CC group may indicate that all SBs/CCs of the SB/CC group are in a same state (e.g., either all “ON” or all “OFF”) while other state indexes may be used to indicate different states for the different SB/CC groups.

The DCI 1040 may include the state index (or state indices) in, e.g., a state field 1046, to indicate a state for each indicated SB/CC within a set of indicated slots (e.g., where the state indicates whether the resources associated with the SB/CC during the slot should be used for scheduling the TB). The indicated state, in some aspects, may be combined with an indication of an SB/CC group (e.g., from a configured set of SB/CC groups) to identify indicated resources (time and frequency resources used to transmit/receive a scheduled TB or to which the TB is, or will be, mapped). For example, in diagram 1000, the UE may have previously been provided an indication of configuration of the states and/or time patterns (e.g., the state patterns associated with different state indices for a set of SB/CC groups) and may further receive DCI 1040 indicating a first SB/CC group 1060 (or of the individual SBs/CCs, SB₀/CC₀ 1010 and SB₁/CC₁ 1020). When using SB/CC groups, the DCI 1140, in some aspects may include an SB/CC group index (e.g., via an SB/CC group index “i_{SBGroup}” in an SB/CC group field such as SB/CC group field 844 of FIG. 8) that identifies the SBs/CCs associated with a scheduled TB (e.g., based on the RRC signaling).

In some aspects, a UE may receive a configuration (e.g., via one or more of RRC signaling, a MAC-CE, or DCI) of a plurality of time-domain patterns (e.g., for TDD slots and/or SBs/CCs) and/or states. Each state, in some aspects, may indicate, for a particular slot and/or set of slots, which of the available, or indicated, SBs/CCs (e.g., individually indicated or indicated in association with an SB/CC group) is in an “ON” state (e.g., is indicated to be an SB/CC to which the TB is, or will be, mapped) or is in an “OFF” state (e.g., is indicated to be an SB/CC to which the TB is not, or will not be, mapped). In some aspects, each state may be associated with (or identify states for SBs/CCs in) a single slot as described in relation to FIG. 10. Each state, in some aspects, may be associated with (or identify states for SBs/CCs across) multiple slots. For example, a state field 1146 in DCI 1140 may include an indication of a single state for a first and second slot (e.g., {stateᵢ} for a corresponding set of slots {slot 0/n, slot 1/m} in time interval 1145). The single state, {stateᵢ}, may have been configured to correspond to a multi-slot state {(On, On)_{0/n}, (Off, On)_{1/m}} or {(1, 1)_{0/n}, (0, 1)_{1/m}} defined for the slots 0/n and 1/m, where “1” is arbitrarily selected as being associated with an indicated SB/CC or an SB/CC in an “ON” state and the subscript of each ordered pair in the set of ordered pairs indicates the corresponding slot. The indicated state, {stateᵢ}, in state field 1146 of diagram 1100 may be associated with, or indicate, a state in which both a first SB/CC and a second SB/CC in an SB/CC group are (indicated to be) an SB/CC to which the TB is, or will be, mapped (e.g., are associated with a reception of the TB) during a first slot of the multiple slots. Similarly, the indicated state, {stateᵢ}, may be associated with the first SB/CC in the SB/CC group not being an SB/CC to which the TB is, or will be, mapped (e.g., not being associated with a reception of the TB), and the second SB/CC in the SB/CC group being an SB/CC to which the TB is, or will be, mapped (e.g., being associated with a reception of the TB) during a second slot of the multiple slots (e.g., as indicated by the ordered pair (Off, On)_{1/m} or (0, 1)_{1/m} associated with the second slot in the indicated state). Based on the (multi-slot) state, the UE may receive a scheduled TB via resources 1121 and 1131 to 1134 (e.g., via a PDSCH within the indicated resources), where the state indicated for a slot (e.g., slot 0/n) defined based on a first SCS (e.g., SCS₀) may be applied to corresponding slots (e.g., slot 0′ and slot 1′) defined based on a second (larger) SCS (e.g., an SCS associated with a higher numerology).

A configuration of state indices, in some aspects, may include one set of state indices used to indicate a set of different states (patterns of states over a time interval) that may be used and/or configured for a plurality of SB/CC groups. The configuration of state indices, in some aspects, may include different states (e.g., different patterns of time-domain states over single or multiple slots) for different SB/CC groups. In some aspects, the different states may be indicated by a same set of state indices (or state index values) where an indication of the SB/CC group allows the UE to determine a mapping between state index and states across the SBs/CCs in the SB/CC group over the time interval. For example, a first state index value (e.g., “01” or “010”) associated with two slots may indicate a first {(On, On)_{0/n}, (Off, On)_{1/m}} state for a first SB/CC group (or first set of SB/CC groups) including two SBs/CCs and a second {(On, On, On)_{0/n}, (Off, On, On)_{1/m}} state for a second SB/CC group (or a second set of SB/CC groups) including three SBs/CCs. Alternatively, or additionally, a first state index (e.g., “00” or “000”) for each SB/CC group may indicate that all SBs/CCs of the SB/CC group are in a same state (e.g., either all “ON” or all “OFF”) over the time interval while other state indexes may be used to indicate different states for the different SB/CC groups.

The DCI 1140 may include the (multi-slot) state index in, e.g., a state field 1146, to indicate one or more state(s) for each indicated SB/CC within a set of indicated slots over the multiple slots (e.g., where the state indicates whether the resources associated with the SB/CC during the slot should be used for scheduling the TB). The indicated slot state(s) (or state pattern), in some aspects, may be combined with an indication of an SB/CC group (e.g., from a configured set of SB/CC groups) to identify indicated resources (time and frequency resources used to transmit/receive a scheduled TB or to which the TB is, or will be, mapped). For example, in diagram 1100, the UE may have previously been provided an indication of configuration of the states and/or time patterns (e.g., the state patterns associated with different state indices for a set of SB/CC groups) and may further receive DCI 1140 indicating an SB/CC group 1190 (or of the individual SBs/CCs, SB₁/CC₁ 1120 and SB_{N}/CC_{N} 1130) and a (multi-slot) state index (e.g., {stateᵢ} in state field 1146) indicating a state pattern over a time interval including slot 1101 and slot 1102 (e.g., slot 0/n and slot 1/m and corresponding slots 0′ to 3′) associated with the scheduled TB.

By combining the previously indicated configuration of the states and/or time patterns and the SB/CC indication(s), the UE may identify that resources 1121 and 1131 to 1134 are associated with the transmission/reception of the scheduled TB. For example, for a DL reception scheduled at a UE, an SB/CC group index may indicate that the TB is scheduled over SB₁/CC₁ 1120 and SB_{N}/CC_{N} 1130 (e.g., that resources 1121, 1122, and 1131 to 1134 are candidate resources, or include resources, for reception of the scheduled TB) and the (multi-slot) state index (e.g., {stateᵢ}) may indicate that the resources 1121, 1122, 1131, 1132, 1133, and 1134 are associated with an ON, OFF, ON, ON, ON, and ON (and D, U, D, D, D, and D) state, respectively, such that resource 1122 may not be used for reception of the scheduled TB. Accordingly, the UE may determine to use resources 1121 and 1131 to 1134 for reception of the scheduled TB (e.g., the PDSCH included in the time-and-frequency resources indicated by, in some aspects, the FDRA and TDRA as discussed above). As illustrated in diagram 1100, when indicating a (time) pattern of states, a slot may be defined based on a smallest SCS associated with the indicated SBs/CCs or SB/CC group and an indicated state may be applied to corresponding (aligned and/or overlapping) slots defined based on a larger SCS.

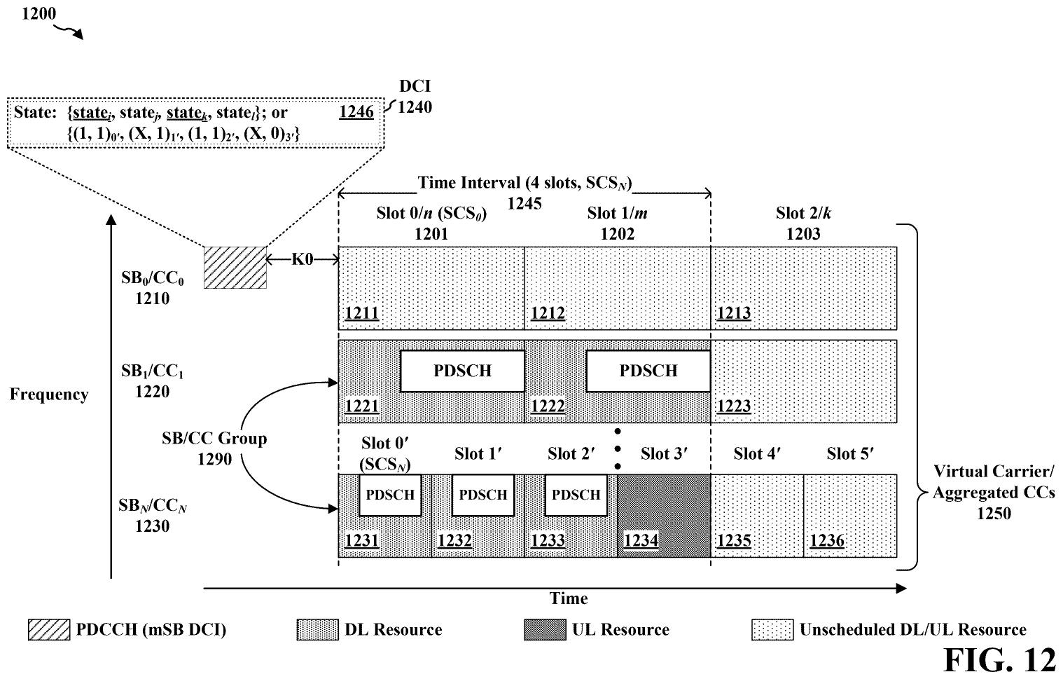

FIG. 12 is a diagram 1200 illustrating a semi-static indication of a set of resources in accordance with some aspects of the disclosure. Diagram 1200 illustrates a virtual carrier/aggregated carrier 1250 including N+1 SBs/CCs (e.g., including SB₀/CC₀ 1210, SB₁/CC₁ 1220, and SB_{N}/CC_{N} 1230). Diagram 1200 further illustrates that the different SBs/CCs may have different slot formats over a set of slots including slots 0/n, 1/m, and 2/k (e.g., slot 1201, slot 1202, and slot 1203, respectively). Different SBs/CCs may be associated with different SCSs (e.g., SB₀/CC₀ 1210 and SB₁/CC₁ 1220 may be associated with SCS₀, while SB_{N}/CC_{N} 1230 may be associated with SCS_{N}) and corresponding different slot lengths/durations. Sets of candidate time-and-frequency resources for TB transmission/reception (e.g., resources 1211, resources 1212, resources 1213, resources 1221, resources 1222, resources 1223, resources 1231, resources 1232, resources 1233, resources 1234, resources 1235, and resources 1236 each including a set of REs to which a TB may be mapped) may be identified by a slot and an SB/CC (e.g., resources 1211 may be identified with SB₀/CC₀ 1210 and slot 1201, and the other resources 1212 to 1236 may similarly be identified by a corresponding combination of SB/CC and slot).

In some aspects, the SBs/CCs in the virtual carrier/aggregated carrier 1250 may be grouped into subsets of SBs/CCs used for single-TB (or TB repetition) scheduling. For example, diagram 1200 illustrates that the virtual carrier/aggregated carrier 1250 may include a group of SBs/CCs (e.g., an SB/CC group 1290). SB/CC group 1290, as illustrated, includes SBs/CCs with different SCSs. The association of SBs/CCs to SB/CC groups for scheduling, in some aspects, may be indicated to a UE by one or more of (UE-specific) RRC signaling, a MAC-CE, or DCI. When using SB/CC groups, the DCI 1240, in some aspects may include an SB/CC group index (e.g., via an SB/CC group index “i_{SBGroup}” in an SB/CC group field such as SB/CC group field 844 of FIG. 8) that identifies the SBs/CCs associated with a scheduled TB (e.g., based on the RRC signaling).

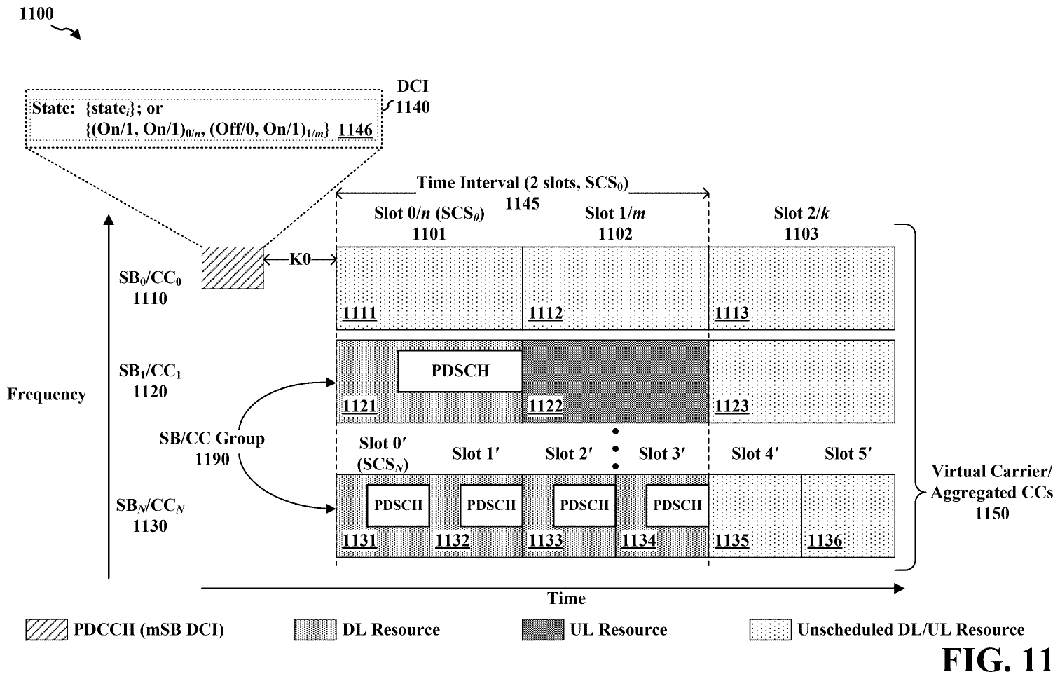

In some aspects, a UE may receive a configuration (e.g., via one or more of RRC signaling, a MAC-CE, or DCI) of a plurality of time-domain patterns (e.g., for TDD slots and/or SBs/CCs) and/or states. Each state, in some aspects, may indicate, for a particular slot and/or set of slots, which of the available, or indicated, SBs/CCs (e.g., individually indicated or indicated in association with an SB/CC group) is in an “ON” state (e.g., is indicated to be an SB/CC to which the TB is, or will be, mapped) or is in an “OFF” state (e.g., is indicated to be an SB/CC to which the TB is not, or will not be, mapped). In some aspects, each state may be associated with (or identify states for SBs/CCs in) a single slot defined based on the larger SCS associated with SB_{N}/CC_{N} 1230. For example, a state field 1246 in DCI 1240 may include an indication of a first state, a second state, a third state, and a fourth state for a first, second, third, and fourth slot (e.g., {stateᵢ, stateⱼ, stateₖ, stateₗ} for corresponding slots {slot 0′, slot 1′, slot 2′, slot 3′} in time interval 1245). In some aspects, the first, second, and third states may be associated with both a first SB/CC and a second SB/CC in an SB/CC group that are (indicated to be) an SB/CC to which the TB is, or will be, mapped (e.g., are associated with a reception of a TB during the first, second, and third slots, where the slots are defined based on the larger SCS associated with SB_{N}/CC_{N} 1230). For example, the state indication(s) {stateᵢ, stateⱼ, stateₖ,} may each correspond to a single slot state in a set of single slot states {(1, 1)_{0′}, (X, 1)_{1′}, (1, 1)_{2′}} where “1” is arbitrarily selected as being associated with an indicated SB/CC or an SB/CC in an “ON” state (and having a compatible direction with the scheduled TB), the subscript of each ordered pair in the set of ordered pairs indicates the corresponding slot, and where X may represent an ON or OFF state as the state for the duration of slot 0/n may be defined based on the state indicated for the beginning of the slot, e.g., slot 0′ in diagram 1200). Similarly, the fourth state (indicated as (X, 0)_{3′} as described above where the state for the slot 1/m may be defined based on the state indicated for the beginning of the slot, e.g., slot 2′ in diagram 1200) may be associated with the first SB/CC in the SB/CC group being an SB/CC to which the TB is, or will be, mapped (e.g., being associated with a reception of the TB), and a second SB/CC in the SB/CC group not being an SB/CC to which the TB is, or will be, mapped (e.g., not being associated with a reception of the TB) during the fourth slot (e.g., slot 3′). While the state for an SB/CC associated with a smaller SCS is illustrated as being determined by a state aligned with the beginning of the slot, in some aspects, it may be determined by a state aligned with the end of the slot. Based on the indicated states, the UE may receive a scheduled TB via resources 1221, 1222, and 1231 to 1233 (e.g., via a PDSCH within the indicated resources). Each state, in some aspects, may be associated with (or identify states for SBs/CCs across) multiple slots as described in relation to FIG. 11.

A configuration of state indices, in some aspects, may include one set of state indices used to indicate a set of different states (patterns of states over a time interval) that may be used and/or configured for a plurality of SB/CC groups. The configuration of state indices, in some aspects, may include different states (e.g., different patterns of time-domain states over single or multiple slots) for different SB/CC groups. In some aspects, the different states may be indicated by a same set of state indices (or state index values) where an indication of the SB/CC group allows the UE to determine a mapping between state index and states across the SBs/CCs in the SB/CC group over the time interval. For example, a first state index value (e.g., “01” or “010”) may indicate a first (Off, On) or (0, 1) state for a first SB/CC group (or first set of SB/CC groups) including two SBs/CCs and a second (Off, On, On) or (0, 1, 1) state for a second SB/CC group (or a second set of SB/CC groups) including three SBs/CCs. Alternatively, or additionally, a first state index (e.g., “00” or “000”) for each SB/CC group may indicate that all SBs/CCs of the SB/CC group are in a same state (e.g., either all “ON” or all “OFF”) while other state indexes may be used to indicate different states for the different SB/CC groups.

The DCI 1240 may include (multiple) state indices in, e.g., a state field 1246, to indicate one or more state(s) for each indicated SB/CC within a set of indicated slots over multiple slots (e.g., where the state indicates whether the resources associated with the SB/CC during the slot should be used for scheduling the TB). The indicated state(s) (or state pattern), in some aspects, may be combined with an indication of an indicated SB/CC group (e.g., from a configured set of SB/CC groups) to identify indicated resources (time and frequency resources used to transmit/receive a scheduled TB or to which the TB is, or will be, mapped). For example, in diagram 1200, the UE may have previously been provided an indication of configuration of the states and/or time patterns (e.g., the state patterns associated with different state indices for a set of SB/CC groups) and may further receive DCI 1240 indicating an SB/CC group 1290 (or the individual SBs/CCs, SB₁/CC₁ 1220 and SB_{N}/CC_{N} 1230) and (multiple) state indices (e.g., {stateᵢ, stateⱼ, stateₖ, stateₗ} in state field 1246) indicating a state pattern over a time interval including slot 0′ to slot 3′ (e.g., corresponding to slot 1201 and slot 1202 or slot 0/n and slot 1/m) associated with the scheduled TB.

By combining the previously indicated configuration of the states and/or time patterns and the SB/CC indication(s), the UE may identify that resources 1221, 1222, and 1231 to 1233 are associated with the transmission/reception of the scheduled TB. For example, for a DL reception scheduled at a UE, an SB/CC group index may indicate that the TB is scheduled over SB₁/CC₁ 1220 and SB_{N}/CC_{N} 1230 (e.g., that resources 1221, 1222, and 1231 to 1234 are candidate resources, or include resources, for reception of the scheduled TB) and the (multiple) state indices (e.g., {stateᵢ, stateⱼ, stateₖ, stateₗ}) may indicate that the resources 1221, 1222, 1231, 1232, 1233, and 1234 are associated with an ON, ON, ON, ON, ON, and OFF state, respectively, such that resource 1234 may not be used for reception of the scheduled TB. Accordingly, the UE may determine to use resources 1221, 1222, and 1231 to 1233 for reception of the scheduled TB (e.g., the PDSCH included in the time-and-frequency resources indicated by, in some aspects, the FDRA and TDRA as discussed above). As illustrated in diagram 1200, when indicating a (time) pattern of states, a slot may be defined based on a largest SCS associated with the indicated SBs/CCs or SB/CC group and an indicated state for one of multiple slots defined by the largest SCS may be applied to corresponding (aligned and/or overlapping) slots defined based on a smaller SCS.

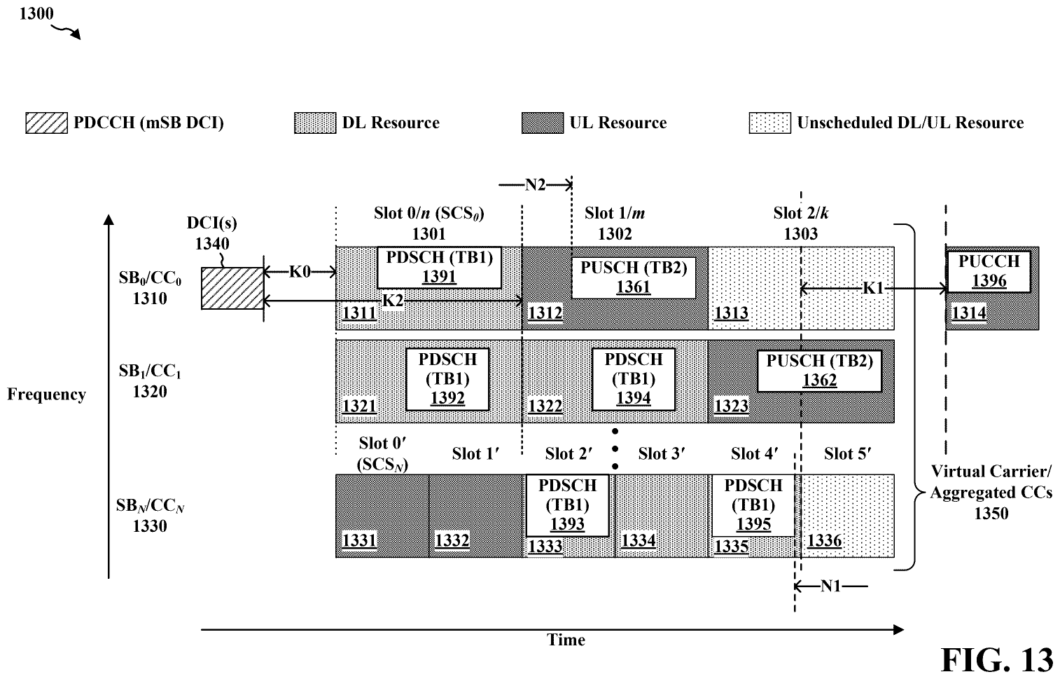

FIG. 13 is a diagram 1300 illustrating additional aspects of FSI/ECA scheduling including TB-repetition scheduling in accordance with some aspects of the disclosure. Diagram 1300 illustrates a virtual carrier/aggregated carrier 1350 including N+1 SBs/CCs (e.g., including SB₀/CC₀ 1310, SB₁/CC₁ 1320, and SB_{N}/CC_{N} 1330). Diagram 1300 further illustrates that the different SBs/CCs may have different slot formats over a set of slots including slots 0/n, 1/m, and 2/k (e.g., slot 1301, slot 1302, and slot 1303, respectively) or slots 0′ to 5′. Different SBs/CCs may be associated with different SCSs (e.g., SB₀/CC₀ 1310 and SB₁/CC₁ 1320 may be associated with SCS₀, while SB_{N}/CC_{N} 1330 may be associated with SCS_{N}) and corresponding different slot lengths/durations. Sets of candidate time-and-frequency resources for TB transmission/reception (e.g., resources 1311, resources 1312, resources 1313, resources 1321, resources 1322, resources 1323, resources 1331, resources 1332, resources 1333, resources 1334, resources 1335, and resources 1336 each including a set of REs to which a TB may be mapped) may be identified by a slot and an SB/CC (e.g., resources 1311 may be identified with SB₀/CC₀ 1310 and slot 1301, and the other resources 1312 to 1336 may similarly be identified by a corresponding combination of SB/CC and slot).

In some aspects, instead of, or in addition to, mapping a TB across an “aggregated” set of resources scheduled on, or across, multiple SBs/CCs, a same TB (e.g., a same underlying data transmission, that may undergo different processing for transmission on different SBs/CCs) may be repeatedly transmitted on different SBs/CCs and/or across different slots. For example, a first DL TB (‘TB1’) may have multiple repetitions (e.g., repetition 1391, repetition 1392, repetition 1393, repetition 1394, and repetition 1395), scheduled via one or more DCIs in a set of DCI(s) 1340. Similarly, in some aspects, a second UL TB (‘TB2’) may have multiple repetitions (e.g., repetition 1361 and repetition 1362), scheduled via one or more DCIs in the set of DCI(s) 1340. The set of TB repetitions, in some aspects, may be scheduled via individual DCIs or via a single (joint) DCI. For example, when using a single (joint) DCI to schedule multiple repetitions, each of the repetitions 1391 to 1395 (or 1361 and 1362) may be scheduled (and the FDRA and/or TDRA may be indicated for each repetition) in any of the ways discussed above in relation to FIGS. 7-12. When using individual (or multiple) DCIs, FDRA, TDRA, and slot indications may be provided per repetition, however, SB/CC grouping may be applied (e.g., each DCI scheduling one repetition of a TB may indicate an SB/CC group [and a state indicating a particular SB/CC] to which that TB repetition is mapped).

In aspects of single-TB mapping and/or scheduling discussed above, the TB size may be determined based on the total number of REs, the number of MIMO layers per SB/CC, and the MCS of each SB/CC. For TB repetition across different SBs/CCs and/or across different slots, a TB size, in some aspects, may be determined based on the number of REs, the number of MIMO layers, and the MCS of an allocation on a reference SB/CC and slot (e.g., a first repetition or a repetition on a configured SB/CC such as an anchor SB/CC). In some aspects, the reference SB/CC and slot may be an earliest scheduled slot on the SB/CC with one of the smallest index or the largest index. For example, the TB size for repetitions 1391 to 1395 may be determined based on SB/CC₀ 1310.

In some aspects, processing timelines associated with UL and DL transmissions may be defined such that K1 (e.g., a gap between PDSCH and PUCCH, such as PDSCH associated with repetition 1395 and PUCCH 1396 in a resource 1314 associated with SB₀/CC₀ 1310) is measured with respect to the latest scheduled slot across the scheduled SBs/CCs (e.g., slot 4′), and K2 (e.g., a gap between PDCCH and PUSCH) is measured with respect to the earliest scheduled slot across the scheduled SBs/CCs (e.g., slot 1/m or slot 1302). Similarly, N1 (e.g., a minimum downlink processing time) may be measured with respect to the latest PDSCH symbol across the scheduled SBs/CCs and N2 (e.g., a minimum uplink processing time) may be measured with respect to the earliest PUSCH symbol across the scheduled SBs/CCs. In some aspects, allowing a TB to be mapped to SBs/CCs with different SCSs, the counting of K1/K2 and/or N1/N2 may be based on a reference SCS, an SCS of the anchor SB/CC, an SCS of the first SB/CC on which PxSCH is scheduled, an SCS of the last SB/CC on which PxSCH is scheduled or one of the minimum or maximum SCS across the scheduled SBs/CCs.

In some aspects, support for single-TB scheduling and/or TB repetition scheduling may be signaled as a UE capability. The support for single-TB scheduling and/or TB repetition scheduling may be signaled separately for UL and DL. For example, a UE may report that it supports single-TB scheduling in DL but not in UL, in UL but not in DL, or in both DL and UL. In some aspects, a network may expect that a UE that indicates support for single-TB scheduling also supports TB repetition scheduling. In some aspects, TB repetition may be a default solution (an expected capability) and the single-TB scheduling may be an optional capability. If a UE supports both options, in some aspects, one of single-TB scheduling or TB repetition may be configured for the UE via RRC. In some aspects, the configuration of single-TB scheduling or TB repetition may be the same for DL and UL or different for DL and UL. For example, the UE, in some aspects, may be configured with single-TB scheduling for DL and TB repetition for UL, or with single-TB scheduling for UL and TB repetition for DL. In some aspects, the configuration may be independent across different sets of SBs/CCs (e.g., per SB/CC group) or the same for all SB/CC groups. In some aspects, the configuration of single-TB scheduling or TB repetition may be indicated for each DL/UL grant. For example, the method associated with a particular DL/UL grant (e.g., for a particular TB) may be indicated via associating the different scheduling methods with different DCI formats, different CORESETs/SS sets, different RNTIs, or by indicating an associated scheduling method via an explicit field added in the DCI.

If the two schemes (e.g., single-TB scheduling and TB repetition scheduling) use the same DCI format and are differentiated using a field in the DCI, the DCI content should have a fixed size to allow for decoding before the UE determines, based on the decoding, whether the DCI is associated with single-TB scheduling and TB repetition scheduling. In both cases, some parameters such as a number of MIMO layers, a DMRS pattern, an MCS, and other characteristics may be indicated separately for each SB/CC. However, the single-TB scheduling may use a single redundancy value (RV), while the repetition based solution may use different RVs for different repetitions (or occasions) in different SBs/CCs and slots. In order to maintain a same RV field size, in some aspects, a DCI format common to single-TB scheduling and TB repetition may indicate N RV indices, where N is fixed and corresponds to the maximum number of repetitions allowed when using TB repetition scheduling. When a DCI indicates single-TB scheduling, in some aspects, one of the RVs may be used for the single TB (e.g., the first one, or any configured RV of the N RVs). In some aspects, the N RVs may be jointly used to derive a single RV value based on some pre-defined (e.g., known or configured) rules. Using the N RVs, in some aspects, may enable a reduction in the payload, e.g., by reducing the bit width of each per-SB/CC RV to a single bit and then then using a set of two or more of the N bits to derive the single RV index for single-TB scheduling, the single RV index may take on a sufficient number of values without using a multiple of N bits to achieve the same number of possible values for RV indexes of TB repetitions.

While discussed as two methods of utilizing a virtual cell including different SBs/CCs, single-TB scheduling and TB repetition scheduling may, in some aspects, be combined and/or used together. Referring to FIG. 7, for example, the DCI 740 may indicate that a first repetition of a TB be jointly mapped to the PDSCH in the resource 711 and the resource 721 and that a second repetition of the TB be jointly mapped to the PDSCH in the resource 722 and the resource 713.

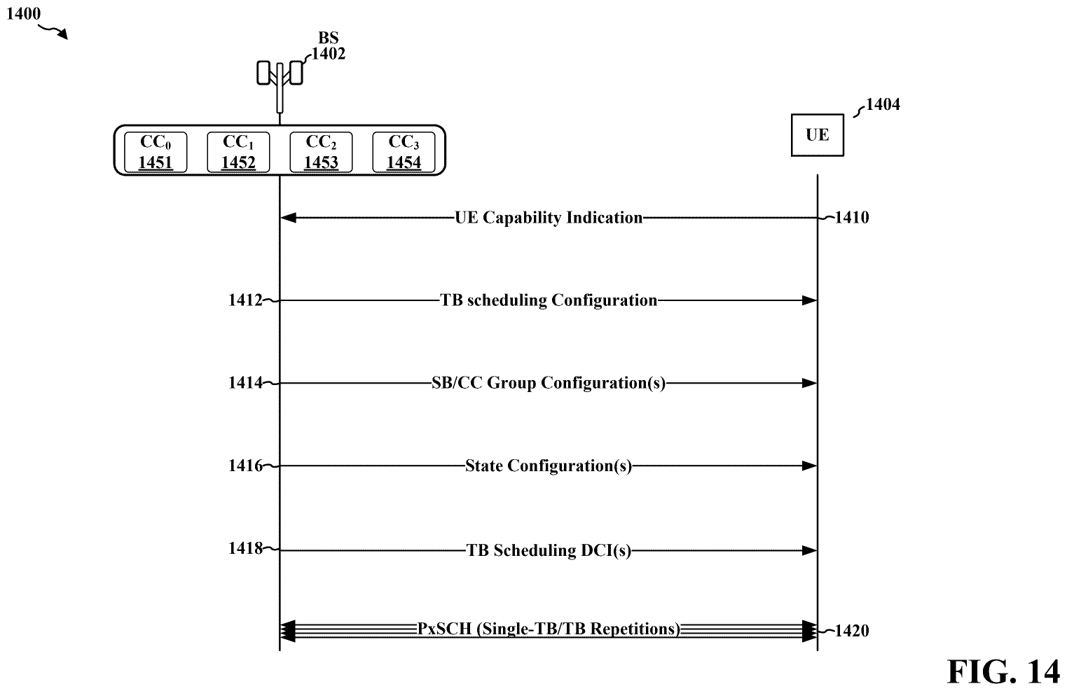

FIG. 14 is a call flow diagram 1400 illustrating a method of wireless communication in accordance with some aspects of the disclosure. The method is illustrated in relation to a base station 1402 (e.g., as an example of a network device or network node that may include one or more components of a disaggregated base station) in communication with a UE 1404 (e.g., as an example of a wireless device). The base station may be associated with a plurality of SBs/CCs (e.g., CC₀ 1451, CC₁ 1452, CC₂ 1453, and CC₃ 1454) that are associated with a FSI/ECA implemented by the base station 1402. The functions ascribed to the base station 1402, in some aspects, may be performed by one or more components of a network entity, a network node, or a network device (a single network entity/node/device or a disaggregated network entity/node/device as described above in relation to FIG. 1). Similarly, the functions ascribed to the UE 1404, in some aspects, may be performed by one or more components of a wireless device supporting communication with a network entity/node/device. Accordingly, references to “transmitting” in the description below may be understood to refer to a first component of the base station 1402 (or the UE 1404) outputting (or providing) an indication of the content of the transmission to be transmitted by a different component of the base station 1402 (or the UE 1404). Similarly, references to “receiving” in the description below may be understood to refer to a first component of the base station 1402 (or the UE 1404) receiving a transmitted signal and outputting (or providing) the received signal (or information based on the received signal) to a different component of the base station 1402 (or the UE 1404).

The UE 1404 may transmit, and the base station 1402 may receive, a UE capability indication 1410 indicating whether the UE supports TB repetition scheduling and/or single-TB scheduling in association with FSI/ECA. In some aspects, an indication of support for single-TB scheduling may imply support for TB repetition scheduling as well. The UE capability indication 1410, in some aspects, may include independent indications for UL and DL.

Based on the UE capability indication 1410, the base station 1402 may transmit, and the UE 1404 may receive, TB scheduling configuration 1412. The TB scheduling configuration 1412, in some aspects, may indicate a mode of TB scheduling (e.g., TB repetition scheduling or single-TB scheduling) associated with both DL and UL, or a first mode of TB scheduling associated with DL and a second mode of TB scheduling associated with UL. In some aspects, a mode of TB scheduling may be determined and indicated per grant and the TB scheduling configuration 1412, may be omitted.

In aspects using SB/CC groups and/or SB/CC grouping, the base station 1402 may transmit, and the UE 1404 may receive, SB/CC group configuration 1414 indicating and/or identifying members of different groups of SBs/CCs. The SB/CC groups indicated by the SB/CC group configuration 1414, in some aspects, may be similar to the SB/CC groups discussed in relation to FIGS. 8-12. In some aspects, the base station 1402 may transmit, and the UE 1404 may receive, state configurations 1416. The state configurations 1416, in some aspects, may indicate a configuration of a plurality of time-domain patterns (e.g., for TDD slots and/or SBs/CCs) and/or states. Each state, in some aspects, may indicate which of a set of available, or indicated, SBs/CCs (e.g., individually indicated or indicated in association with an SB/CC group) is associated with an ON state or an OFF state over a time interval. In some aspects, each state may be associated with (or identify states for SBs/CCs in) a single slot. Each state, in some aspects, may be associated with (or identify states for SBs/CCs across) multiple slots.

Additional details relating to the state configuration 1416 are discussed above in relation to FIGS. 10-12. In some aspects, the TB scheduling configuration 1412, the CC group configuration 1414, and the state configurations 1416 may be provided via RRC signaling (e.g., may be RRC configured), a MAC-CE, or DCI.

Based on the various configurations transmitted by the base station 1402 and received by the UE 1404 which in turn may be based on the UE capability, the mode of TB scheduling, and whether the base station and the UE use SB/CC groups and/or state indications to indicated resources for a scheduled TB, the base station 1402 may transmit, and the UE 1404 may receive, one or more TB scheduling DCIs 1418. The one or more TB scheduling DCIs 1418, in a TB repetition scheduling mode may include one DCI for each repetition or a single DCI for all the repetitions as described in relation to FIG. 13. For a single-TB scheduling mode, the one or more TB scheduling DCIs 1418 may include a single DCI indicating resources associated with the TB transmission/reception as described in relation to FIGS. 7-12. Based on the one or more TB scheduling DCIs 1418, the base station 1402 and/or the UE 1404 may transmit and/or receive PxSCH 1420, or a PUCCH, (e.g., including one of a single TB or a set of TB repetitions) via the resources (and, in some aspects, with a RV index) indicated in the one or more TB scheduling DCIs 1418 as described in relation to FIGS. 7-12.

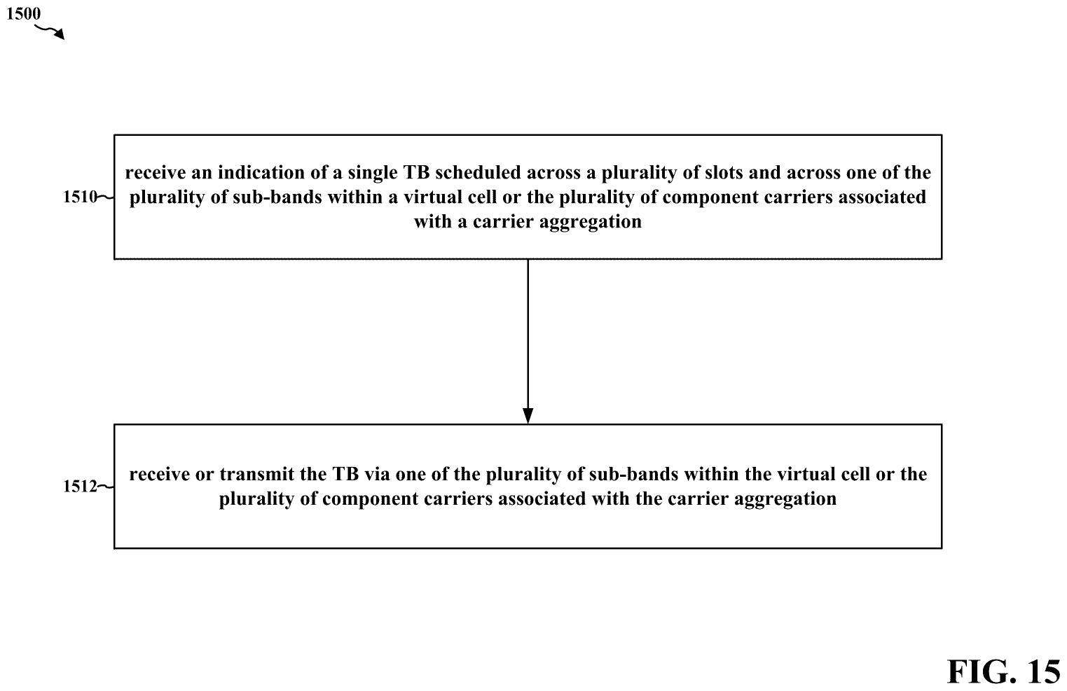

FIG. 15 is a flowchart 1500 of a method of wireless communication. The method may be performed by a UE (e.g., the UE 104, 404, 1404; the apparatus 1904). In some aspects, the UE may transmit one or more of a first indication of support for scheduling a single instance of a TB over a plurality of slots and across one of a plurality of sub-bands within a virtual cell or a plurality of component carriers associated with a carrier aggregation, or a second indication of support for scheduling a plurality of repetitions of the TB over the plurality of slots and across one of the plurality of sub-bands or the plurality of component carriers. In some aspects, the first indication of support for scheduling a single instance of a TB over the plurality of slots and across one of the plurality of sub-bands or the plurality of component carriers may imply support for scheduling a plurality of repetitions of the TB over the plurality of slots and across one of the plurality of sub-bands or the plurality of component carriers. For example, referring to FIG. 14, the UE 1404 may transmit the UE capability indication 1410.

The UE may, in some aspects, receive an additional indication of a mode of TB scheduling across pluralities of slots and one of the plurality of sub-bands or the plurality of component carriers. In some aspects, the mode of TB scheduling comprises one of a first mode of TB scheduling associated with scheduling a single TB across multiple slots and one of multiple sub-bands within the virtual cell or multiple component carriers associated with the carrier aggregation or a second mode of TB scheduling associated with scheduling multiple repetitions of a TB across multiple slots and on each of multiple sub-bands within the virtual cell or multiple component carriers associated with the carrier aggregation. In some aspects, the additional indication may be for both DL and UL directions and/or transmissions. The additional indication, in some aspects, may be for one of the DL or UL directions and/or transmissions. In some aspects, the additional indication is included in one of a RRC message, a MAC-CE, or scheduling DCI. For example, the additional indication may be associated with a particular TB and the UE may not receive the additional indication until the particular TB is scheduled (e.g., via DCI received at 1510). For example, referring to FIG. 14, the UE 1404 may receive the TB scheduling configuration 1412 indicating a mode of TB scheduling.

In some aspects, the UE may receive configuration information identifying members of different groups of sub-bands or component carriers. In some aspects, each member of each group of the different groups may be associated with a same SCS. In some aspects, a group may include members associated with different SCSs. For example, referring to FIG. 14, the UE 1404 may receive the CC group configuration 1414 indicating SB/CC groups.

The UE, in some aspects, may receive configuration information indicating a set of states that may be indicated in the DCI. In some aspects, the state of each sub-band of the plurality of sub-bands or each component carrier of the plurality of component carriers during each slot of the plurality of slots comprises one of a single indicated state that applies to each slot of the plurality of slots, or a sequence of indicated states corresponding to the plurality of slots. In some aspects, a state in the set of states may indicate a slot format or ON/OFF state associated with each member of an SB/CC group over one or more slots. The configuration information, in some aspects, may include a set of states defined for each of a plurality of SB/CC groups. For example, referring to FIG. 14, the UE 1404 may receive the state configurations 1416 indicating states that may be indicated via the one or more TB scheduling DCIs 1418.

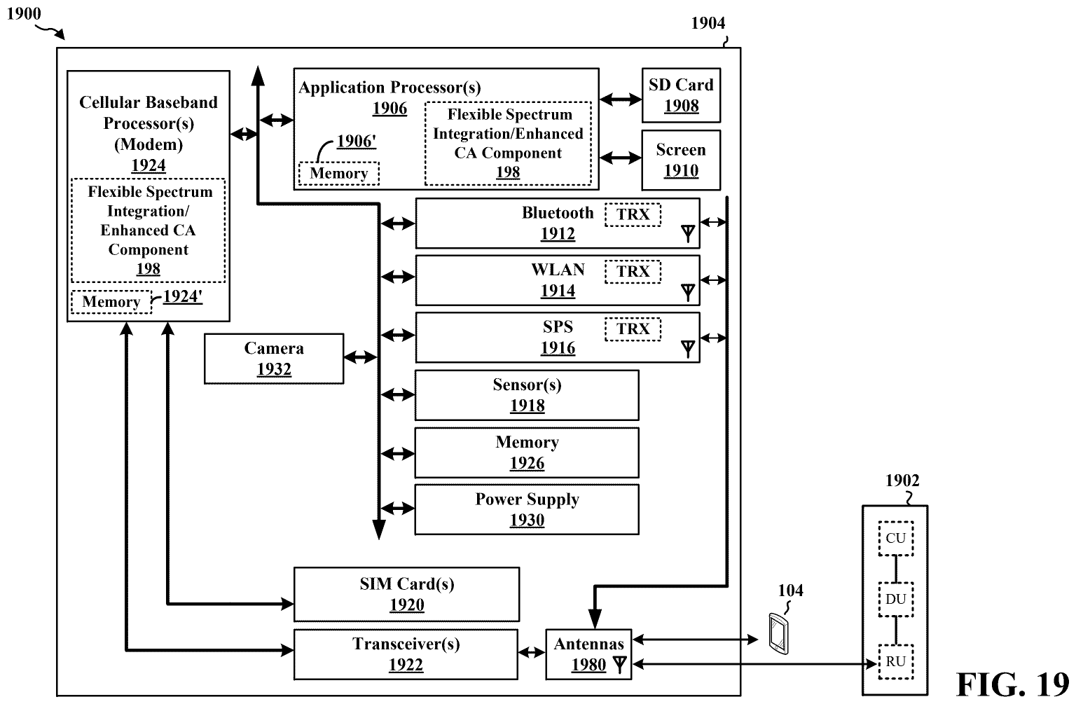

At 1510, the UE may receive an indication of a single TB scheduled across a plurality of slots and across one of a plurality of sub-bands within a virtual cell or a plurality of component carriers associated with a carrier aggregation. For example, 1510 may be performed by application processor(s) 1906, cellular baseband processor(s) 1924, transceiver(s) 1922, antenna(s) 1980, and/or FSI/ECA component 198 of FIG. 19. In some aspects, the indication may be included in scheduling DCI. For example, referring to FIG. 14, the UE 1404 may receive the one or more TB scheduling DCIs 1418 indicating resources associated with the TB transmission/reception as described in relation to FIGS. 7-12.

In some aspects, to indicate the plurality of sub-bands or the plurality of component carriers, the DCI includes one of (1) a plurality of indices corresponding to one of the plurality of sub-bands or the plurality of component carriers or (2) a group index corresponding to one of the plurality of sub-bands or the plurality of component carriers. The DCI, in some aspects, may include an FDRA that is one of (1) a first FDRA that applies, during the plurality of slots, to the plurality of sub-bands or the plurality of component carriers, (2) a first set of FDRAs, where each FDRA in the first set of FDRAs applies, during a corresponding slot in the plurality of slots, to the plurality of sub-bands or the plurality of component carriers, (3) a second set of FDRAs, where each FDRA in the second set of FDRAs applies, during the plurality of slots, to a first corresponding sub-band of the plurality of sub-bands or a first corresponding component carrier of the plurality of component carriers, or (4) a third set of FDRAs, where each FDRA in the second set of FDRAs applies, during a corresponding slot in the plurality of slots, to a second corresponding sub-band of the plurality of sub-bands or a second corresponding component carrier of the plurality of component carriers.

The DCI, in some aspects, includes an additional indication of a timing associated with the TB that is one of (1) a first set of slot indices for each sub-band of the plurality of sub-bands or component carrier of the plurality of component carriers indicating slots in the plurality of slots for which the TB is scheduled, (2) a second set of slot offsets for each sub-band of the plurality of sub-bands or each component carrier of the plurality of component carriers indicating slots in the plurality of slots for which the TB is scheduled, (3) a first TDRA indicating a starting symbol and a duration per slot that applies, during the plurality of slots, to the plurality of sub-bands or the plurality of component carriers, (4) a first set of TDRAs, where each TDRA in the first set of TDRAs applies, during a corresponding slot in the plurality of slots, to the plurality of sub-bands or the plurality of component carriers, (5) a second set of TDRAs, where each TDRA in the second set of TDRAs applies, during the plurality of slots, to a corresponding sub-band or component carrier of the plurality of sub-bands or the plurality of component carriers, (6) a third set of TDRAs, where each TDRA in the second set of TDRAs applies, during a corresponding slot in the plurality of slots, to a first corresponding sub-band of the plurality of sub-bands or a first corresponding component carrier of the plurality of component carriers, (7) a first extended TDRA indicating an extended duration that includes the plurality of slots and that applies, during the plurality of slots, to the plurality of sub-bands or the plurality of component carriers, or (8) a fourth set of extended TDRAs, where each extended TDRA in the fourth set of extended TDRAs applies, during the plurality of slots, to a second corresponding sub-band of the plurality of sub-bands or a second corresponding component carrier of the plurality of component carriers. In some aspects, the DCI includes one of the first extended TDRA or the fourth set of extended TDRAs and the TB may be associated with a first transmission direction and the extended duration spans at least one slot associated with a second transmission direction that is not the first transmission direction in one of a first sub-band of the plurality of sub-bands or a first component carrier of the plurality of component carriers. The extended duration, in some aspects, may be based on one of excluding the at least one slot associated with the second transmission direction from the extended duration applied to the first sub-band or the first component carrier or including the at least one slot associated with the second transmission direction in the extended duration applied to the first sub-band or the first component carrier.

In some aspects, the DCI includes an additional indication of a time interval spanning the plurality of slots, where, during each slot of the plurality of slots, a corresponding set of sub-bands of the plurality of sub-bands or a corresponding set of component carriers of the plurality of component carriers carrying the TB is based on one of (1) a slot format and/or state associated with each sub-band of the plurality of sub-bands or each component carrier of the plurality of component carriers, or (2) a slot format and/or state, indicated in the DCI, of each sub-band of the plurality of sub-bands or each component carrier of the plurality of component carriers during each slot of the plurality of slots. A state of each sub-band of the plurality of sub-bands or each component carrier of the plurality of component carriers during a particular slot, in some aspects, may include a slot format and/or an ON/OFF state associated with each sub-band of the plurality of sub-bands or each component carrier of the plurality of component carriers during the particular slot. In some aspects, the time interval may be indicated as a number of slots based on one of a SCS associated with one sub-band of the plurality of sub-bands or one component carrier of the plurality of component carriers or a reference SCS.

A processing timeline associated with the TB, in some aspects, may be based on one of an earliest slot in the plurality of slots or a latest slot in the plurality of slots. In some aspects, the TB scheduled across the plurality of slots may include one of (1) a plurality of repetitions of the TB, where each repetition in the plurality of repetitions is associated with one of a set of one or more sub-bands of the plurality of sub-bands or a set of one or more component carriers of the plurality of component carriers, or (2) a single instance of the TB. The TB scheduled across the plurality of slots, in some aspects, may include the plurality of repetitions of the TB, and the indication of the TB may include one of a single scheduling DCI scheduling the plurality of repetitions of the TB or a plurality of scheduling DCIs corresponding to the plurality of repetitions of the TB. In some aspects the indication of the single TB scheduled across the plurality of slots and across one of the plurality of sub-bands within the virtual cell or the plurality of component carriers associated with the carrier aggregation includes an additional indication of one of (1) a first RV associated with the single instance of the TB, or (2) a plurality of RVs corresponding to the plurality of repetitions of the TB.

At 1512, the UE may receive or transmit the TB via one of the plurality of sub-bands within the virtual cell or the plurality of component carriers associated with the carrier aggregation. For example, 1512 may be performed by application processor(s) 1906, cellular baseband processor(s) 1924, transceiver(s) 1922, antenna(s) 1980, and/or FSI/ECA component 198 of FIG. 19. In some aspects, the TB may be received or transmitted via (1) a plurality of repetitions of the TB, where each repetition in the plurality of repetitions is associated with one of a set of one or more sub-bands of the plurality of sub-bands or a set of one or more component carriers of the plurality of component carriers, or (2) a single instance of the TB. For example, referring to FIG. 14, the UE 1404 may receive or transmit the PxSCH 1420 (e.g., including one of a single TB or a set of TB repetitions) via the resources indicated in the one or more TB scheduling DCIs 1418 as described in relation to FIGS. 7-12.

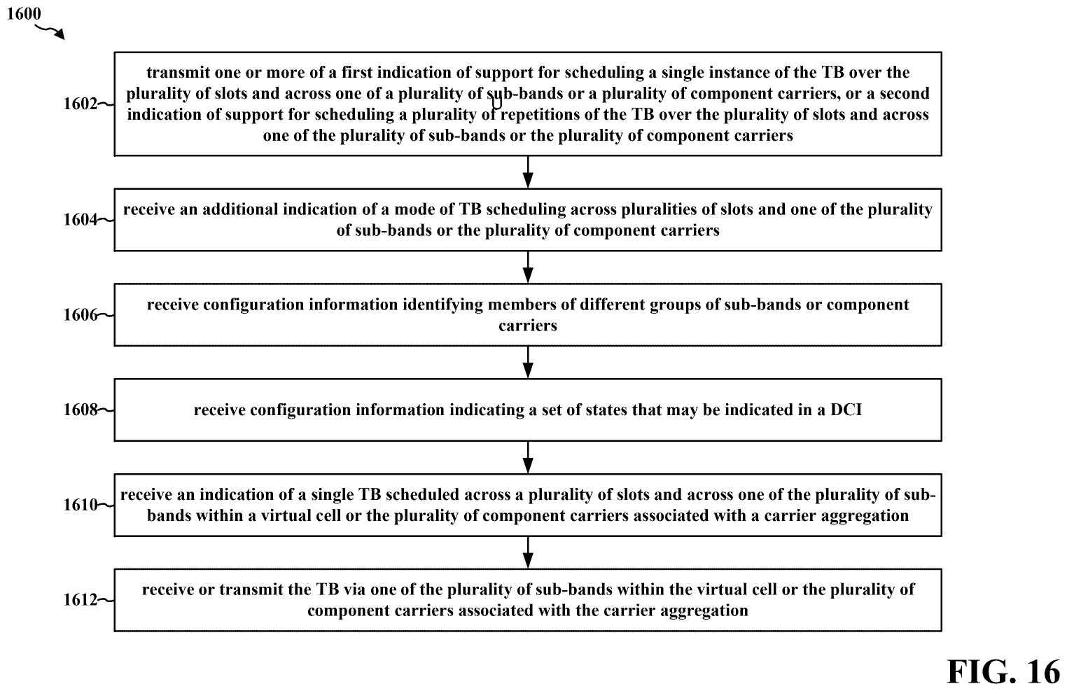

FIG. 16 is a flowchart 1600 of a method of wireless communication. The method may be performed by a UE (e.g., the UE 104, 404, 1404; the apparatus 1904). At 1602, the UE may transmit one or more of a first indication of support for scheduling a single instance of a TB over a plurality of slots and across one of a plurality of sub-bands within a virtual cell or a plurality of component carriers associated with a carrier aggregation, or a second indication of support for scheduling a plurality of repetitions of the TB over the plurality of slots and across one of the plurality of sub-bands or the plurality of component carriers. For example, 1602 may be performed by application processor(s) 1906, cellular baseband processor(s) 1924, transceiver(s) 1922, antenna(s) 1980, and/or FSI/ECA component 198 of FIG. 19. In some aspects, the first indication of support for scheduling a single instance of a TB over the plurality of slots and across one of the plurality of sub-bands or the plurality of component carriers may imply support for scheduling a plurality of repetitions of the TB over the plurality of slots and across one of the plurality of sub-bands or the plurality of component carriers. For example, referring to FIG. 14, the UE 1404 may transmit the UE capability indication 1410.

At 1604, the UE may, receive an additional indication of a mode of TB scheduling across pluralities of slots and one of the plurality of sub-bands or the plurality of component carriers. In some aspects, the mode of TB scheduling comprises one of a first mode of TB scheduling associated with scheduling a single TB across multiple slots and one of multiple sub-bands within the virtual cell or multiple component carriers associated with the carrier aggregation or a second mode of TB scheduling associated with scheduling multiple repetitions of a TB across multiple slots and on each of multiple sub-bands within the virtual cell or multiple component carriers associated with the carrier aggregation. In some aspects, the additional indication may be for both DL and UL directions and/or transmissions. The additional indication, in some aspects, may be for one of the DL or UL directions and/or transmissions. For example, 1604 may be performed by application processor(s) 1906, cellular baseband processor(s) 1924, transceiver(s) 1922, antenna(s) 1980, and/or FSI/ECA component 198 of FIG. 19. In some aspects, the additional indication is included in one of a RRC message, a MAC-CE, or scheduling DCI. For example, the additional indication may be associated with a particular TB and the UE may not receive the additional indication until the particular TB is scheduled (e.g., via DCI received at 1610). For example, referring to FIG. 14, the UE 1404 may receive the TB scheduling configuration 1412 indicating a mode of TB scheduling.

At 1606, the UE may receive configuration information identifying members of different groups of sub-bands or component carriers. For example, 1606 may be performed by application processor(s) 1906, cellular baseband processor(s) 1924, transceiver(s) 1922, antenna(s) 1980, and/or FSI/ECA component 198 of FIG. 19. In some aspects, each member of each group of the different groups may be associated with a same SCS. In some aspects, a group may include members associated with different SCSs. For example, referring to FIG. 14, the UE 1404 may receive the CC group configuration 1414 indicating SB/CC groups.

At 1608, the UE may receive configuration information indicating a set of states that may be indicated in the DCI. In some aspects, the state of each sub-band of the plurality of sub-bands or each component carrier of the plurality of component carriers during each slot of the plurality of slots comprises one of a single indicated state that applies to each slot of the plurality of slots, or a sequence of indicated states corresponding to the plurality of slots. For example, 1608 may be performed by application processor(s) 1906, cellular baseband processor(s) 1924, transceiver(s) 1922, antenna(s) 1980, and/or FSI/ECA component 198 of FIG. 19. In some aspects, a state in the set of states may indicate a slot format or ON/OFF state associated with each member of an SB/CC group over one or more slots. The configuration information, in some aspects, may include a set of states defined for each of a plurality of SB/CC groups. For example, referring to FIG. 14, the UE 1404 may receive the state configurations 1416 indicating states that may be indicated via the one or more TB scheduling DCIs 1418.

At 1610, the UE may receive an indication of a single TB scheduled across a plurality of slots and across one of a plurality of sub-bands within a virtual cell or a plurality of component carriers associated with a carrier aggregation. For example, 1610 may be performed by application processor(s) 1906, cellular baseband processor(s) 1924, transceiver(s) 1922, antenna(s) 1980, and/or FSI/ECA component 198 of FIG. 19. In some aspects, the indication may be included in scheduling DCI. For example, referring to FIG. 14, the UE 1404 may receive the one or more TB scheduling DCIs 1418 indicating resources associated with the TB transmission/reception as described in relation to FIGS. 7-12.

In some aspects, to indicate the plurality of sub-bands or the plurality of component carriers, the DCI includes one of (1) a plurality of indices corresponding to one of the plurality of sub-bands or the plurality of component carriers or (2) a group index corresponding to one of the plurality of sub-bands or the plurality of component carriers. The DCI, in some aspects, may include an FDRA that is one of (1) a first FDRA that applies, during the plurality of slots, to the plurality of sub-bands or the plurality of component carriers, (2) a first set of FDRAs, where each FDRA in the first set of FDRAs applies, during a corresponding slot in the plurality of slots, to the plurality of sub-bands or the plurality of component carriers, (3) a second set of FDRAs, where each FDRA in the second set of FDRAs applies, during the plurality of slots, to a first corresponding sub-band of the plurality of sub-bands or a first corresponding component carrier of the plurality of component carriers, or (4) a third set of FDRAs, where each FDRA in the second set of FDRAs applies, during a corresponding slot in the plurality of slots, to a second corresponding sub-band of the plurality of sub-bands or a second corresponding component carrier of the plurality of component carriers.

The DCI, in some aspects, includes an additional indication of a timing associated with the TB that is one of (1) a first set of slot indices for each sub-band of the plurality of sub-bands or component carrier of the plurality of component carriers indicating slots in the plurality of slots for which the TB is scheduled, (2) a second set of slot offsets for each sub-band of the plurality of sub-bands or each component carrier of the plurality of component carriers indicating slots in the plurality of slots for which the TB is scheduled, (3) a first TDRA indicating a starting symbol and a duration per slot that applies, during the plurality of slots, to the plurality of sub-bands or the plurality of component carriers, (4) a first set of TDRAs, where each TDRA in the first set of TDRAs applies, during a corresponding slot in the plurality of slots, to the plurality of sub-bands or the plurality of component carriers, (5) a second set of TDRAs, where each TDRA in the second set of TDRAs applies, during the plurality of slots, to a corresponding sub-band or component carrier of the plurality of sub-bands or the plurality of component carriers, (6) a third set of TDRAs, where each TDRA in the second set of TDRAs applies, during a corresponding slot in the plurality of slots, to a first corresponding sub-band of the plurality of sub-bands or a first corresponding component carrier of the plurality of component carriers, (7) a first extended TDRA indicating an extended duration that includes the plurality of slots and that applies, during the plurality of slots, to the plurality of sub-bands or the plurality of component carriers, or (8) a fourth set of extended TDRAs, where each extended TDRA in the fourth set of extended TDRAs applies, during the plurality of slots, to a second corresponding sub-band of the plurality of sub-bands or a second corresponding component carrier of the plurality of component carriers. In some aspects, the DCI includes one of the first extended TDRA or the fourth set of extended TDRAs and the TB may be associated with a first transmission direction and the extended duration spans at least one slot associated with a second transmission direction that is not the first transmission direction in one of a first sub-band of the plurality of sub-bands or a first component carrier of the plurality of component carriers. The extended duration, in some aspects, may be based on one of excluding the at least one slot associated with the second transmission direction from the extended duration applied to the first sub-band or the first component carrier or including the at least one slot associated with the second transmission direction in the extended duration applied to the first sub-band or the first component carrier.

In some aspects, the DCI includes an additional indication of a time interval spanning the plurality of slots, where, during each slot of the plurality of slots, a corresponding set of sub-bands of the plurality of sub-bands or a corresponding set of component carriers of the plurality of component carriers carrying the TB is based on one of (1) a slot format and/or state associated with each sub-band of the plurality of sub-bands or each component carrier of the plurality of component carriers, or (2) a slot format and/or state, indicated in the DCI, of each sub-band of the plurality of sub-bands or each component carrier of the plurality of component carriers during each slot of the plurality of slots. A state of each sub-band of the plurality of sub-bands or each component carrier of the plurality of component carriers during a particular slot, in some aspects, may include a slot format and/or an ON/OFF state associated with each sub-band of the plurality of sub-bands or each component carrier of the plurality of component carriers during the particular slot. In some aspects, the time interval may be indicated as a number of slots based on one of a SCS associated with one sub-band of the plurality of sub-bands or one component carrier of the plurality of component carriers or a reference SCS.

A processing timeline associated with the TB, in some aspects, may be based on one of an earliest slot in the plurality of slots or a latest slot in the plurality of slots. In some aspects, the TB scheduled across the plurality of slots may include one of (1) a plurality of repetitions of the TB, where each repetition in the plurality of repetitions is associated with one of a set of one or more sub-bands of the plurality of sub-bands or a set of one or more component carriers of the plurality of component carriers, or (2) a single instance of the TB. The TB scheduled across the plurality of slots, in some aspects, may include the plurality of repetitions of the TB, and the indication of the TB may include one of a single scheduling DCI scheduling the plurality of repetitions of the TB or a plurality of scheduling DCIs corresponding to the plurality of repetitions of the TB. In some aspects the indication of the single TB scheduled across the plurality of slots and across one of the plurality of sub-bands within the virtual cell or the plurality of component carriers associated with the carrier aggregation includes an additional indication of one of (1) a first RV associated with the single instance of the TB, or (2) a plurality of RVs corresponding to the plurality of repetitions of the TB.

At 1612, the UE may receive or transmit the TB via one of the plurality of sub-bands within the virtual cell or the plurality of component carriers associated with the carrier aggregation. For example, 1612 may be performed by application processor(s) 1906, cellular baseband processor(s) 1924, transceiver(s) 1922, antenna(s) 1980, and/or FSI/ECA component 198 of FIG. 19. In some aspects, the TB may be received or transmitted via (1) a plurality of repetitions of the TB, where each repetition in the plurality of repetitions is associated with one of a set of one or more sub-bands of the plurality of sub-bands or a set of one or more component carriers of the plurality of component carriers, or (2) a single instance of the TB. For example, referring to FIG. 14, the UE 1404 may receive or transmit the PxSCH 1420 (e.g., including one of a single TB or a set of TB repetitions) via the resources indicated in the one or more TB scheduling DCIs 1418 as described in relation to FIGS. 7-12.

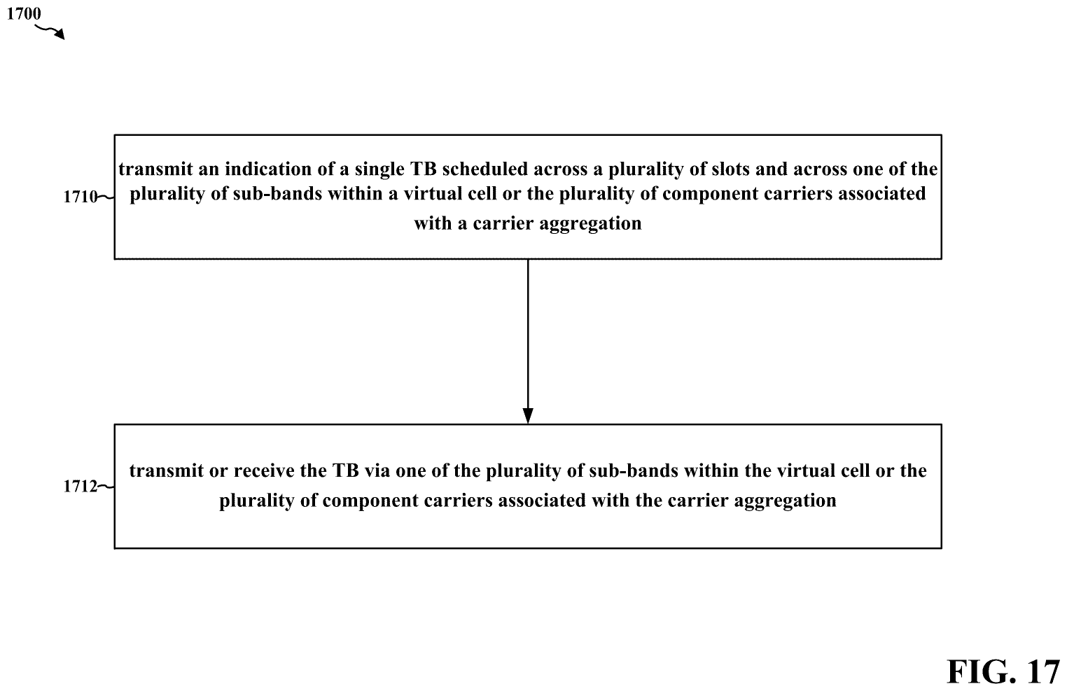

FIG. 17 is a flowchart 1700 of a method of wireless communication. The method may be performed by a base station (e.g., the base station 102, 402, 1402; the network entity 1902, 2002, 2160). In some aspects, the network device may receive, from a UE, one or more of a first indication of support for scheduling a single instance of a TB over a plurality of slots and across one of a plurality of sub-bands within a virtual cell or a plurality of component carriers associated with a carrier aggregation, or a second indication of support for scheduling a plurality of repetitions of the TB over the plurality of slots and across one of the plurality of sub-bands or the plurality of component carriers. In some aspects, the first indication of support for scheduling a single instance of a TB over the plurality of slots and across one of the plurality of sub-bands or the plurality of component carriers may imply support for scheduling a plurality of repetitions of the TB over the plurality of slots and across one of the plurality of sub-bands or the plurality of component carriers. For example, referring to FIG. 14, the base station 1402 may receive the UE capability indication 1410.

The network device may, in some aspects, transmit an additional indication of a mode of TB scheduling across pluralities of slots and one of the plurality of sub-bands or the plurality of component carriers. In some aspects, the mode of TB scheduling comprises one of a first mode of TB scheduling associated with scheduling a single TB across multiple slots and one of multiple sub-bands within the virtual cell or multiple component carriers associated with the carrier aggregation or a second mode of TB scheduling associated with scheduling multiple repetitions of a TB across multiple slots and on each of multiple sub-bands within the virtual cell or multiple component carriers associated with the carrier aggregation. In some aspects, the additional indication may be for both DL and UL directions and/or transmissions. The additional indication, in some aspects, may be for one of the DL or UL directions and/or transmissions. In some aspects, the additional indication is included in one of a RRC message, a MAC-CE, or scheduling DCI. For example, the additional indication may be associated with a particular TB and the network device may not transmit the additional indication until the particular TB is scheduled (e.g., via DCI transmitted at 1710). For example, referring to FIG. 14, the base station 1402 may transmit the TB scheduling configuration 1412 indicating a mode of TB scheduling.

In some aspects, the network device may transmit configuration information identifying members of different groups of sub-bands or component carriers. In some aspects, each member of each group of the different groups may be associated with a same SCS. In some aspects, a group may include members associated with different SCSs. For example, referring to FIG. 14, the base station 1402 may transmit the CC group configuration 1414 indicating SB/CC groups.

The network device, in some aspects, may transmit configuration information indicating a set of states that may be indicated in the DCI. In some aspects, the state of each sub-band of the plurality of sub-bands or each component carrier of the plurality of component carriers during each slot of the plurality of slots comprises one of a single indicated state that applies to each slot of the plurality of slots, or a sequence of indicated states corresponding to the plurality of slots. In some aspects, a state in the set of states may indicate a slot format and/or ON/OFF state associated with each member of an SB/CC group over one or more slots. The configuration information, in some aspects, may include a set of states defined for each of a plurality of SB/CC groups. For example, referring to FIG. 14, the base station 1402 may transmit the state configurations 1416 indicating states that may be indicated via the one or more TB scheduling DCIs 1418.

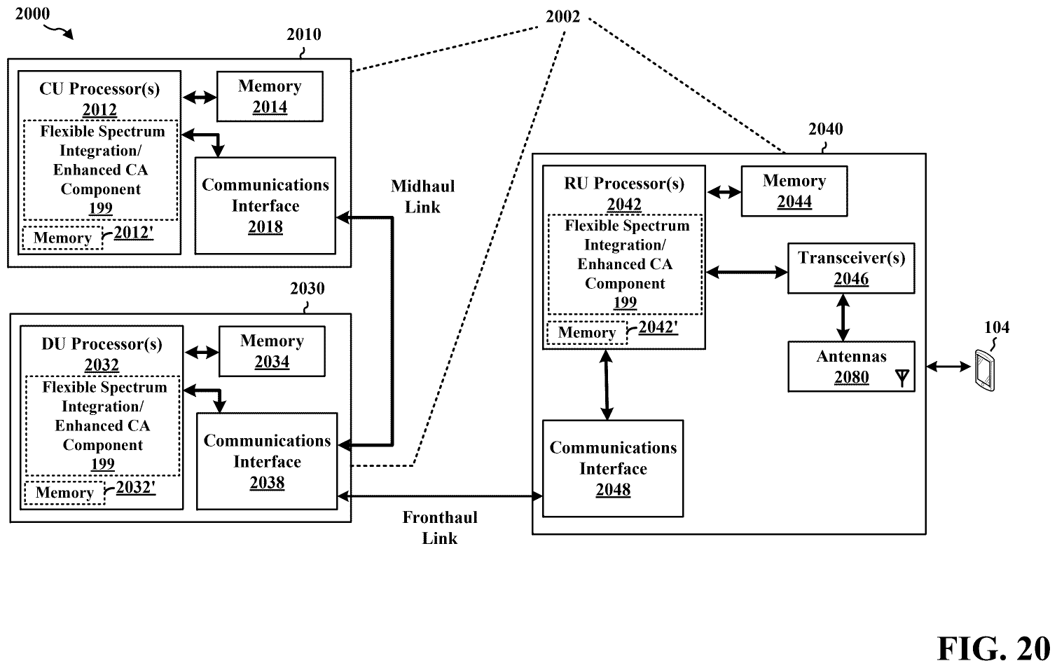

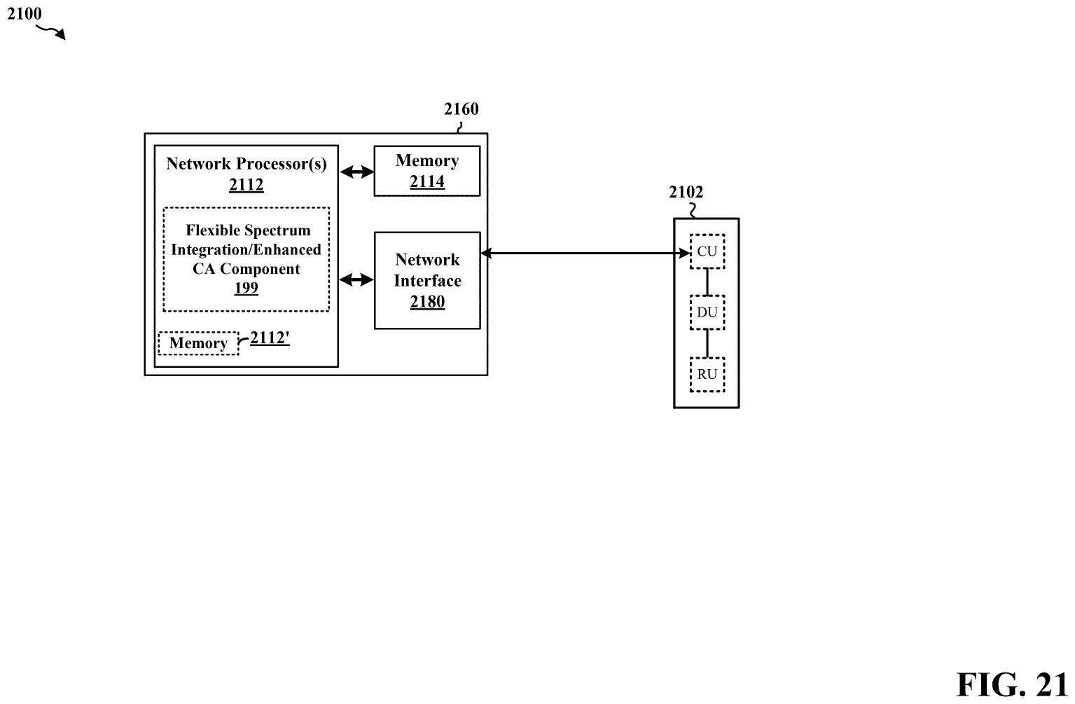

At 1710, the network device may transmit an indication of a single TB scheduled across a plurality of slots and across one of a plurality of sub-bands within a virtual cell or a plurality of component carriers associated with a carrier aggregation. For example, 1710 may be performed by CU processor(s) 2012, DU processor(s) 2032, RU processor(s) 2042, transceiver(s) 2046, antenna(s) 2080, network processor 2112, network interface 2180, and/or FSI/ECA component 199 of FIGS. 20 and 21. In some aspects, the indication may be included in scheduling DCI. For example, referring to FIG. 14, the base station 1402 may transmit the one or more TB scheduling DCIs 1418 indicating resources associated with the TB transmission/reception as described in relation to FIGS. 7-12.

In some aspects, to indicate the plurality of sub-bands or the plurality of component carriers, the DCI includes one of (1) a plurality of indices corresponding to one of the plurality of sub-bands or the plurality of component carriers or (2) a group index corresponding to one of the plurality of sub-bands or the plurality of component carriers. The DCI, in some aspects, may include an FDRA that is one of (1) a first FDRA that applies, during the plurality of slots, to the plurality of sub-bands or the plurality of component carriers, (2) a first set of FDRAs, where each FDRA in the first set of FDRAs applies, during a corresponding slot in the plurality of slots, to the plurality of sub-bands or the plurality of component carriers, (3) a second set of FDRAs, where each FDRA in the second set of FDRAs applies, during the plurality of slots, to a first corresponding sub-band of the plurality of sub-bands or a first corresponding component carrier of the plurality of component carriers, or (4) a third set of FDRAs, where each FDRA in the second set of FDRAs applies, during a corresponding slot in the plurality of slots, to a second corresponding sub-band of the plurality of sub-bands or a second corresponding component carrier of the plurality of component carriers.

The DCI, in some aspects, includes an additional indication of a timing associated with the TB that is one of (1) a first set of slot indices for each sub-band of the plurality of sub-bands or component carrier of the plurality of component carriers indicating slots in the plurality of slots for which the TB is scheduled, (2) a second set of slot offsets for each sub-band of the plurality of sub-bands or each component carrier of the plurality of component carriers indicating slots in the plurality of slots for which the TB is scheduled, (3) a first TDRA indicating a starting symbol and a duration per slot that applies, during the plurality of slots, to the plurality of sub-bands or the plurality of component carriers, (4) a first set of TDRAs, where each TDRA in the first set of TDRAs applies, during a corresponding slot in the plurality of slots, to the plurality of sub-bands or the plurality of component carriers, (5) a second set of TDRAs, where each TDRA in the second set of TDRAs applies, during the plurality of slots, to a corresponding sub-band or component carrier of the plurality of sub-bands or the plurality of component carriers, (6) a third set of TDRAs, where each TDRA in the second set of TDRAs applies, during a corresponding slot in the plurality of slots, to a first corresponding sub-band of the plurality of sub-bands or a first corresponding component carrier of the plurality of component carriers, (7) a first extended TDRA indicating an extended duration that includes the plurality of slots and that applies, during the plurality of slots, to the plurality of sub-bands or the plurality of component carriers, or (8) a fourth set of extended TDRAs, where each extended TDRA in the fourth set of extended TDRAs applies, during the plurality of slots, to a second corresponding sub-band of the plurality of sub-bands or a second corresponding component carrier of the plurality of component carriers. In some aspects, the DCI includes one of the first extended TDRA or the fourth set of extended TDRAs and the TB may be associated with a first transmission direction and the extended duration spans at least one slot associated with a second transmission direction that is not the first transmission direction in one of a first sub-band of the plurality of sub-bands or a first component carrier of the plurality of component carriers. The extended duration, in some aspects, may be based on one of excluding the at least one slot associated with the second transmission direction from the extended duration applied to the first sub-band or the first component carrier or including the at least one slot associated with the second transmission direction in the extended duration applied to the first sub-band or the first component carrier.

In some aspects, the DCI includes an additional indication of a time interval spanning the plurality of slots, where, during each slot of the plurality of slots, a corresponding set of sub-bands of the plurality of sub-bands or a corresponding set of component carriers of the plurality of component carriers carrying the TB is based on one of (1) a slot format and/or state associated with each sub-band of the plurality of sub-bands or each component carrier of the plurality of component carriers, or (2) a slot format and/or state, indicated in the DCI, of each sub-band of the plurality of sub-bands or each component carrier of the plurality of component carriers during each slot of the plurality of slots. A state of each sub-band of the plurality of sub-bands or each component carrier of the plurality of component carriers during a particular slot, in some aspects, may include a slot format and/or an ON/OFF state associated with each sub-band of the plurality of sub-bands or each component carrier of the plurality of component carriers during the particular slot. In some aspects, the time interval may be indicated as a number of slots based on one of a SCS associated with one sub-band of the plurality of sub-bands or one component carrier of the plurality of component carriers or a reference SCS.

A processing timeline associated with the TB, in some aspects, may be based on one of an earliest slot in the plurality of slots or a latest slot in the plurality of slots. In some aspects, the TB scheduled across the plurality of slots may include one of (1) a plurality of repetitions of the TB, where each repetition in the plurality of repetitions is associated with one of a set of one or more sub-bands of the plurality of sub-bands or a set of one or more component carriers of the plurality of component carriers, or (2) a single instance of the TB. The TB scheduled across the plurality of slots, in some aspects, may include the plurality of repetitions of the TB, and the indication of the TB may include one of a single scheduling DCI scheduling the plurality of repetitions of the TB or a plurality of scheduling DCIs corresponding to the plurality of repetitions of the TB. In some aspects the indication of the single TB scheduled across the plurality of slots and across one of the plurality of sub-bands within the virtual cell or the plurality of component carriers associated with the carrier aggregation includes an additional indication of one of (1) a first RV associated with the single instance of the TB, or (2) a plurality of RVs corresponding to the plurality of repetitions of the TB.

At 1712, the network device may transmit or receive the TB via one of the plurality of sub-bands within the virtual cell or the plurality of component carriers associated with the carrier aggregation. For example, 1712 may be performed by CU processor(s) 2012, DU processor(s) 2032, RU processor(s) 2042, transceiver(s) 2046, antenna(s) 2080, network processor 2112, network interface 2180, and/or FSI/ECA component 199 of FIGS. 20 and 21. In some aspects, the TB may be transmitted or received via (1) a plurality of repetitions of the TB, where each repetition in the plurality of repetitions is associated with one of a set of one or more sub-bands of the plurality of sub-bands or a set of one or more component carriers of the plurality of component carriers, or (2) a single instance of the TB. For example, referring to FIG. 14, the base station 1402 may transmit or receive the PxSCH 1420 (e.g., including one of a single TB or a set of TB repetitions) via the resources indicated in the one or more TB scheduling DCIs 1418 as described in relation to FIGS. 7-12.

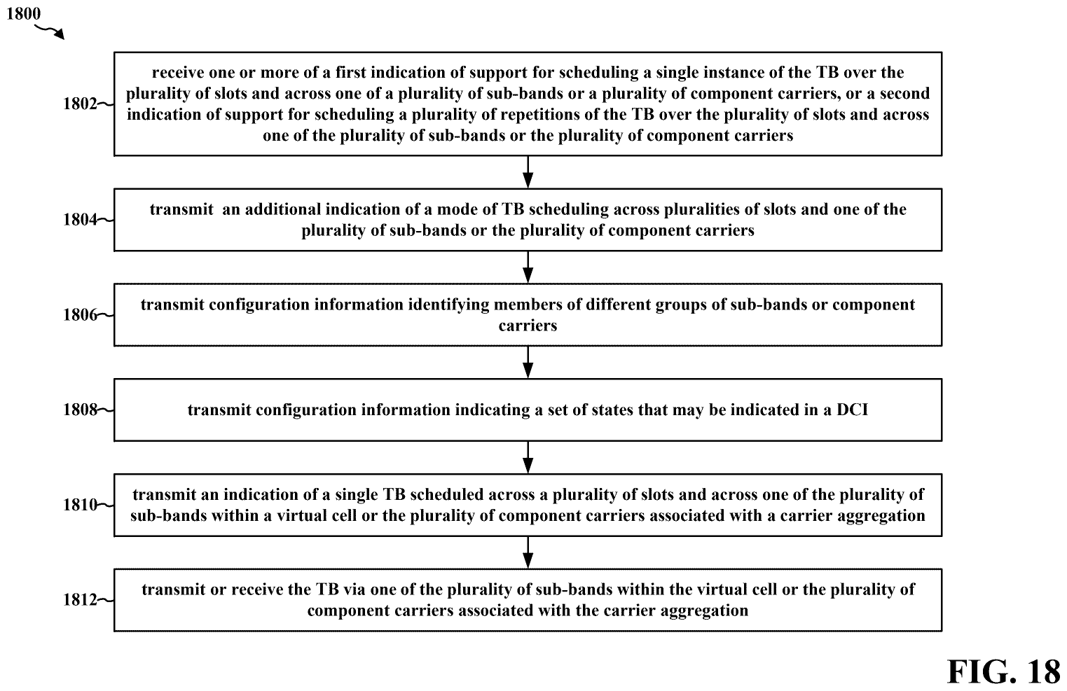

FIG. 18 is a flowchart 1800 of a method of wireless communication. The method may be performed by a base station (e.g., the base station 102, 402, 1402; the network entity 1902, 2002, 2160). At 1802, the network device may receive, from a UE, one or more of a first indication of support for scheduling a single instance of a TB over a plurality of slots and across one of a plurality of sub-bands within a virtual cell or a plurality of component carriers associated with a carrier aggregation, or a second indication of support for scheduling a plurality of repetitions of the TB over the plurality of slots and across one of the plurality of sub-bands or the plurality of component carriers. For example, 1802 may be performed by CU processor(s) 2012, DU processor(s) 2032, RU processor(s) 2042, transceiver(s) 2046, antenna(s) 2080, network processor 2112, network interface 2180, and/or FSI/ECA component 199 of FIGS. 20 and 21. In some aspects, the first indication of support for scheduling a single instance of a TB over the plurality of slots and across one of the plurality of sub-bands or the plurality of component carriers may imply support for scheduling a plurality of repetitions of the TB over the plurality of slots and across one of the plurality of sub-bands or the plurality of component carriers. For example, referring to FIG. 14, the base station 1402 may receive the UE capability indication 1410.

At 1804, the network device may, transmit an additional indication of a mode of TB scheduling across pluralities of slots and one of the plurality of sub-bands or the plurality of component carriers. In some aspects, the mode of TB scheduling comprises one of a first mode of TB scheduling associated with scheduling a single TB across multiple slots and one of multiple sub-bands within the virtual cell or multiple component carriers associated with the carrier aggregation or a second mode of TB scheduling associated with scheduling multiple repetitions of a TB across multiple slots and on each of multiple sub-bands within the virtual cell or multiple component carriers associated with the carrier aggregation. In some aspects, the additional indication may be for both DL and UL directions and/or transmissions. The additional indication, in some aspects, may be for one of the DL or UL directions and/or transmissions. For example, 1804 may be performed by CU processor(s) 2012, DU processor(s) 2032, RU processor(s) 2042, transceiver(s) 2046, antenna(s) 2080, network processor 2112, network interface 2180, and/or FSI/ECA component 199 of FIGS. 20 and 21. In some aspects, the additional indication is included in one of a RRC message, a MAC-CE, or scheduling DCI. For example, the additional indication may be associated with a particular TB and the network device may not transmit the additional indication until the particular TB is scheduled (e.g., via DCI transmitted at 1810). For example, referring to FIG. 14, the base station 1402 may transmit the TB scheduling configuration 1412 indicating a mode of TB scheduling.

At 1806, the network device may transmit configuration information identifying members of different groups of sub-bands or component carriers. For example, 1806 may be performed by CU processor(s) 2012, DU processor(s) 2032, RU processor(s) 2042, transceiver(s) 2046, antenna(s) 2080, network processor 2112, network interface 2180, and/or FSI/ECA component 199 of FIGS. 20 and 21. In some aspects, each member of each group of the different groups may be associated with a same SCS. In some aspects, a group may include members associated with different SCSs. For example, referring to FIG. 14, the base station 1402 may transmit the CC group configuration 1414 indicating SB/CC groups.

At 1808, the network device may transmit configuration information indicating a set of states that may be indicated in the DCI. In some aspects, the state of each sub-band of the plurality of sub-bands or each component carrier of the plurality of component carriers during each slot of the plurality of slots comprises one of a single indicated state that applies to each slot of the plurality of slots, or a sequence of indicated states corresponding to the plurality of slots. For example, 1808 may be performed by CU processor(s) 2012, DU processor(s) 2032, RU processor(s) 2042, transceiver(s) 2046, antenna(s) 2080, network processor 2112, network interface 2180, and/or FSI/ECA component 199 of FIGS. 20 and 21. In some aspects, a state in the set of states may indicate a slot format and/or ON/OFF state associated with each member of an SB/CC group over one or more slots. The configuration information, in some aspects, may include a set of states defined for each of a plurality of SB/CC groups. For example, referring to FIG. 14, the base station 1402 may transmit the state configurations 1416 indicating states that may be indicated via the one or more TB scheduling DCIs 1418.

At 1810, the network device may transmit an indication of a single TB scheduled across a plurality of slots and across one of a plurality of sub-bands within a virtual cell or a plurality of component carriers associated with a carrier aggregation. For example, 1810 may be performed by CU processor(s) 2012, DU processor(s) 2032, RU processor(s) 2042, transceiver(s) 2046, antenna(s) 2080, network processor 2112, network interface 2180, and/or FSI/ECA component 199 of FIGS. 20 and 21. In some aspects, the indication may be included in scheduling DCI. For example, referring to FIG. 14, the base station 1402 may transmit the one or more TB scheduling DCIs 1418 indicating resources associated with the TB transmission/reception as described in relation to FIGS. 7-12.

In some aspects, to indicate the plurality of sub-bands or the plurality of component carriers, the DCI includes one of (1) a plurality of indices corresponding to one of the plurality of sub-bands or the plurality of component carriers or (2) a group index corresponding to one of the plurality of sub-bands or the plurality of component carriers. The DCI, in some aspects, may include an FDRA that is one of (1) a first FDRA that applies, during the plurality of slots, to the plurality of sub-bands or the plurality of component carriers, (2) a first set of FDRAs, where each FDRA in the first set of FDRAs applies, during a corresponding slot in the plurality of slots, to the plurality of sub-bands or the plurality of component carriers, (3) a second set of FDRAs, where each FDRA in the second set of FDRAs applies, during the plurality of slots, to a first corresponding sub-band of the plurality of sub-bands or a first corresponding component carrier of the plurality of component carriers, or (4) a third set of FDRAs, where each FDRA in the second set of FDRAs applies, during a corresponding slot in the plurality of slots, to a second corresponding sub-band of the plurality of sub-bands or a second corresponding component carrier of the plurality of component carriers.

The DCI, in some aspects, includes an additional indication of a timing associated with the TB that is one of (1) a first set of slot indices for each sub-band of the plurality of sub-bands or component carrier of the plurality of component carriers indicating slots in the plurality of slots for which the TB is scheduled, (2) a second set of slot offsets for each sub-band of the plurality of sub-bands or each component carrier of the plurality of component carriers indicating slots in the plurality of slots for which the TB is scheduled, (3) a first TDRA indicating a starting symbol and a duration per slot that applies, during the plurality of slots, to the plurality of sub-bands or the plurality of component carriers, (4) a first set of TDRAs, where each TDRA in the first set of TDRAs applies, during a corresponding slot in the plurality of slots, to the plurality of sub-bands or the plurality of component carriers, (5) a second set of TDRAs, where each TDRA in the second set of TDRAs applies, during the plurality of slots, to a corresponding sub-band or component carrier of the plurality of sub-bands or the plurality of component carriers, (6) a third set of TDRAs, where each TDRA in the second set of TDRAs applies, during a corresponding slot in the plurality of slots, to a first corresponding sub-band of the plurality of sub-bands or a first corresponding component carrier of the plurality of component carriers, (7) a first extended TDRA indicating an extended duration that includes the plurality of slots and that applies, during the plurality of slots, to the plurality of sub-bands or the plurality of component carriers, or (8) a fourth set of extended TDRAs, where each extended TDRA in the fourth set of extended TDRAs applies, during the plurality of slots, to a second corresponding sub-band of the plurality of sub-bands or a second corresponding component carrier of the plurality of component carriers. In some aspects, the DCI includes one of the first extended TDRA or the fourth set of extended TDRAs and the TB may be associated with a first transmission direction and the extended duration spans at least one slot associated with a second transmission direction that is not the first transmission direction in one of a first sub-band of the plurality of sub-bands or a first component carrier of the plurality of component carriers. The extended duration, in some aspects, may be based on one of excluding the at least one slot associated with the second transmission direction from the extended duration applied to the first sub-band or the first component carrier or including the at least one slot associated with the second transmission direction in the extended duration applied to the first sub-band or the first component carrier.

In some aspects, the DCI includes an additional indication of a time interval spanning the plurality of slots, where, during each slot of the plurality of slots, a corresponding set of sub-bands of the plurality of sub-bands or a corresponding set of component carriers of the plurality of component carriers carrying the TB is based on one of (1) a slot format and/or state associated with each sub-band of the plurality of sub-bands or each component carrier of the plurality of component carriers, or (2) a slot format and/or state, indicated in the DCI, of each sub-band of the plurality of sub-bands or each component carrier of the plurality of component carriers during each slot of the plurality of slots. A state of each sub-band of the plurality of sub-bands or each component carrier of the plurality of component carriers during a particular slot, in some aspects, may include a slot format and/or an ON/OFF state associated with each sub-band of the plurality of sub-bands or each component carrier of the plurality of component carriers during the particular slot. In some aspects, the time interval may be indicated as a number of slots based on one of a SCS associated with one sub-band of the plurality of sub-bands or one component carrier of the plurality of component carriers or a reference SCS.

A processing timeline associated with the TB, in some aspects, may be based on one of an earliest slot in the plurality of slots or a latest slot in the plurality of slots. In some aspects, the TB scheduled across the plurality of slots may include one of (1) a plurality of repetitions of the TB, where each repetition in the plurality of repetitions is associated with one of a set of one or more sub-bands of the plurality of sub-bands or a set of one or more component carriers of the plurality of component carriers, or (2) a single instance of the TB. The TB scheduled across the plurality of slots, in some aspects, may include the plurality of repetitions of the TB, and the indication of the TB may include one of a single scheduling DCI scheduling the plurality of repetitions of the TB or a plurality of scheduling DCIs corresponding to the plurality of repetitions of the TB. In some aspects the indication of the single TB scheduled across the plurality of slots and across one of the plurality of sub-bands within the virtual cell or the plurality of component carriers associated with the carrier aggregation includes an additional indication of one of (1) a first RV associated with the single instance of the TB, or (2) a plurality of RVs corresponding to the plurality of repetitions of the TB.

At 1812, the network device may transmit or receive the TB via one of the plurality of sub-bands within the virtual cell or the plurality of component carriers associated with the carrier aggregation. For example, 1812 may be performed by CU processor(s) 2012, DU processor(s) 2032, RU processor(s) 2042, transceiver(s) 2046, antenna(s) 2080, network processor 2112, network interface 2180, and/or FSI/ECA component 199 of FIGS. 20 and 21. In some aspects, the TB may be transmitted or received via (1) a plurality of repetitions of the TB, where each repetition in the plurality of repetitions is associated with one of a set of one or more sub-bands of the plurality of sub-bands or a set of one or more component carriers of the plurality of component carriers, or (2) a single instance of the TB. For example, referring to FIG. 14, the base station 1402 may transmit or receive the PxSCH 1420 (e.g., including one of a single TB or a set of TB repetitions) via the resources indicated in the one or more TB scheduling DCIs 1418 as described in relation to FIGS. 7-12.

FIG. 19 is a diagram 1900 illustrating an example of a hardware implementation for an apparatus 1904. The apparatus 1904 may be a UE, a component of a UE, or may implement UE functionality. In some aspects, the apparatus 1904 may include at least one cellular baseband processor 1924 (also referred to as a modem) coupled to one or more transceivers 1922 (e.g., cellular RF transceiver). The cellular baseband processor(s) 1924 may include at least one on-chip memory 1924′. In some aspects, the apparatus 1904 may further include one or more subscriber identity modules (SIM) cards 1920 and at least one application processor 1906 coupled to a secure digital (SD) card 1908 and a screen 1910. The application processor(s) 1906 may include on-chip memory 1906′. In some aspects, the apparatus 1904 may further include a Bluetooth module 1912, a WLAN module 1914, an SPS module 1916 (e.g., GNSS module), one or more sensor modules 1918 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1926, a power supply 1930, and/or a camera 1932. The Bluetooth module 1912, the WLAN module 1914, and the SPS module 1916 may include an on-chip transceiver (TRX) (or in some cases, just a receiver (RX)). The Bluetooth module 1912, the WLAN module 1914, and the SPS module 1916 may include their own dedicated antennas and/or utilize one or more antennas 1980 for communication. The cellular baseband processor(s) 1924 communicates through the transceiver(s) 1922 via the one or more antennas 1980 with the UE 104 and/or with an RU associated with a network entity 1902. The cellular baseband processor(s) 1924 and the application processor(s) 1906 may each include a computer-readable medium/memory 1924′, 1906′, respectively. The additional memory modules 1926 may also be considered a computer-readable medium/memory. Each computer-readable medium/memory 1924′, 1906′, 1926 may be non-transitory. The cellular baseband processor(s) 1924 and the application processor(s) 1906 are each responsible for general processing, including the execution of software stored on the computer-readable medium/memory. The software, when executed by the cellular baseband processor(s) 1924/application processor(s) 1906, causes the cellular baseband processor(s) 1924/application processor(s) 1906 to perform the various functions described supra. The computer-readable medium/memory may also be used for storing data that is manipulated by the cellular baseband processor(s) 1924/application processor(s) 1906 when executing software. The cellular baseband processor(s) 1924/application processor(s) 1906 may be a component of the UE 350 and may include the at least one memory 360 and/or at least one of the TX processor 368, the RX processor 356, and the controller/processor 359. In one configuration, the apparatus 1904 may be at least one processor chip (modem and/or application) and include just the cellular baseband processor(s) 1924 and/or the application processor(s) 1906, and in another configuration, the apparatus 1904 may be the entire UE (e.g., see UE 350 of FIG. 3) and include the additional modules of the apparatus 1904.

As discussed supra, the FSI/ECA component 198 may be configured to receive an indication of a single TB scheduled across a plurality of slots and across one of a plurality of sub-bands within a virtual cell or a plurality of component carriers associated with a carrier aggregation, and receive or transmit the TB via the plurality of slots and one of the plurality of sub-bands within the virtual cell or the plurality of component carriers associated with the carrier aggregation. The FSI/ECA component 198 may be within the cellular baseband processor(s) 1924, the application processor(s) 1906, or both the cellular baseband processor(s) 1924 and the application processor(s) 1906. The FSI/ECA component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1904 may include a variety of components configured for various functions. In one configuration, the apparatus 1904, and in particular the cellular baseband processor(s) 1924 and/or the application processor(s) 1906, may include means for receiving an indication of a single transport block (TB) scheduled across a plurality of slots and across one of a plurality of sub-bands within a virtual cell or a plurality of component carriers associated with a carrier aggregation. The apparatus 1904, and in particular the cellular baseband processor(s) 1924 and/or the application processor(s) 1906, may include means for receiving or transmitting the TB via one of the plurality of sub-bands within the virtual cell or the plurality of component carriers associated with the carrier aggregation. The apparatus 1904, and in particular the cellular baseband processor(s) 1924 and/or the application processor(s) 1906, may include means for receiving configuration information identifying members of different groups of sub-bands or component carriers. The apparatus 1904, and in particular the cellular baseband processor(s) 1924 and/or the application processor(s) 1906, may include means for receiving configuration information indicating a set of states that may be indicated in the DCI. The apparatus 1904, and in particular the cellular baseband processor(s) 1924 and/or the application processor(s) 1906, may include means for transmitting one or more of: a first indication of support for scheduling the single instance of the TB over the plurality of slots and across one of the plurality of sub-bands or the plurality of component carriers, or a second indication of support for scheduling the plurality of repetitions of the TB over the plurality of slots and across one of the plurality of sub-bands or the plurality of component carriers. The apparatus 1904, and in particular the cellular baseband processor(s) 1924 and/or the application processor(s) 1906, may include means for receiving an additional indication of a mode of TB scheduling across pluralities of slots and one of the plurality of sub-bands or the plurality of component carriers. The apparatus 1904 may further include means for performing any of the aspects described in connection with the flowcharts in FIGS. 15 and 16, and/or performed by the UE in the communication flow of FIG. 14. The means may be the FSI/ECA component 198 of the apparatus 1904 configured to perform the functions recited by the means. As described supra, the apparatus 1904 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 20 is a diagram 2000 illustrating an example of a hardware implementation for a network entity 2002. The network entity 2002 may be a BS, a component of a BS, or may implement BS functionality. The network entity 2002 may include at least one of a CU 2010, a DU 2030, or an RU 2040. For example, depending on the layer functionality handled by the FSI/ECA component 199, the network entity 2002 may include the CU 2010; both the CU 2010 and the DU 2030; each of the CU 2010, the DU 2030, and the RU 2040; the DU 2030; both the DU 2030 and the RU 2040; or the RU 2040. The CU 2010 may include at least one CU processor 2012. The CU processor(s) 2012 may include on-chip memory 2012′. In some aspects, the CU 2010 may further include additional memory modules 2014 and a communications interface 2018. The CU 2010 communicates with the DU 2030 through a midhaul link, such as an F1 interface. The DU 2030 may include at least one DU processor 2032. The DU processor(s) 2032 may include on-chip memory 2032′. In some aspects, the DU 2030 may further include additional memory modules 2034 and a communications interface 2038. The DU 2030 communicates with the RU 2040 through a fronthaul link. The RU 2040 may include at least one RU processor 2042. The RU processor(s) 2042 may include on-chip memory 2042′. In some aspects, the RU 2040 may further include additional memory modules 2044, one or more transceivers 2046, one or more antennas 2080, and a communications interface 2048. The RU 2040 communicates with the UE 104. The on-chip memory 2012′, 2032′, 2042′ and the additional memory modules 2014, 2034, 2044 may each be considered a computer-readable medium/memory. Each computer-readable medium/memory may be non-transitory. Each of the processors 2012, 2032, 2042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the FSI/ECA component 199 may be configured to transmit an indication of a TB scheduled across a plurality of slots and across one of a plurality of sub-bands within a virtual cell or a plurality of component carriers associated with a carrier aggregation and to transmit or receive the TB via the plurality of slots and one of the plurality of sub-bands within the virtual cell or the plurality of component carriers associated with the carrier aggregation. The FSI/ECA component 199 may be within one or more processors of one or more of the CU 2010, DU 2030, and the RU 2040. The FSI/ECA component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2002 may include a variety of components configured for various functions. In one configuration, the network entity 2002 may include means for transmitting an indication of a transport block (TB) scheduled across a plurality of slots and across one of a plurality of sub-bands within a virtual cell or a plurality of component carriers associated with a carrier aggregation. The network entity 2002, in some aspects, may include means for transmitting or receiving the TB via the plurality of slots and one of the plurality of sub-bands within the virtual cell or the plurality of component carriers associated with the carrier aggregation. The network entity 2002, in some aspects, may include means for transmitting configuration information identifying members of different groups of sub-bands within the virtual cell or component carriers associated with the carrier aggregation. The network entity 2002, in some aspects, may include means for transmitting configuration information indicating a set of states that may be indicated in the DCI. The network entity 2002, in some aspects, may include means for receiving one or more of: a first indication of support for scheduling the single instance of the TB over the plurality of slots and across one of the plurality of sub-bands or the plurality of component carriers, or a second indication of support for scheduling the plurality of repetitions of the TB over the plurality of slots and across one of the plurality of sub-bands or the plurality of component carriers. The network entity 2002, in some aspects, may include means for transmitting an additional indication of a mode of TB scheduling across pluralities of slots and one of the plurality of sub-bands or the plurality of component carriers. The network entity 2002 may further include means for performing any of the aspects described in connection with the flowcharts in FIGS. 17 and 18, and/or performed by the base station in the communication flow of FIG. 14. The means may be the FSI/ECA component 199 of the network entity 2002 configured to perform the functions recited by the means. As described supra, the network entity 2002 may include the TX processor 316, the RX processor 370, and the controller/processor 375. As such, in one configuration, the means may be the TX processor 316, the RX processor 370, and/or the controller/processor 375 configured to perform the functions recited by the means or as described in relation to FIGS. 17 and 18.

FIG. 21 is a diagram 2100 illustrating an example of a hardware implementation for a network entity 2160. In one example, the network entity 2160 may be within the core network 120. The network entity 2160 may include at least one network processor 2112. The network processor(s) 2112 may include on-chip memory 2112′. In some aspects, the network entity 2160 may further include additional memory modules 2114. The network entity 2160 communicates via the network interface 2180 directly (e.g., backhaul link) or indirectly (e.g., through a RIC) with the CU 2102. The on-chip memory 2112′ and the additional memory modules 2114 may each be considered a computer-readable medium/memory. Each computer-readable medium/memory may be non-transitory. The network processor(s) 2112 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the FSI/ECA component 199 may be configured to transmit an indication of a TB scheduled across a plurality of slots and across one of a plurality of sub-bands within a virtual cell or a plurality of component carriers associated with a carrier aggregation and to transmit or receive the TB via the plurality of slots and one of the plurality of sub-bands within the virtual cell or the plurality of component carriers associated with the carrier aggregation. The FSI/ECA component 199 may be within the network processor(s) 2112. The FSI/ECA component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2160 may include a variety of components configured for various functions. In one configuration, the network entity 2160 may include means for transmitting an indication of a transport block (TB) scheduled across a plurality of slots and across one of a plurality of sub-bands within a virtual cell or a plurality of component carriers associated with a carrier aggregation. The network entity 2160, in some aspects, may include means for transmitting or receiving the TB via the plurality of slots and one of the plurality of sub-bands within the virtual cell or the plurality of component carriers associated with the carrier aggregation. The network entity 2160, in some aspects, may include means for transmitting configuration information identifying members of different groups of sub-bands within the virtual cell or component carriers associated with the carrier aggregation. The network entity 2160, in some aspects, may include means for transmitting configuration information indicating a set of states that may be indicated in the DCI. The network entity 2160, in some aspects, may include means for receiving one or more of: a first indication of support for scheduling the single instance of the TB over the plurality of slots and across one of the plurality of sub-bands or the plurality of component carriers, or a second indication of support for scheduling the plurality of repetitions of the TB over the plurality of slots and across one of the plurality of sub-bands or the plurality of component carriers. The network entity 2160, in some aspects, may include means for transmitting an additional indication of a mode of TB scheduling across pluralities of slots and one of the plurality of sub-bands or the plurality of component carriers. The means may be the FSI/ECA component 199 of the network entity 2160 configured to perform the functions recited by the means or as described in relation to FIGS. 17 and 18.

Various aspects relate generally to scheduling schemes for FSI and/or ECA. Some aspects more specifically relate to a scheduling associated with a repetition of a transport block (TB) across multiple CCs and/or SBs associated with the FSI and/or ECA (e.g., without a prior indication of a failure from a receiving device) and/or a scheduling associated with a transmission/reception of a (single) TB over multiple CCs and/or over multiple SBs associated with the FSI and/or ECA (e.g., CCs associated with ECA and/or SBs associated with a virtual cell/carrier), where the multiple CCs and/or SBs may be associated with different link directions (e.g., DL/UL or D/U) in any particular slot and/or symbol. For example, some aspects relate to indicating a time domain resource allocation (TDRA) and/or a frequency domain resource allocation (FDRA) for transmitting/receiving the TB repeated across multiple CCs and/or SBs and/or for transmitting/receiving the (single) TB over the multiple CCs and/or the multiple SBs. In some examples, a wireless device may be configured to receive an indication of a single TB scheduled across a plurality of slots and across one of a plurality of sub-bands within a virtual cell or a plurality of component carriers associated with a carrier aggregation and to transmit or receive the TB via the plurality of slots one of the plurality of sub-bands within the virtual cell or the plurality of component carriers associated with the carrier aggregation. In some examples, a network device may be configured to transmit an indication of a TB scheduled across a plurality of slots and across one of a plurality of sub-bands within a virtual cell or a plurality of component carriers associated with a carrier aggregation and to transmit or receive the TB via the plurality of slots and one of the plurality of sub-bands within the virtual cell or the plurality of component carriers associated with the carrier aggregation.

Particular aspects of the subject matter described in this disclosure can be implemented to realize one or more of the following potential advantages. In some examples, by using FSI and/or ECA to schedule repetitions of a TB, or a single TB transmission/reception, across multiple SBs or CCs, the described techniques can be used to realize the potential improvements to throughput, reliability, and/or power consumption/saving associated with using a single scheduler and/or coordinated/integrated schedulers for multiple SBs and/or CCs.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: receiving an indication of a single transport block (TB) scheduled across a plurality of slots and across one of a plurality of sub-bands within a virtual cell or a plurality of component carriers associated with a carrier aggregation; and receiving or transmitting the TB via the plurality of slots and one of the plurality of sub-bands within the virtual cell or the plurality of component carriers associated with the carrier aggregation.

Aspect 2 is the method of aspect 1, wherein the indication is included in scheduling downlink control information (DCI).

Aspect 3 is the method of aspect 2, wherein, to indicate the plurality of sub-bands or the plurality of component carriers, the DCI includes one of: a plurality of indices corresponding to one of the plurality of sub-bands or the plurality of component carriers; or a group index corresponding to one of the plurality of sub-bands or the plurality of component carriers.

Aspect 4 is the method of aspect 3, further comprising: receiving configuration information identifying members of different groups of sub-bands or component carriers.

Aspect 5 is the method of aspect 4, wherein each member of each group of the different groups is associated with a same subcarrier spacing.

Aspect 6 is the method of any of aspects 2 to 5, wherein the DCI comprises a frequency domain resource allocation (FDRA) that is one of: a first FDRA that applies, during the plurality of slots, to the plurality of sub-bands or the plurality of component carriers; a first set of FDRAs, wherein each FDRA in the first set of FDRAs applies, during a corresponding slot in the plurality of slots, to the plurality of sub-bands or the plurality of component carriers; a second set of FDRAs, wherein each FDRA in the second set of FDRAs applies, during the plurality of slots, to a first corresponding sub-band of the plurality of sub-bands or a first corresponding component carrier of the plurality of component carriers; or a third set of FDRAs, wherein each FDRA in the second set of FDRAs applies, during a corresponding slot in the plurality of slots, to a second corresponding sub-band of the plurality of sub-bands or a second corresponding component carrier of the plurality of component carriers.

Aspect 7 is the method of any of aspects 2 to 6, wherein the DCI comprises an additional indication of a timing associated with the TB that is one of: a first set of slot indices for each sub-band of the plurality of sub-bands or component carrier of the plurality of component carriers indicating slots in the plurality of slots for which the TB is scheduled; a second set of slot offsets for each sub-band of the plurality of sub-bands or each component carrier of the plurality of component carriers indicating slots in the plurality of slots for which the TB is scheduled; a first time domain resource allocation (TDRA) indicating a starting symbol and a duration per slot that applies, during the plurality of slots, to the plurality of sub-bands or the plurality of component carriers; a first set of TDRAs, wherein each TDRA in the first set of TDRAs applies, during a corresponding slot in the plurality of slots, to the plurality of sub-bands or the plurality of component carriers; a second set of TDRAs, wherein each TDRA in the second set of TDRAs applies, during the plurality of slots, to a corresponding sub-band or component carrier of the plurality of sub-bands or the plurality of component carriers; a third set of TDRAs, wherein each TDRA in the second set of TDRAs applies, during a corresponding slot in the plurality of slots, to a first corresponding sub-band of the plurality of sub-bands or a first corresponding component carrier of the plurality of component carriers; a first extended TDRA indicating an extended duration that includes the plurality of slots and that applies, during the plurality of slots, to the plurality of sub-bands or the plurality of component carriers; or a fourth set of extended TDRAs, wherein each extended TDRA in the fourth set of extended TDRAs applies, during the plurality of slots, to a second corresponding sub-band of the plurality of sub-bands or a second corresponding component carrier of the plurality of component carriers.

Aspect 8 is the method of aspect 7, wherein the DCI comprises one of the first extended TDRA or the fourth set of extended TDRAs and the TB is associated with a first transmission direction and the extended duration spans at least one slot associated with a second transmission direction that is not the first transmission direction in one of a first sub-band of the plurality of sub-bands or a first component carrier of the plurality of component carriers, wherein the extended duration is based on one of excluding the at least one slot associated with the second transmission direction from the extended duration applied to the first sub-band or the first component carrier or including the at least one slot associated with the second transmission direction in the extended duration applied to the first sub-band or the first component carrier.

Aspect 9 is the method of any of aspects 2 to 7, wherein the DCI includes an additional indication of a time interval spanning the plurality of slots, wherein, during each slot of the plurality of slots, a corresponding set of sub-bands of the plurality of sub-bands or a corresponding set of component carriers of the plurality of component carriers carrying the TB is based on one of: a slot format associated with each sub-band of the plurality of sub-bands or each component carrier of the plurality of component carriers; or a state, indicated in the DCI, of each sub-band of the plurality of sub-bands or each component carrier of the plurality of component carriers during each slot of the plurality of slots.

Aspect 10 is the method of aspect 9, wherein a state of each sub-band of the plurality of sub-bands or each component carrier of the plurality of component carriers during a particular slot comprises one of an ON state, an OFF state, or a slot format associated with each sub-band of the plurality of sub-bands or each component carrier of the plurality of component carriers during the particular slot, the method further comprising: receiving configuration information indicating a set of states that may be indicated in the DCI, wherein the state of each sub-band of the plurality of sub-bands or each component carrier of the plurality of component carriers during each slot of the plurality of slots comprises one of a single indicated state that applies to each slot of the plurality of slots, or a sequence of indicated states corresponding to the plurality of slots.

Aspect 11 is the method of any of aspects 9 and 10, wherein the time interval is indicated as a number of slots based on one of a subcarrier spacing associated with one sub-band of the plurality of sub-bands or one component carrier of the plurality of component carriers or a reference subcarrier spacing.

Aspect 12 is the method of any of aspects 1 to 11, wherein a processing timeline associated with the TB is based on one of an earliest slot in the plurality of slots or a latest slot in the plurality of slots.

Aspect 13 is the method of any of aspects 1 to 12, wherein the TB scheduled across the plurality of slots comprises one of: a plurality of repetitions of the TB, wherein each repetition in the plurality of repetitions is associated with one of a set of one or more sub-bands of the plurality of sub-bands or a set of one or more component carriers of the plurality of component carriers, or a single instance of the TB.

Aspect 14 is the method of aspect 13, wherein the TB scheduled across the plurality of slots comprises the plurality of repetitions of the TB, and the indication of the TB comprises one of a single scheduling downlink control information (DCI) scheduling the plurality of repetitions of the TB or a plurality of scheduling DCIs corresponding to the plurality of repetitions of the TB.

Aspect 15 is the method of any of aspects 13 and 14, further comprising transmitting one or more of: a first indication of support for scheduling the single instance of the TB over the plurality of slots and across one of the plurality of sub-bands or the plurality of component carriers, or a second indication of support for scheduling the plurality of repetitions of the TB over the plurality of slots and across one of the plurality of sub-bands or the plurality of component carriers.

Aspect 16 is the method of aspect 15, further comprising: receiving an additional indication of a mode of TB scheduling across pluralities of slots and one of the plurality of sub-bands or the plurality of component carriers, wherein the mode of TB scheduling comprises one of a first mode of TB scheduling associated with scheduling a single TB across multiple slots and one of multiple sub-bands within the virtual cell or multiple component carriers associated with the carrier aggregation or a second mode of TB scheduling associated with scheduling multiple repetitions of a TB across multiple slots and on each of multiple sub-bands within the virtual cell or multiple component carriers associated with the carrier aggregation.

Aspect 17 is the method of aspect 16, wherein the additional indication is included in one of a radio resource control (RRC) message, a medium access control (MAC) control element (CE) (MAC-CE), or scheduling downlink control information (DCI).

Aspect 18 is the method of any of aspects 15 to 17, wherein the indication includes an additional indication of one of: a first redundancy value (RV) associated with the single instance of the TB, or a plurality of RVs corresponding to the plurality of repetitions of the TB.

Aspect 19 is a method of wireless communication at a network device, comprising: transmitting an indication of a transport block (TB) scheduled across a plurality of slots and across one of a plurality of sub-bands within a virtual cell or a plurality of component carriers associated with a carrier aggregation; and transmitting or receiving the TB via the plurality of slots and one of the plurality of sub-bands within the virtual cell or the plurality of component carriers associated with the carrier aggregation.

Aspect 20 is the method of aspect 19, wherein the indication is included in scheduling downlink control information (DCI).

Aspect 21 is the method of aspect 20, wherein, to indicate the plurality of sub-bands or the plurality of component carriers, the DCI includes one of: a plurality of indices corresponding to one of the plurality of sub-bands or the plurality of component carriers; or a group index corresponding to one of the plurality of sub-bands or the plurality of component carriers.

Aspect 22 is the method of aspect 21, further comprising: transmitting configuration information identifying members of different groups of sub-bands within the virtual cell or component carriers associated with the carrier aggregation.

Aspect 23 is the method of aspect 22, wherein each member of each group of the different groups is associated with a same subcarrier spacing.

Aspect 24 is the method of any of aspects 20 to 23, wherein the DCI comprises a frequency domain resource allocation (FDRA) that is one of: a first FDRA that applies, during the plurality of slots, to the plurality of sub-bands or the plurality of component carriers; a first set of FDRAs, wherein each FDRA in the first set of FDRAs applies, during a corresponding slot in the plurality of slots, to the plurality of sub-bands or the plurality of component carriers; a second set of FDRAs, wherein each FDRA in the second set of FDRAs applies, during the plurality of slots, to a first corresponding sub-band of the plurality of sub-bands or a first corresponding component carrier of the plurality of component carriers; or a third set of FDRAs, wherein each FDRA in the second set of FDRAs applies, during a corresponding slot in the plurality of slots, to a second corresponding sub-band of the plurality of sub-bands or a second corresponding component carrier of the plurality of component carriers.

Aspect 25 is the method of any of aspects 20 to 24, wherein the DCI comprises an additional indication of a timing associated with the TB that is one of: a first set of slot indices for each sub-band of the plurality of sub-bands or component carrier of the plurality of component carriers indicating slots in the plurality of slots for which the TB is scheduled; a second set of slot offsets for each sub-band of the plurality of sub-bands or each component carrier of the plurality of component carriers indicating slots in the plurality of slots for which the TB is scheduled; a first time domain resource allocation (TDRA) indicating a starting symbol and a duration per slot that applies, during the plurality of slots, to the plurality of sub-bands or the plurality of component carriers; a first set of TDRAs, wherein each TDRA in the first set of TDRAs applies, during a corresponding slot in the plurality of slots, to the plurality of sub-bands or the plurality of component carriers; a second set of TDRAs, wherein each TDRA in the second set of TDRAs applies, during the plurality of slots, to a corresponding sub-band or component carrier of the plurality of sub-bands or the plurality of component carriers; a third set of TDRAs, wherein each TDRA in the second set of TDRAs applies, during a corresponding slot in the plurality of slots, to a first corresponding sub-band of the plurality of sub-bands or a first corresponding component carrier of the plurality of component carriers; a first extended TDRA indicating an extended duration that includes the plurality of slots and that applies, during the plurality of slots, to the plurality of sub-bands or the plurality of component carriers; or a fourth set of extended TDRAs, wherein each extended TDRA in the fourth set of extended TDRAs applies, during the plurality of slots, to a second corresponding sub-band of the plurality of sub-bands or a second corresponding component carrier of the plurality of component carriers.

Aspect 26 is the method of aspect 25, wherein the DCI comprises one of the first extended TDRA or the fourth set of extended TDRAs and the TB is associated with a first transmission direction and the extended duration spans at least one slot associated with a second transmission direction that is not the first transmission direction in one of a first sub-band of the plurality of sub-bands or a first component carrier of the plurality of component carriers, wherein the extended duration is based on one of excluding the at least one slot associated with the second transmission direction from the extended duration applied to the first sub-band or the first component carrier or including the at least one slot associated with the second transmission direction in the extended duration applied to the first sub-band or the first component carrier.

Aspect 27 is the method of any of aspects 20 to 25, wherein the DCI includes an additional indication of a time interval spanning the plurality of slots, wherein, during each slot of the plurality of slots, a corresponding set of sub-bands of the plurality of sub-bands or a corresponding set of component carriers of the plurality of component carriers carrying the TB is based on one of: a slot format associated with each sub-band of the plurality of sub-bands or each component carrier of the plurality of component carriers; or a state, indicated in the DCI, of each sub-bands of the plurality of sub-bands or each component carriers of the plurality of component carriers during each slot of the plurality of slots.

Aspect 28 is the method of aspect 27, wherein a state of each sub-band of the plurality of sub-bands or each component carrier of the plurality of component carriers during a particular slot comprises one of an ON state, an OFF state, or a slot format associated with each sub-band of the plurality of sub-bands or each component carrier of the plurality of component carriers during the particular slot, the method further comprising: transmitting configuration information indicating a set of states that may be indicated in the DCI, wherein the state of each sub-band of the plurality of sub-bands or each component carrier of the plurality of component carriers during each slot of the plurality of slots comprises one of a single indicated state that applies to each slot of the plurality of slots, or a sequence of indicated states corresponding to the plurality of slots.

Aspect 29 is the method of any of aspects 27 and 28, wherein the time interval is indicated as a number of slots based on one of a subcarrier spacing associated with one sub-band of the plurality of sub-bands or one component carrier of the plurality of component carriers or a reference subcarrier spacing.

Aspect 30 is the method of any of aspects 19 to 29, wherein a processing timeline associated with the TB is based on one of an earliest slot in the plurality of slots or a latest slot in the plurality of slots.

Aspect 31 is the method of any of aspects 19 to 30, wherein the TB scheduled across the plurality of slots comprises one of: a plurality of repetitions of the TB, wherein each repetition in the plurality of repetitions is associated with one of a set of one or more sub-bands of the plurality of sub-bands or a set of one or more component carriers of the plurality of component carriers, or a single instance of the TB.

Aspect 32 is the method of aspect 31, wherein the TB scheduled across the plurality of slots comprises the plurality of repetitions of the TB, and the indication of the TB comprises one of a single scheduling downlink control information (DCI) scheduling the plurality of repetitions of the TB or a plurality of scheduling DCIs corresponding to the plurality of repetitions of the TB.

Aspect 33 is the method of any of aspects 31 and 32, further comprising receiving one or more of: a first indication of support for scheduling the single instance of the TB over the plurality of slots and across one of the plurality of sub-bands or the plurality of component carriers, or a second indication of support for scheduling the plurality of repetitions of the TB over the plurality of slots and across one of the plurality of sub-bands or the plurality of component carriers.

Aspect 34 is the method of aspect 33, further comprising: transmitting an additional indication of a mode of TB scheduling across pluralities of slots and one of the plurality of sub-bands or the plurality of component carriers, wherein the mode of TB scheduling comprises one of a first mode of TB scheduling associated with scheduling a single TB across multiple slots and one of multiple sub-bands within the virtual cell or multiple component carriers associated with the carrier aggregation or a second mode of TB scheduling associated with scheduling multiple repetitions of a TB across multiple slots and on each of multiple sub-bands within the virtual cell or multiple component carriers associated with the carrier aggregation.

Aspect 35 is the method of aspect 34, wherein the additional indication is included in one of a radio resource control (RRC) message, a medium access control (MAC) control element (CE) (MAC-CE), or scheduling downlink control information (DCI).

Aspect 36 is the method of any of aspects 33 to 35, wherein the indication includes an additional indication of one of: a first redundancy value (RV) associated with the single instance of the TB, or a plurality of RVs corresponding to the plurality of repetitions of the TB.

Aspect 37 is an apparatus for wireless communication at a device including a memory and at least one processor coupled to the memory and, based at least in part on information stored in the memory, the at least one processor is configured to implement any of aspects 1 to 18.

Aspect 38 is the apparatus of aspect 37, further including a transceiver or an antenna coupled to the at least one processor.

Aspect 39 is an apparatus for wireless communication at a device including means for implementing any of aspects 1 to 18.

Aspect 40 is a computer-readable medium (e.g., a non-transitory computer-readable medium) storing computer executable code, where the code when executed by a processor causes the processor to implement any of aspects 1 to 18.

Aspect 41 is an apparatus for wireless communication at a device including a memory and at least one processor coupled to the memory and, based at least in part on information stored in the memory, the at least one processor is configured to implement any of aspects 19 to 36.

Aspect 42 is the apparatus of aspect 41, further including a transceiver or an antenna coupled to the at least one processor.

Aspect 43 is an apparatus for wireless communication at a device including means for implementing any of aspects 19 to 36.

Aspect 44 is a computer-readable medium (e.g., a non-transitory computer-readable medium) storing computer executable code, where the code when executed by a processor causes the processor to implement any of aspects 19 to 36.

What is claimed is:

1. An apparatus for wireless communication at a user equipment (UE), comprising:
at least one memory; and
at least one processor coupled to the at least one memory and, based at least in part on stored information that is stored in the at least one memory, the at least one processor, individually or in any combination, is configured to:
receive an indication of a single transport block (TB) scheduled across a plurality of slots and across one of a plurality of sub-bands within a virtual cell or a plurality of component carriers associated with a carrier aggregation; and
receive or transmit the TB via the plurality of slots and one of the plurality of sub-bands within the virtual cell or the plurality of component carriers associated with the carrier aggregation.

2. The apparatus of claim 1, wherein the indication is included in scheduling downlink control information (DCI).

3. The apparatus of claim 2, wherein, to indicate the plurality of sub-bands or the plurality of component carriers, the DCI includes one of:
a plurality of indices corresponding to one of the plurality of sub-bands or the plurality of component carriers; or
a group index corresponding to one of the plurality of sub-bands or the plurality of component carriers.

4. The apparatus of claim 3, wherein the at least one processor, individually or in any combination, is further configured to:
receive configuration information identifying members of different groups of sub-bands or component carriers.

5. The apparatus of claim 4, wherein each member of each group of the different groups is associated with a same subcarrier spacing.

6. The apparatus of claim 2, wherein the DCI comprises a frequency domain resource allocation (FDRA) that is one of:
a first FDRA that applies, during the plurality of slots, to the plurality of sub-bands or the plurality of component carriers;
a first set of FDRAs, wherein each FDRA in the first set of FDRAs applies, during a corresponding slot in the plurality of slots, to the plurality of sub-bands or the plurality of component carriers;
a second set of FDRAs, wherein each FDRA in the second set of FDRAs applies, during the plurality of slots, to a first corresponding sub-band of the plurality of sub-bands or a first corresponding component carrier of the plurality of component carriers; or
a third set of FDRAs, wherein each FDRA in the second set of FDRAs applies, during a corresponding slot in the plurality of slots, to a second corresponding sub-band of the plurality of sub-bands or a second corresponding component carrier of the plurality of component carriers.

7. The apparatus of claim 2, wherein the DCI comprises an additional indication of a timing associated with the TB that is one of:
a first set of slot indices for each sub-band of the plurality of sub-bands or component carrier of the plurality of component carriers indicating slots in the plurality of slots for which the TB is scheduled;
a second set of slot offsets for each sub-band of the plurality of sub-bands or each component carrier of the plurality of component carriers indicating slots in the plurality of slots for which the TB is scheduled;
a first time domain resource allocation (TDRA) indicating a starting symbol and a duration per slot that applies, during the plurality of slots, to the plurality of sub-bands or the plurality of component carriers;
a first set of TDRAs, wherein each TDRA in the first set of TDRAs applies, during a corresponding slot in the plurality of slots, to the plurality of sub-bands or the plurality of component carriers;
a second set of TDRAs, wherein each TDRA in the second set of TDRAs applies, during the plurality of slots, to a corresponding sub-band or component carrier of the plurality of sub-bands or the plurality of component carriers;
a third set of TDRAs, wherein each TDRA in the second set of TDRAs applies, during a corresponding slot in the plurality of slots, to a first corresponding sub-band of the plurality of sub-bands or a first corresponding component carrier of the plurality of component carriers;
a first extended TDRA indicating an extended duration that includes the plurality of slots and that applies, during the plurality of slots, to the plurality of sub-bands or the plurality of component carriers; or
a fourth set of extended TDRAs, wherein each extended TDRA in the fourth set of extended TDRAs applies, during the plurality of slots, to a second corresponding sub-band of the plurality of sub-bands or a second corresponding component carrier of the plurality of component carriers.

8. The apparatus of claim 7, wherein the DCI comprises one of the first extended TDRA or the fourth set of extended TDRAs and the TB is associated with a first transmission direction and the extended duration spans at least one slot associated with a second transmission direction that is not the first transmission direction in one of a first sub-band of the plurality of sub-bands or a first component carrier of the plurality of component carriers, wherein the extended duration is based on one of excluding the at least one slot associated with the second transmission direction from the extended duration applied to the first sub-band or the first component carrier or including the at least one slot associated with the second transmission direction in the extended duration applied to the first sub-band or the first component carrier.

9. The apparatus of claim 2, wherein the DCI includes an additional indication of a time interval spanning the plurality of slots, wherein, during each slot of the plurality of slots, a corresponding set of sub-bands of the plurality of sub-bands or a corresponding set of component carriers of the plurality of component carriers carrying the TB is based on one of:
a slot format associated with each sub-band of the plurality of sub-bands or each component carrier of the plurality of component carriers; or
a state, indicated in the DCI, of each sub-band of the plurality of sub-bands or each component carrier of the plurality of component carriers during each slot of the plurality of slots.

10. The apparatus of claim 9, wherein a state of each sub-band of the plurality of sub-bands or each component carrier of the plurality of component carriers during a particular slot comprises one of an ON state, an OFF state, or a slot format associated with each sub-band of the plurality of sub-bands or each component carrier of the plurality of component carriers during the particular slot, wherein the at least one processor, individually or in any combination, is further configured to:
receive configuration information indicating a set of states that may be indicated in the DCI, wherein the state of each sub-band of the plurality of sub-bands or each component carrier of the plurality of component carriers during each slot of the plurality of slots comprises one of a single indicated state that applies to each slot of the plurality of slots, or a sequence of indicated states corresponding to the plurality of slots.

11. The apparatus of claim 9, wherein the time interval is indicated as a number of slots based on one of a subcarrier spacing associated with one sub-band of the plurality of sub-bands or one component carrier of the plurality of component carriers or a reference subcarrier spacing.

12. The apparatus of claim 1, wherein a processing timeline associated with the TB is based on one of an earliest slot in the plurality of slots or a latest slot in the plurality of slots.

13. The apparatus of claim 1, wherein the TB scheduled across the plurality of slots comprises one of:
a plurality of repetitions of the TB, wherein each repetition in the plurality of repetitions is associated with one of a set of one or more sub-bands of the plurality of sub-bands or a set of one or more component carriers of the plurality of component carriers, or
a single instance of the TB.

14. The apparatus of claim 13, wherein the TB scheduled across the plurality of slots comprises the plurality of repetitions of the TB, and the indication of the TB comprises one of a single scheduling downlink control information (DCI) scheduling the plurality of repetitions of the TB or a plurality of scheduling DCIs corresponding to the plurality of repetitions of the TB.

15. The apparatus of claim 13, further comprising a transceiver coupled to the at least one processor, wherein the at least one processor, individually or in any combination, is further configured to transmit, via the transceiver, one or more of:
a first indication of support for scheduling the single instance of the TB over the plurality of slots and across one of the plurality of sub-bands or the plurality of component carriers, or
a second indication of support for scheduling the plurality of repetitions of the TB over the plurality of slots and across one of the plurality of sub-bands or the plurality of component carriers.

16. The apparatus of claim 15, wherein the at least one processor, individually or in any combination, is further configured to:
receive an additional indication of a mode of TB scheduling across pluralities of slots and one of the plurality of sub-bands or the plurality of component carriers, wherein the mode of TB scheduling comprises one of a first mode of TB scheduling associated with scheduling a single TB across multiple slots and one of multiple sub-bands within the virtual cell or multiple component carriers associated with the carrier aggregation or a second mode of TB scheduling associated with scheduling multiple repetitions of a TB across multiple slots and on each of multiple sub-bands within the virtual cell or multiple component carriers associated with the carrier aggregation.

17. The apparatus of claim 16, wherein the additional indication is included in one of a radio resource control (RRC) message, a medium access control (MAC) control element (CE) (MAC-CE), or scheduling downlink control information (DCI).

18. The apparatus of claim 15, wherein the indication includes an additional indication of one of:
a first redundancy value (RV) associated with the single instance of the TB, or
a plurality of RVs corresponding to the plurality of repetitions of the TB.

19. An apparatus for wireless communication at a network node, comprising:
at least one memory; and
at least one processor coupled to the at least one memory and, based at least in part on stored information that is stored in the at least one memory, the at least one processor, individually or in any combination, is configured to:
transmit an indication of a transport block (TB) scheduled across a plurality of slots and across one of a plurality of sub-bands within a virtual cell or a plurality of component carriers associated with a carrier aggregation; and
transmit or receive the TB via the plurality of slots and one of the plurality of sub-bands within the virtual cell or the plurality of component carriers associated with the carrier aggregation.

20. The apparatus of claim 19, wherein the indication is included in scheduling downlink control information (DCI).

21. The apparatus of claim 20, wherein, to indicate the plurality of sub-bands or the plurality of component carriers, the DCI includes one of:
a plurality of indices corresponding to one of the plurality of sub-bands or the plurality of component carriers; or
a group index corresponding to one of the plurality of sub-bands or the plurality of component carriers.

22. The apparatus of claim 21, wherein the at least one processor, individually or in any combination, is further configured to:
transmit configuration information identifying members of different groups of sub-bands within the virtual cell or component carriers associated with the carrier aggregation.

23. The apparatus of claim 22, wherein each member of each group of the different groups is associated with a same subcarrier spacing.

24. The apparatus of claim 20, wherein the DCI comprises a frequency domain resource allocation (FDRA) that is one of:
a first FDRA that applies, during the plurality of slots, to the plurality of sub-bands or the plurality of component carriers;
a first set of FDRAs, wherein each FDRA in the first set of FDRAs applies, during a corresponding slot in the plurality of slots, to the plurality of sub-bands or the plurality of component carriers;
a second set of FDRAs, wherein each FDRA in the second set of FDRAs applies, during the plurality of slots, to a first corresponding sub-band of the plurality of sub-bands or a first corresponding component carrier of the plurality of component carriers; or
a third set of FDRAs, wherein each FDRA in the second set of FDRAs applies, during a corresponding slot in the plurality of slots, to a second corresponding sub-band of the plurality of sub-bands or a second corresponding component carrier of the plurality of component carriers.

25. The apparatus of claim 20, wherein the DCI comprises an additional indication of a timing associated with the TB that is one of:
a first set of slot indices for each sub-band of the plurality of sub-bands or component carrier of the plurality of component carriers indicating slots in the plurality of slots for which the TB is scheduled;
a second set of slot offsets for each sub-band of the plurality of sub-bands or each component carrier of the plurality of component carriers indicating slots in the plurality of slots for which the TB is scheduled;
a first time domain resource allocation (TDRA) indicating a starting symbol and a duration per slot that applies, during the plurality of slots, to the plurality of sub-bands or the plurality of component carriers;
a first set of TDRAs, wherein each TDRA in the first set of TDRAs applies, during a corresponding slot in the plurality of slots, to the plurality of sub-bands or the plurality of component carriers;
a second set of TDRAs, wherein each TDRA in the second set of TDRAs applies, during the plurality of slots, to a corresponding sub-band or component carrier of the plurality of sub-bands or the plurality of component carriers;
a third set of TDRAs, wherein each TDRA in the second set of TDRAs applies, during a corresponding slot in the plurality of slots, to a first corresponding sub-band of the plurality of sub-bands or a first corresponding component carrier of the plurality of component carriers;
a first extended TDRA indicating an extended duration that includes the plurality of slots and that applies, during the plurality of slots, to the plurality of sub-bands or the plurality of component carriers; or
a fourth set of extended TDRAs, wherein each extended TDRA in the fourth set of extended TDRAs applies, during the plurality of slots, to a second corresponding sub-band of the plurality of sub-bands or a second corresponding component carrier of the plurality of component carriers.

26. The apparatus of claim 25, wherein the DCI comprises one of the first extended TDRA or the fourth set of extended TDRAs and the TB is associated with a first transmission direction and the extended duration spans at least one slot associated with a second transmission direction that is not the first transmission direction in one of a first sub-band of the plurality of sub-bands or a first component carrier of the plurality of component carriers, wherein the extended duration is based on one of excluding the at least one slot associated with the second transmission direction from the extended duration applied to the first sub-band or the first component carrier or including the at least one slot associated with the second transmission direction in the extended duration applied to the first sub-band or the first component carrier.

27. The apparatus of claim 20, wherein the DCI includes an additional indication of a time interval spanning the plurality of slots, wherein, during each slot of the plurality of slots, a corresponding set of sub-bands of the plurality of sub-bands or a corresponding set of component carriers of the plurality of component carriers carrying the TB is based on one of:
a slot format associated with each sub-band of the plurality of sub-bands or each component carrier of the plurality of component carriers; or
a state, indicated in the DCI, of each sub-band of the plurality of sub-bands or each component carriers of the plurality of component carriers during each slot of the plurality of slots.

28. The apparatus of claim 27, wherein a state of each sub-band of the plurality of sub-bands or each component carrier of the plurality of component carriers during a particular slot comprises one of an ON state, an OFF state, or a slot format associated with each sub-band of the plurality of sub-bands or each component carrier of the plurality of component carriers during the particular slot, wherein the at least one processor, individually or in any combination, is further configured to:
transmit configuration information indicating a set of states that may be indicated in the DCI, wherein the state of each sub-band of the plurality of sub-bands or each component carrier of the plurality of component carriers during each slot of the plurality of slots comprises one of a single indicated state that applies to each slot of the plurality of slots, or a sequence of indicated states corresponding to the plurality of slots.

29. A method of wireless communication at a user equipment (UE), comprising:
receiving an indication of a single transport block (TB) scheduled across a plurality of slots and across one of a plurality of sub-bands within a virtual cell or a plurality of component carriers associated with a carrier aggregation; and
receiving or transmitting the TB via the plurality of slots and one of the plurality of sub-bands within the virtual cell or the plurality of component carriers associated with the carrier aggregation.

30. A method of wireless communication at a network node, comprising:
transmitting an indication of a transport block (TB) scheduled across a plurality of slots and across one of a plurality of sub-bands within a virtual cell or a plurality of component carriers associated with a carrier aggregation; and
transmitting or receiving the TB via the plurality of slots and one of the plurality of sub-bands within the virtual cell or the plurality of component carriers associated with the carrier aggregation.
